(19) United States
(12) Patent Application Publication
(10) Pub. No.: US 2025/0171589 A1
(43) Pub. Date: May 29, 2025

(54) FUNCTIONAL ADDITIVE IN POLYMER SYSTEMS

(71) Applicant: ARIZONA BOARD OF REGENTS ON BEHALF OF ARIZONA STATE UNIVERSITY, Scottsdale, AZ (US)

(72) Inventors: Jose Sintas, Phoenix, AZ (US); Timothy Long, Phoenix, AZ (US)

(21) Appl. No.: 18/912,560

(22) Filed: Oct. 10, 2024

Related U.S. Application Data
(60) Provisional application No. 63/543,637, filed on Oct. 11, 2023.

(51) Int. Cl. C08G 71/04

(52) U.S. Cl. CPC C08G 71/04

(57) ABSTRACT

The subject matter described herein relates to polymer compositions, polymer additives, methods of polymers, and materials thereof.

### FUNCTIONAL ADDITIVE IN POLYMER SYSTEMS

This application claims priority to U.S. Provisional Application No. 63/543,637 filed on Oct. 11, 2023, the entire contents of which are incorporated herein by reference.

### GOVERNMENT INTERESTS

This invention was made with government support under DE-NA0002839 awarded by the Department of Energy. The government has certain rights in the invention.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to polyurethane-based polymer compositions, polymer additives, methods of producing polyurethane-based polymers, and materials thereof.

### BACKGROUND OF THE INVENTION

Thermosetting resins and thermoplastic resins are popular for a variety of commercial applications. One requirement of this class of polymer is the absence of volatile byproducts, which omits the implementation of certain classes of chemistries for use in thermosetting and thermoplastic applications.

### SUMMARY OF THE INVENTION

Aspects of the invention are drawn towards a polymer resin comprising: a bis-carbonylimidazolide (BCI) monomer or derivative thereof; a multifunctional nucleophile, wherein the multifunctional nucleophile is selected from the group consisting of a multifunctional primary amine, a multifunctional secondary amine, a multifunctional thiol, or a multifunctional alcohol, or a combination thereof; and a Michael acceptor additive. In embodiments, the BCI monomer or derivative thereof is present in about 1 weight % to about 90 weight % of the resin; the amine is present in about 10 weight % to about 90 weight % of the resin; and the Michael acceptor additive is present in about 1 weight % to about 90 weight % of the resin. In embodiments, the bis-carbonylimidazolide (BCI) monomer or derivative thereof is

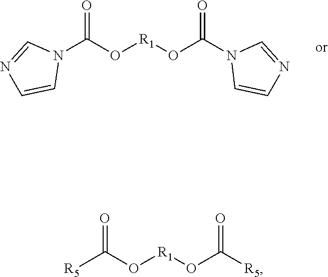

wherein —O—R₁—O— is taken together and selected from the group consisting of: a polyol, a diol, an aliphatic alcohol, a cyclic alcohol, and an aromatic alcohol; or R₁ is selected from the group consisting of:

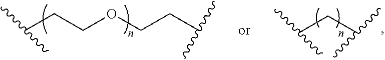

wherein n=1-10; -alkyl-, -aryl-, -cycloalkyl-, heterocyclyl-, -heteroaryl-,

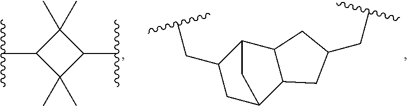

or a substituted derivative thereof; and wherein, R₅ is selected from the group consisting of:

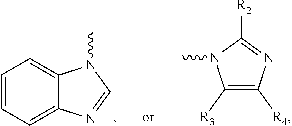

wherein R₂ is selected from the group consisting of an alkyl group, an aryl group, a vinyl group, or an inorganic substituent; wherein R₃ is selected from the group consisting of an alkyl group, an aryl group, a vinyl group, or an inorganic substituent; and wherein R₄ is selected from the group consisting of an alkyl group, an aryl group, a vinyl group, or an inorganic substituent. In embodiments, the multifunctional nucleophile comprises:

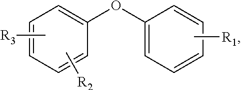

wherein R₁, R₂, and R₃ are independently selected from the group consisting of —H, —NH₂, —NR₄, —OH, or —SH, wherein R₄ is an alkyl group;

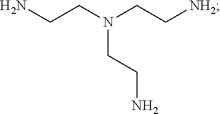

a polyetherimide;

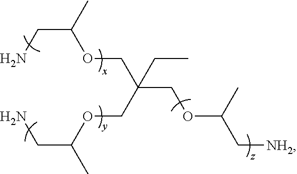

wherein x, y, and z are independently about 1 to about 10;

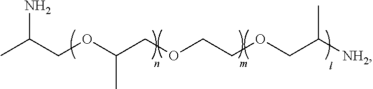

wherein n, m, and l are independently about 1 to about 25; a dendritic nucleophile; or

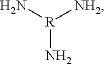

wherein R is a trialkylamine. In embodiments, the Michael acceptor additive comprises a Michael acceptor. In embodiments, the Michael acceptor comprises

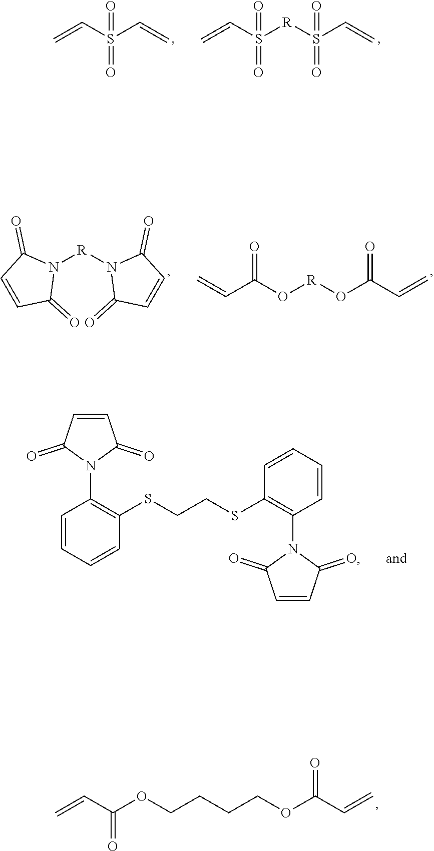

wherein R is:

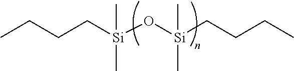

and n=1-10,

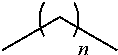

and n=1-10,

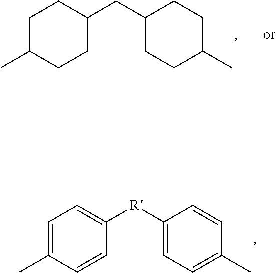

wherein R′ is an electron withdrawing group, an electron donating group, or a neutral group.

Aspects of the invention are drawn towards a method of producing a polymer or polymer material while capturing a byproduct to form a tunable filler, the method comprising: combining a bis-carbonylimidazolide (BCI) monomer, or derivative thereof, and a Michael acceptor additive to produce a pre-reaction mixture; reacting the pre-reaction mixture with at least one multifunctional nucleophile, thereby producing a polymer or polymer foam, wherein the polymer or polymer foam releases a Michael donor byproduct; and reacting the Michael donor byproduct with the Michael acceptor additive, thereby capturing the Michael donor byproduct by forming a Michael addition filler. In embodiments, the Michael donor byproduct comprises a Michael donor. In embodiments, the Michael donor comprises:

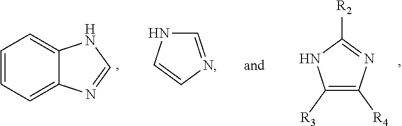

wherein, wherein R₂ is selected from the group consisting of an alkyl group, an aryl group, a vinyl group, or an inorganic substituent; wherein R₃ is selected from the group consisting of an alkyl group, an aryl group, a vinyl group, or an inorganic substituent; and wherein R₄ is selected from the group consisting of an alkyl group, an aryl group, a vinyl group, or an inorganic substituent. In embodiments, the bis-carbonylimidazolide (BCI) monomer or derivative thereof is

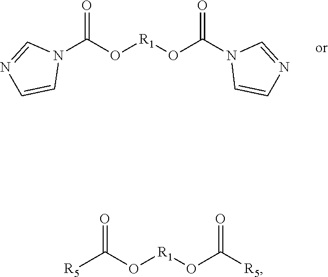

wherein —O—R₁—O— is taken together and selected from the group consisting of: a polyol, a diol, an aliphatic alcohol, a cyclic alcohol, and an aromatic alcohol; or R₁ is selected from the group consisting of:

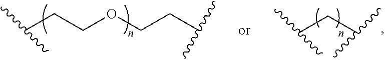

wherein n=1-10; -alkyl-; -aryl-; -cycloalkyl-; -heterocyclyl-; heteroaryl-;

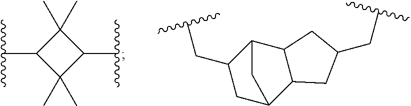

or a substituted derivative thereof; and wherein, R₅ is selected from the group consisting of:

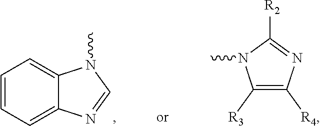

and wherein R₂ is selected from the group consisting of an alkyl group, an aryl group, a vinyl group, or an inorganic substituent; wherein R₃ is selected from the group consisting of an alkyl group, an aryl group, a vinyl group, or an inorganic substituent; and wherein R₄ is selected from the group consisting of an alkyl group, an aryl group, a vinyl group, or an inorganic substituent. In embodiments, the polyol is a polyethylene glycol (PEG), a polypropylene glycol (PPG), a polyester diol, or a polydimethylsiloxane (PDMS) diol, and/or wherein the cyclic alcohol is isosorbide. In embodiments, the multifunctional nucleophile comprises a multifunctional aromatic amine or a multifunctional aliphatic amine. In embodiments, the multifunctional nucleophile comprises:

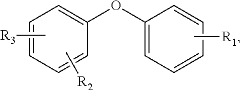

wherein R₁, R₂, and R₃ are independently selected from the group consisting of —H, —NH₂, —NR₄, —OH, or —SH, wherein R₄ is an alkyl group;

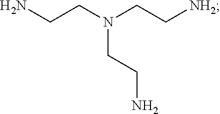

a polyetherimide;

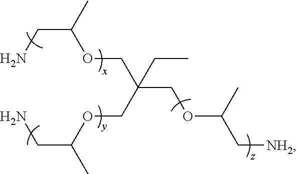

wherein x, y, and z are independently about 0 to about 10;

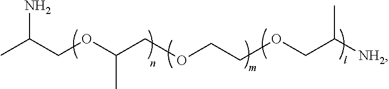

wherein n, m, and 1 are independently about 0 to about 25; a dendritic nucleophile; or

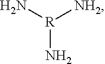

wherein R is a trialkylamine. In embodiments, the Michael acceptor additive comprises a Michael acceptor. In embodiments, the Michael acceptor comprises:

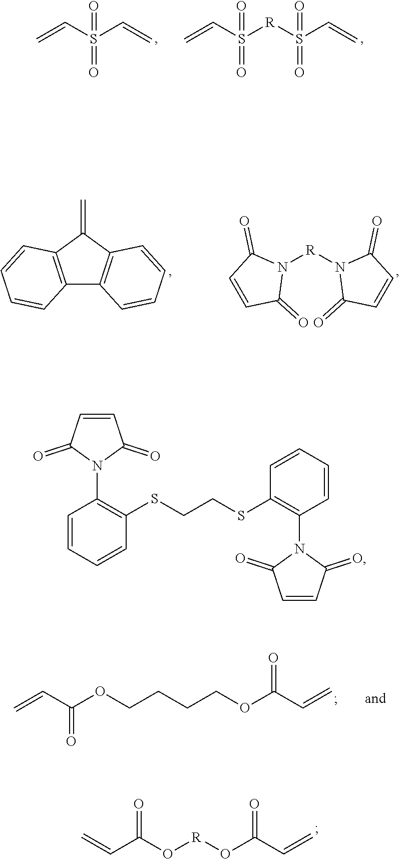

wherein R is selected from the group consisting of;

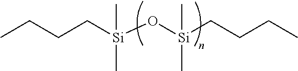

and n=1-10,

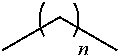

and n=1-10,

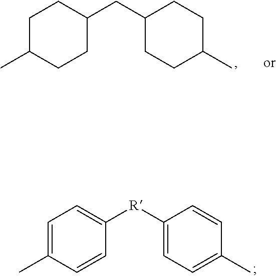

wherein R′ is an electron withdrawing group, an electron donating group, or a neutral group. In embodiments, the method further comprising adjusting the reaction rate by tuning the Michael acceptor additive, the method comprising: determining if the reaction rate should be increased or decreased; and selecting a more electron withdrawing Michael acceptor to increase the reaction rate, or selecting a less electron withdrawing Michael acceptor to decrease the reaction rate. In embodiments, the method further comprises targeting mechanical properties by tuning the Michael acceptor additive, the method comprising: targeting an increased T_{g} and modulus or targeting a decreased T_{g} and modulus; and selecting a rigid Michael acceptor additive to increase T_{g} and modulus, or selecting a flexible Michael acceptor additive to decrease T_{g} and modulus.

Aspects of the invention are drawn towards a polymer or polymer material produced by a method described herein. In embodiments, the method further comprises heating the polymer or polymer material to a temperature sufficient to induce decarboxylation, thereby producing a foam. In embodiments, the polymer, polymer material, or polymer foam described herein, is a polycarbonate, a polycarbonate foam, a polycarbonate material, a polyurethane, a polyurethane foam, a polyurethane material, a thiourethane, a thiourethane foam, a thiourethane material, or a co-polymer, copolymer material, or co-polymer foam thereof.

Other objects and advantages of this invention will become readily apparent from the ensuing description.

### BRIEF DESCRIPTION OF THE FIGURES

The patent or application file contains at least one drawing executed in color. Copies of this patent or patent application publication with color drawing(s) will be provided by the Office upon request and payment of necessary fee.

FIG. 1 shows a non-limiting, exemplary DSC trace highlighting the low melting point of TCDBCI.

FIG. 2 shows a non-limiting, exemplary scheme and a digital photograph of the product. DABCO and low melting TCDBCI enabled the low temperature synthesis of a NIPU foam based off BCI chemistry.

FIG. 3 shows a non-limiting, exemplary scheme and table of results. Incorporation of a flexible ether amine is successful at reducing the T_{g} of the synthesized foam.

FIG. 4 shows a non-limiting, exemplary scheme and a digital photograph of the product. Incorporation of ED-2003 enables synthesis of NIPU foam with a T_{g} that meets specified requirements.

FIG. 5 shows a non-limiting, exemplary results from a decarboxylation experiment. The absence of β-hydrogens in CBBCI prevents decarboxylation, NMR confirms no degradation of monomer after heating.

FIG. 6 shows a non-limiting, exemplary scheme a digital photograph of the product. CBBCI produces porous structure in the absence of CO₂. This can be due to the off gassing of imidazole throughout the reaction.

FIG. 7 shows non-limiting, exemplary digital photographs of the results before and after catalyst and addition process optimization.

FIG. 8 shows a non-limiting, exemplary TGA-SA plot. TGA-SA displays no variance in equilibrium water uptake with relation to surfactant incorporation in BBCI-T-403 foams. Surfactant incorporation affects foam architecture.

FIG. 9 shows a non-limiting, exemplary in-situ FTIR spectroscopy. In-situ FTIR spectroscopy in acetonitrile allowed for understanding the propensity imidazole has for Michael additions. Disappearance of the starting BDDA carbonyl stretch confirms Michael addition reactions are present.

FIG. 10 shows a non-limiting, exemplary scheme a digital photograph of the product. BDDA addition to a BBCI-T-403 foam produces porous structure. The stepwise-isotherm TGA provides pathways for monitoring discrete weight loss steps.

FIG. 11 shows a non-limiting, exemplary TGA weight loss curves confirming imidazole capture.

FIG. 12 shows non-limiting, exemplary weight loss profiles comparing unextracted, extracted, and filled BCI foams. The increased weight loss temperature of BCI foams after addition of Michael accepter (MA) suggests successful imidazole capture, while the increase in T_{d, 5%} of the extracted foam compared to the unextracted foam suggests latent imidazole presence.

FIG. 13 shows non-limiting, exemplary microscopy images of molded foam cross sections. These images reveal good shape retention and closed cell structure. The addition of a Michael accepter to the BCI formulation resulted in increased gloss of the final part. For example, gloss can be measured with a microgloss meter, with upper end gloss values meeting or exceeding 90/95/98 at 20°/60°/85°.

FIG. 14 shows a non-limiting, exemplary digital photograph of the top of a molded foam rectangle. This foam piece released from the mold, resulting in minimal damage to the outside surface. A diamond saw was used to further shape this foam into test specimens.

FIG. 15 shows non-limiting, exemplary photographs of BCI chemistry foam properties. BCI chemistry allows for diverse foam properties comprising control over pore geometry and thermomechanical properties. Panel A shows aliphatic flexible foams. Panel B shows PDMS-doped foams with uniform cell shape. Panel C shows cyclic aliphatic and aromatic rigid foam. Panel D shows predictable pore geometry.

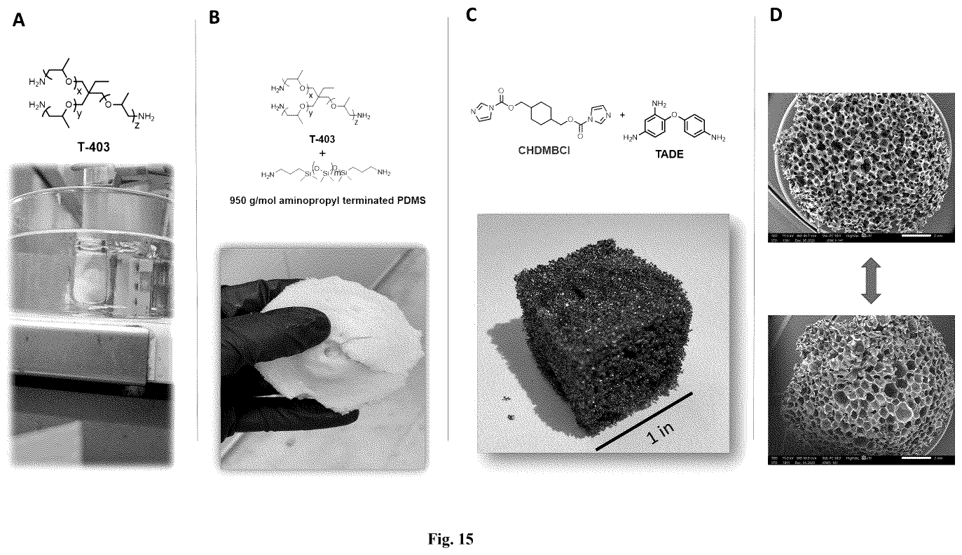

FIG. 16 shows non-limiting, exemplary comparison of CO₂ generation profiles for an aliphatic and aromatic BCI monomer. The lack of CO₂ generation in aromatic BCI monomers suggests a mechanistic importance of the β-hydrogen, through a β-hydrogen elimination pathway.

FIG. 17 shows non-limiting, exemplary schematics. The organic tertiary amine (DABCO 33-LV) catalytically promoted the amine addition to a BCI monomer. DBTDL, a traditional PU catalyst, is not effective at promoting this reaction with identical reaction conditions. Both catalysts display elongated reaction times at increased catalyst loading. A drop of catalyst was quantified as a volume of 50 μL dispensed from a micropipette.

FIG. 18 shows a non-limiting, exemplary stepwise isothermal TGA demonstrated complete removal of imidazole byproduct after solvent extraction.

FIG. 19 shows a non-limiting, exemplary TGA temperature ramp experiment with imidazole small molecule (dashed line) and BBCI-MDA:T-403 0:100 PU foam before (dotted line) and after (solid line) solvent extraction.

FIG. 20 shows non-limiting, exemplary data. Thermomechanical properties of synthesized BCI foams acquired from TMA, DSC, and TGA.

FIG. 21 shows non-limiting, exemplary data. TMA elucidated an increase in T_{g} with an increase in the concentration of the trifunctional aromatic amine, TADE, and difunctional aromatic amine, MDA, in PU foams. Mol. % calculations were calculated with respect to moles of BCI and amine functional groups.

FIG. 22 shows a non-limiting, exemplary SEM of BBCI-MDA:T-403 0:100 indicated a closed-cell or partially open-cell system.

FIG. 23 shows non-limiting, exemplary images. Controlling surface energy through surfactant addition (Dabco® DC193) in the BBCI-T-403 homopolymer foam results in an array of possible foam structures ranging from open to closed cell. Foam density is also affected with less surfactant loading (a) providing a denser foam than (b).

FIG. 24 shows non-limiting, exemplary SEM of BBCI-TADE:T-403 100:0 indicated a fully closed-cell system after addition of 0.8 wt. % Dabco® DC193 surfactant.

FIG. 25 shows a non-limiting, exemplary DSC trace of BBCI-MDA:T-403 0:100 PU foam with an observed T_{g} of −3° C.

FIG. 26 shows non-limiting, exemplary images. Introduction of surfactant (0.8 wt % Dabco® DC193) into BBCI-MDA:T-403 0:100 produced more open cells than without surfactant.

FIG. 27 shows a non-limiting, exemplary ¹H NMR, in CDCl₃, confirmed the structure and purity of the 1,4-butyl(bis-carbonylimidazolide) (1,4-BBCI)

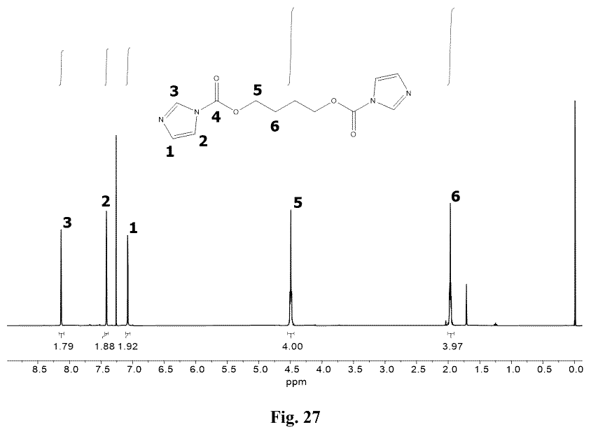

FIG. 28 shows a non-limiting, exemplary ¹H NMR, in CDCl₃, confirmed the structure and purity of the 1,4-cyclohexanedimethanol (bis-carbonylimidazolide) (1,4-CHDMBCI).

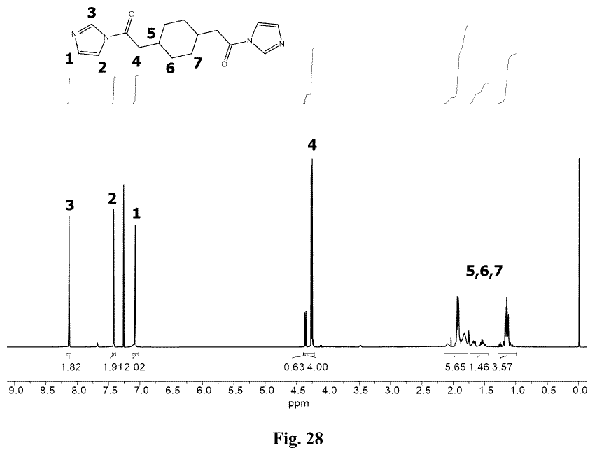

FIG. 29 shows non-limiting, exemplary data. CO₂ generation occurred rapidly once monomers were in the melt-state and increased exponentially upon gelation.

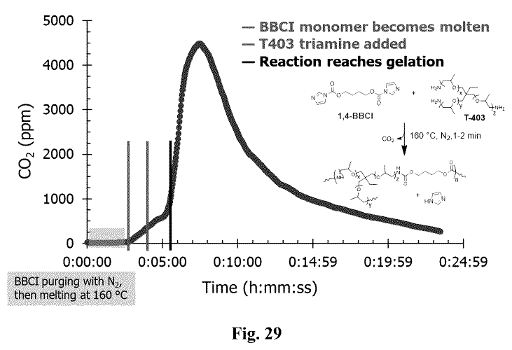

FIG. 30 shows a non-limiting, exemplary spectrum. ATR-IR confirmed presence of urethane linkages and alkene moieties of PU foams.

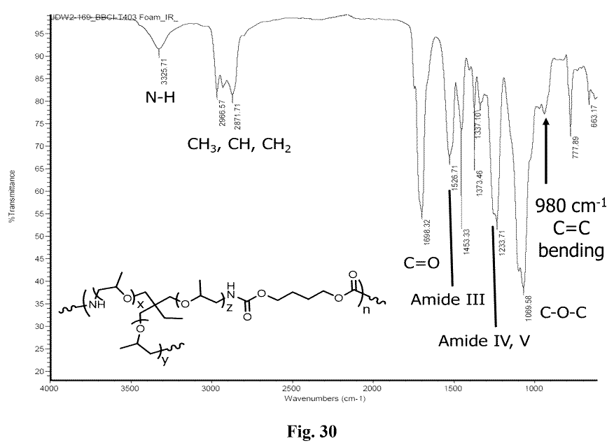

FIG. 31 shows non-limiting, exemplary TMA temperature ramp of BBCI-TADE:T-403 90:10 provided CTE from slope and T_{g} from onset point.

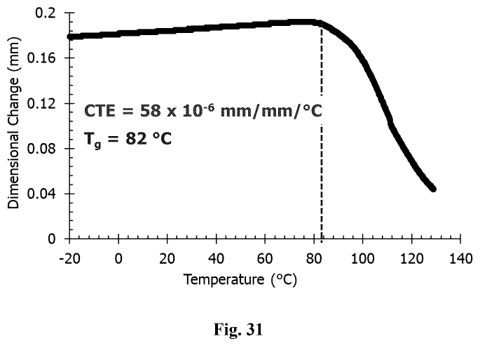

FIG. 32 shows a non-limiting, exemplary DSC trace. DSC analysis indicated that the addition of MDA increased the T_{g} of T-403-based PU foams.

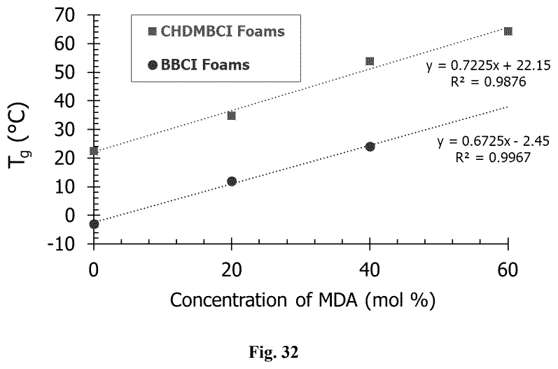

FIG. 33 shows a non-limiting, exemplary graph. The incorporation of T-403 reduced the T_{g} for TADE-based PU foams according to DSC analysis.

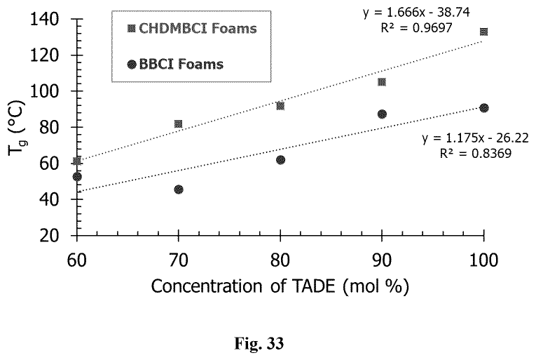

FIG. 34 shows non-limiting, exemplary images. The introduction of surfactant (0.8 wt % Dabco® DC193) into BBCI-TADE:T-403 100:0 produced a more homogeneous distribution of cells than without surfactant.

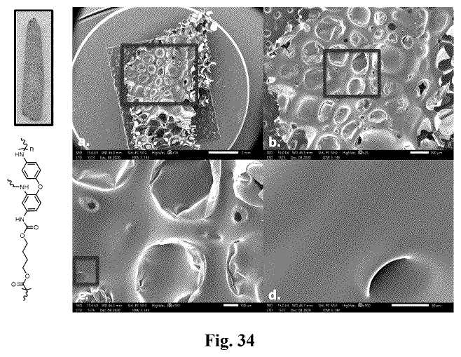

FIG. 35 shows non-limiting, exemplary ATR-FTIR spectroscopy. The ATR-FTIR confirmed polyurethane structure of all synthesized compositions.

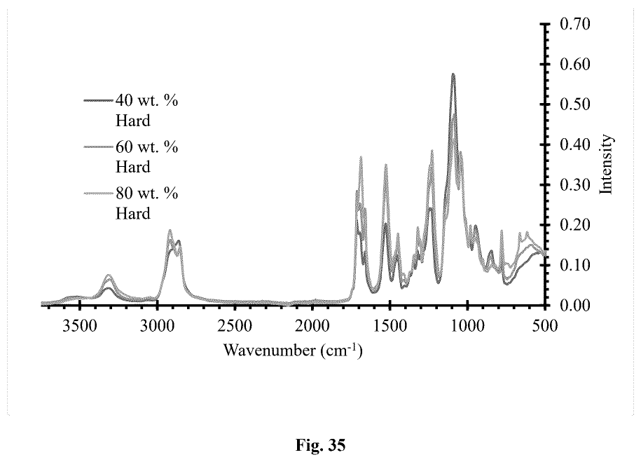

FIG. 36 shows non-limiting, exemplary TGA-SA data. TGA-SA quantified water uptake as a function of relative humidity for all synthesized NIPUs at 25° C.

FIG. 37 shows non-limiting, exemplary AFM images. The AFM images of 40 (Panel A) and 80 (Panel B) wt. % HS NIPUs revealed nanophase separation present in all samples. Electrostatic interactions between the AFM probe and NIPU surface resulted in tip dragging at an 80 wt. % HS concentration, prohibiting small area measurements.

FIG. 38 shows a non-limiting, exemplary DMA trace. Tan & maxima derived from DMA traces provided thermal transition temperatures for all samples

FIG. 39 shows non-limiting, exemplary WAXS. WAXS region for synthesized NIPU compositions.

FIG. 40 shows non-limiting, exemplary 2D graphs of 40 wt. % small (panel C), middle (panel B), and wide (panel A) x-ray scattering patterns.

FIG. 41 shows non-limiting, exemplary 2D graphs of 60 wt. % small (panel C), middle (panel B), and wide (panel A) x-ray scattering patterns.

FIG. 42 shows non-limiting, exemplary 2D graphs of 80 wt. % small (panel C), middle (panel B), and wide (panel A) x-ray scattering patterns.

FIG. 43 shows non-limiting, exemplary Lorentzian peak fitting of the 60 wt. % HS SAXS region. This fitting was used to analyze the FWHM, peak center, and peak height and was repeated for all samples.

FIG. 44 shows non-limiting, exemplary DMA traces. DMA reveals thermal transitions for all NIPU compositions, demonstrating the influence of HS concentration on thermomechanical behavior. Tan δ maxima provided thermal transition temperatures including SS T_{g}, SS Tₘ, SS rigid amorphous (RA) T_{g}, and HS T_{g}.

FIG. 45 shows non-limiting, exemplary DMA traces. DSC traces provided further insights to DMA transitions by characterizing melting point endotherms.

FIG. 46 shows non-limiting, exemplary ATR-FTIR spectra. ATR-FTIR spectroscopy reveals an increase in hydrogen-bonded carbonyls as a function of HS wt. % concentration.

FIG. 47 shows non-limiting, exemplary SAXS. SAXS scattering patterns revealed the presence of discreate phases at the nanoscale for all NIPU compositions.

FIG. 48 shows a representative AFM trace of the 60 wt. % HS sample revealed nanoscale phase separation within synthesized NIPUs. Lighter regions correspond to HS rods, while darker regimes outline the SS.

FIG. 49 shows a non-limiting, exemplary ¹³C NMR reveals change in carbonyl carbon shift.

FIG. 50 shows non-limiting, exemplary MO diagrams for BBCI and BBCIL displays shift in electron density towards carbonyl carbon.

FIG. 51 shows non-limiting, exemplary step-wise TGA-SA curve elucidates water uptake throughout a range of humidities. This increase in water uptake likely results from installed imidazolium units.

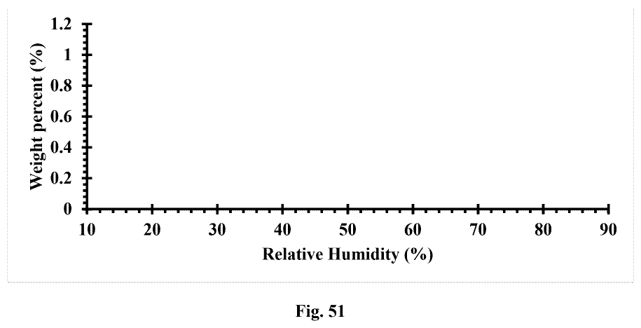

FIG. 52 shows non-limiting, exemplary ¹H NMR of BBCI IL.

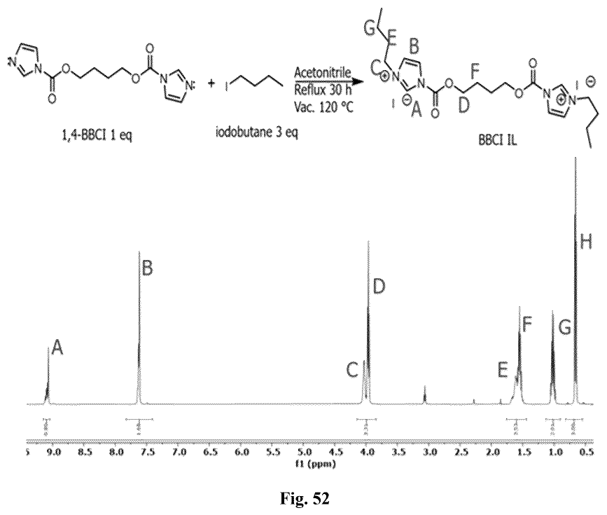

FIG. 53 shows a non-limiting, exemplary DSC trace. DSC of BBCI IL reveals T_{g}.

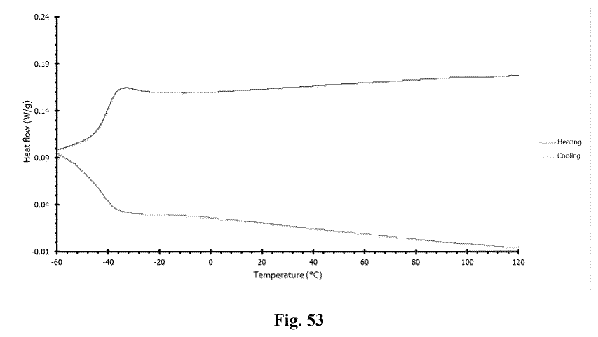

FIG. 54 shows a non-limiting, exemplary graph. CO₂ production monitoring of BBCI IL reveals no decarboxylation after imidazolium production.

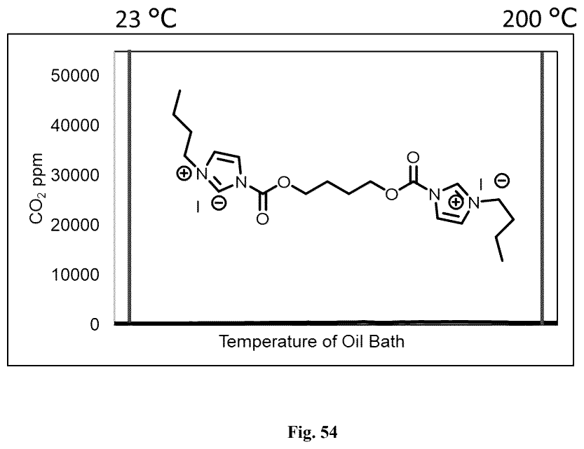

FIG. 55 shows non-limiting, exemplary in-situ FTIR spectroscopy. The FTIR spectrum tracks the disappearance of the BBCI carbonyl stretch, revealing full conversion of BBCI monomer to form BBCI IL.

FIG. 56 shows non-limiting, exemplary weight loss profiles of BBCI IL reveal an increase in T_{d, 5%}, suggesting full conversion of BBCI. The loss of basic imidazole amines inhibit CO₂ formation, increasing onset weight loss temperatures to values that match relevant imidazolium literature values.

FIG. 57 shows a non-limiting, exemplary graph. BBCI IL resists addition from primary amine, corroborated by in situ FTIR spectroscopy. The sample required 200 min to dissolve, producing the carbonyl plateau.

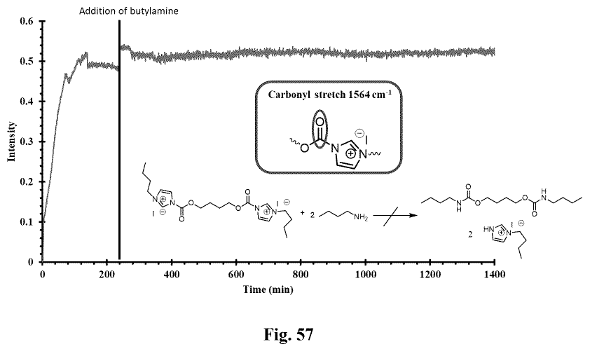

FIG. 58 shows a non-limiting, exemplary graph. Temperature dependence of ionic conductivity for neat BBCI IL. The solid line represents fitting to the VFT equation.

FIG. 59 shows a non-limiting, exemplary graph. Relative static permittivity (εₛ) data for BBCI IL measured at discrete temperatures. Error bars denote parameter errors obtained from fitting to the Havriliak-Negami function.

FIG. 60 shows non-limiting, exemplary DSC thermograms of PEG₄₀₀ ionenes containing 0 (black) and 30 (red) wt. % HS compared to the 100 wt. % HS ionene (blue). Data is shifted vertically for clarity.

FIG. 61 shows non-limiting, exemplary in-situ FTIR spectroscopy. FTIR spectroscopy probed the addition of imidazole to BDDA in the absence of catalyst in acetonitrile. Disappearance of the BDDA carbonyl informed reaction extent and kinetics at different temperatures.

FIG. 62 shows a non-limiting, exemplary schematic. Addition of BDDA to BCI foam formulations resulted in a porous, crosslinked polyurethane foam that possessed increased coloration.

FIG. 63 shows a non-limiting, exemplary step-wise isotherm TGA. TGA analysis provided accurate mass measurements of a flexible BBCI foam with and without the BDDA additive. An increase in weight loss onset for the BDDA BBCI foam indicates successful capture of the imidazole condensate.

FIG. 64 shows non-limiting, exemplary TGA data. TGA weight loss traces for neat, extracted, and BMI rigid foams revealed the effects that each method has on imidazole retention and leaching. The rigid foam sample containing the maleimide additive displayed the highest degree of thermal resistance.

FIG. 65 shows a non-limiting, exemplary schematic. TCDBCI reacts with TADA and an etheric Jeffamine® to produce a tough NIPU foam.

FIG. 66 shows a non-limiting, exemplar image of the top of a molded foam rectangle. This foam piece released from the mold, resulting in minimal damage to the outside surface. A diamond saw was used to further shape this foam into test specimens

FIG. 67 shows non-limiting, exemplary microscopy images of molded foam cross sections reveal good shape retention and closed cell structure. The addition of a Michael accepter to the BCI formulation resulted in increased gloss of the final part.

FIG. 68 shows a non-limiting, exemplary NMR spectrum and schematic. CB readily reacts with CDI to form CBBCI at high yields and purity.

FIG. 69 shows a non-limiting, exemplary image and graph. Decarboxylation experiments utilizing CBBCI display no CO₂ generation throughout a wide temperature range.

### DETAILED DESCRIPTION OF THE INVENTION

Detailed descriptions of one or more embodiments are provided herein. However, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can refer to “one,” but it is also consistent with “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably. Specifically, each of the terms used herein is consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” can refer to a process that includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, the disclosure is not necessarily limited in its application to the details set forth in the following description or exemplified by the examples. The disclosure is capable of other embodiments or of being practiced or carried out in various ways. Other compositions, compounds, methods, features, and advantages of the present disclosure will be or become apparent to one having ordinary skill in the art upon examination of the following drawings, detailed description, and examples. All such additional compositions, compounds, methods, features, and advantages can be included within this description, and be within the scope of the present disclosure.

Aspects of the invention are drawn towards a method of producing a polymer, a polymer foam, or polymer material while capturing a byproduct to form a tunable filler. For example, the polymer, polymer foam, or polymer material can comprise a polycarbonate, a polycarbonate foam, a polycarbonate material, a polyurethane, a polyurethane foam, a polyurethane material, a thiourethane, a thiourethane foam, a thiourethane material, or a co-polymer, a co-polymer material, a co-polymer foam, or composite thereof. For example, the polyurethane can be a non-isocyanate polyurethane (NIPU).

As used herein, the term “polymer matrix” can refer to the continuous phase of a polymeric material. As used herein, the terms “polymer material” can refer to a material made from polymers. As used herein, the term “polymer resin” can refer to the compounds or combination of compounds that can be used to produce a polymer, polymer foam, or polymer material.

As used herein, the term “polymer foam” can refer to a material produced by introducing a gaseous filler into a polymer matrix. In embodiments, the gaseous filler can be any gaseous filler known in the art. For example, non-limiting, exemplary gaseous fillers can comprise air, nitrogen, or heptanes. As used herein, the terms “blowing agent” and “gaseous filler” can be used interchangeably. As used herein, the term “blowing agent” can refer to a substance that can produce holes in the polymer matrix, thereby forming a cellular material. In embodiments, the blowing agent can comprise any blowing agent known in the art. In embodiments, the blowing agent can comprise a physical blowing agent, a chemical blowing agent, or a combination thereof. For example, the blowing agent can comprise CO₂, N₂, heptanes, hexanes, chloro-fluorocarbons, air, or any combination thereof. In some embodiments, the blowing agent can be CO₂ produced by decarboxylation when heating the reaction. In embodiments, the blowing agent introduces porosity into the polymer matrix. In embodiments, the porosity can be tuned by the reaction temperature, the surfactant composition and loading, the viscosity, the catalyst loading, and the amount of gas produced. These parameters can be tuned by one of ordinary skill in the art using methods known in the art.

Aspects of the disclosure are drawn towards a resin comprising: a bis-carbonylimidazolide (BCI) monomer or derivative thereof, a multifunctional nucleophile, and a Micheal acceptor additive. In embodiments, the resin can comprise a thermosetting resin or a thermoplastic resin. In embodiments, the the multifunctional nucleophile can be selected from the group consisting of a multifunctional primary amine, a multifunctional secondary amine, a multifunctional thiol, or a multifunctional alcohol.

As used herein, BCI can refer to a BCI monomer or a BCI derivative thereof. As used herein, the term “BCI derivative” can refer to a BCI monomer wherein the end groups comprise a substituted imidazole group.

As used herein the term “substituted” can refer to substituents of the compounds and/or materials described herein. Substituents can comprise acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and can comprise one or more heteroatoms such as oxygen, sulfur, or nitrogen grouping in linear, branched, or cyclic structural formats.

Representative substituents comprise alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, amino acid, peptide, and polypeptide groups. As used herein in reference to an “R” group, the name used to describe said “R” group can be the chemical name prior to the removal of a hydrogen. For example, wherein “R” is described as an “alkane” can refer to an “alkyl” group.

Heteroatoms such as nitrogen can have hydrogen substituents and/or substituents of organic compounds described herein which satisfy the valences of the heteroatoms. It is understood that “substitution” or “substituted” comprises substitutions is accordance with permitted valence of the substituted atom and the substituent.

In embodiments, substituents can comprise acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms for example, nitrogen can have hydrogen substituents and/or substituents of organic compounds described herein which satisfy the valencies of the heteroatoms.

For example, the substituent can be selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like.

In embodiments, the bis-carbonylimidazolide (BCI) monomer or derivative thereof can be a multi-carbonylimidazolide such as a tris-carbonylimidazolide or a tetra-carbonylimidazolide. For example, the multi-carbonylimidazolide can be formed by reacting CDI with a multifunctional alcohol.

In embodiments, the bis-carbonylimidazolide (BCI) monomer or derivative thereof is

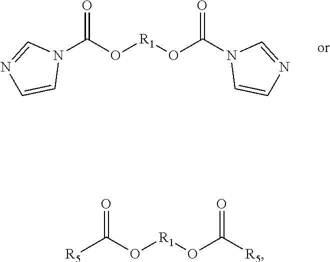

wherein —O—R₁—O— is taken together and selected from the group consisting of: a polyol, a diol, an aliphatic alcohol, a cyclic alcohol, and an aromatic alcohol; or R₁ is selected from the group consisting of:

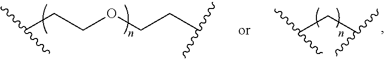

wherein n=1-10; -alkyl-; -aryl-; -cycloalkyl-; heterocyclyl-; -heteroaryl-;

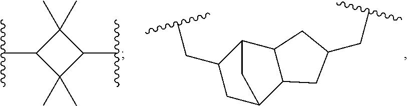

or a substituted derivative thereof; and wherein, R₅ is selected from the group consisting of:

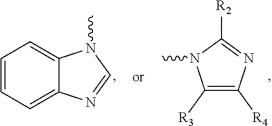

wherein R₂ is selected from the group consisting of a hydrogen, an alkyl group, an aryl group, a vinyl group, or an inorganic substituent; wherein R₃ is selected from the group consisting of a hydrogen, an alkyl group, an aryl group, a vinyl group, or an inorganic substituent; and wherein R₄ is selected from the group consisting of a hydrogen, an alkyl group, an aryl group, a vinyl group, an inorganic group, or a substituted derivative thereof. For example, non-limiting exemplary alkyl groups comprise methyl and ethyl substituents.

As used herein, the term “multifunctional nucleophile” can refer to a compound that has at least two nucleophilic moieties. For example, the multifunctional nucleophile can be any multifunctional nucleophile known in the art. In embodiments, when there are greater than 2 nucleophilic moieties, the resulting polymer can be crosslinked or branched. Non-limiting, exemplary multifunctional nucleophile can comprise:

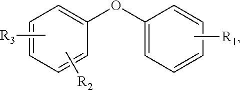

wherein R₁, R₂, and R₃ are independently selected from the group consisting of —H, —NH₂, —NR₄, —OH, or —SH, wherein R₄ is an alkyl group;

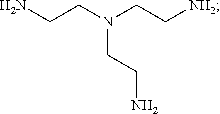

a polyetherimide;

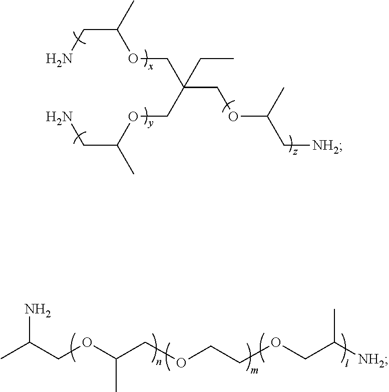

a dendritic nucleophile; or

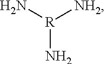

wherein R is a trialkylamine.

In embodiments, x, y, and z can independently be 0, 1, 2, 3, 4, 5, 6, 7, 8, 9, 10, 11, 12, 13, 14, 15, 16, 17, 18, 19, 20, or greater than 20. For example, x can be 2, y can be 2, and z can be 2. For example, x can be about 2, y can be about 2, and z can be about 3. For example, x can be 2 or 3, y can be 2 or 3, and z can be 2 or 3. For example, x can be 2, y can be 5, and z can be 10. In embodiments, n, m, and l can independently be 0, 1, 2, 3, 4, 5, 6, 7, 8, 9, 10, 11, 12, 13, 14, 15, 16, 17, 18, 19, 20, 21, 22, 23, 24, 25, or greater than 25. For example, n can be about 1 to about 3, 1 can be about 1 to about 3, and m can be about 19. In embodiments R₄ can be any alkyl or substituted alkyl. For example, R₄ can be ethyl or methyl.

In embodiments, the dendritic nucleophile described herein can be any dendritic nucleophile known in the art. For example, the dendritic nucleophile can be:

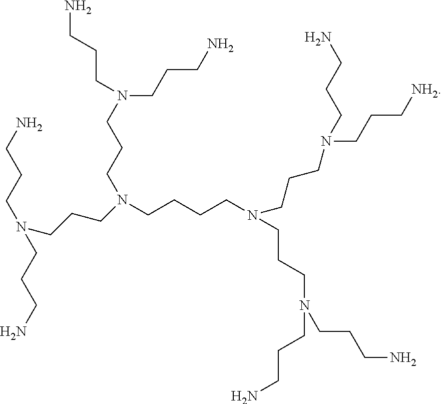 [SMILES: NCCCN(CCCN)CCCN(CCCCN(CCCN(CCCN)CCCN)CCCN(CCCN)CCCN)CCCN(CCCN)CCCN]

For example, the dendritic nucleophile can comprise a G1, G2, G3, G4, G5, G6, G7, or G8 dendrimer.

In embodiments, the Michael acceptor additive comprises a Michael acceptor. The Michael acceptor can comprise any Michael acceptor known in the art. As used herein, the term “additive” can refer to a composition that is added to a polymer or polymer composite to enhance or modify the polymer or polymer composite properties. As used herein, the terms “polymer additive” and “additive” can be used interchangeably. In embodiments, the additive can modify the physical properties of the polymer or polymer material. For example, the physical properties of the polymer can comprise, but are not limited to, mechanical properties, tensile strength, elasticity, toughness, glass transition temperature, permeability, resistance to electric current, hardness, thermal conductivity, thermal expansion, density, strain, or a combination thereof. In embodiments, the terms “additive” and “filler” can be used interchangeably. For example, in embodiments, the additive can be a filler in a foam system.

In non-limiting, exemplary Michael acceptor comprise:

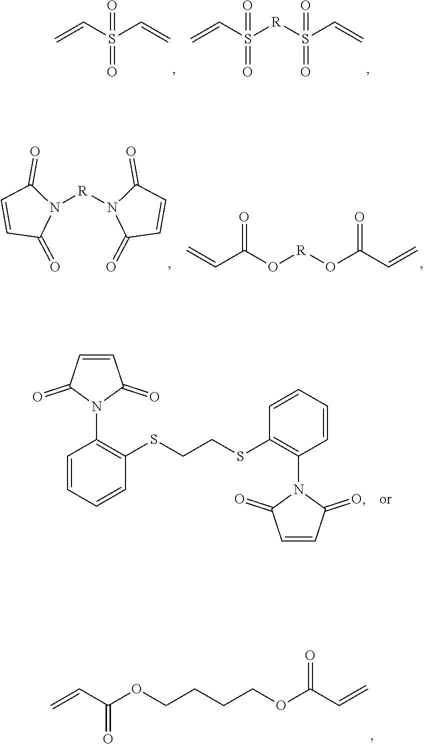

wherein R is:

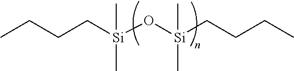

and n=1-10,

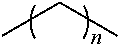

and n=1-10,

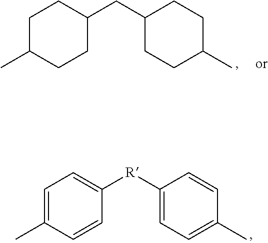

wherein R′ is an electron withdrawing group, an electron donating group, or a neutral group. For example, R′ can be an oxygen, sulfur, sulfone, or ketone.

As used herein, the term “alkyl” can refer to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups. In embodiments, the notation-alkyl can refer to an alkyl group with a radical at each end, thereby forming the appropriate valency upon attachment.

In some embodiments, a straight chain or branched chain alkyl has 30 or fewer carbon atoms in its backbone (e.g., C1-C30 for straight chains, C3-C30 for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which can refer to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

As used herein, the moieties substituted on the hydrocarbon chain can themselves be substituted. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

As used herein, the term “heteroalkyl”, can refer to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as described herein for alkyl groups.

The term “alkylthio” refers to an alkyl group, as defined above, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined above for alkyl groups.

The terms “alkenyl” and “alkynyl”, refer to unsaturated aliphatic groups analogous in length and possible substitution to the alkyls described above, but that contain at least one double or triple bond respectively.

The terms “alkoxyl” or “alkoxy” as used herein refers to an alkyl group, as defined above, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined herein. The alkoxy and aroxy groups can be substituted as described above for alkyl.

As used herein, “Aryl” can refer to a monovalent aromatic hydrocarbon radical derived by the removal of one hydrogen atom from a single carbon atom of a parent aromatic ring system. Aryl groups can comprise groups derived from aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene, and the like. For example, an aryl group can comprise about 6 to about 20 carbon atoms.

In embodiments, the aryl group can be a “heteroaryl” group. As used herein, the term heteroaryl” can refer to a monocyclic or fused bicyclic or tricyclic aromatic ring assembly containing 5 to 16 ring atoms, where from 1 to 5 of the ring atoms are a heteroatom such as N, O or S. Heteroaryl groups can comprise any number of ring atoms, such as, 5 to 6, 3 to 8, 4 to 8, 5 to 8, 6 to 8, 3 to 9, 3 to 10, 3 to 11, or 3 to 12 ring members. Any number of heteroatoms can be included in the heteroaryl groups, such as 1, 2, 3, 4, or 5, or 1 to 2, 1 to 3, 1 to 4, 1 to 5, 2 to 3, 2 to 4, 2 to 5, 3 to 4, or 3 to 5. Heteroaryl groups can have from 5 to 8 ring members and from 1 to 4 heteroatoms, or from 5 to 8 ring members and from 1 to 3 heteroatoms, or from 5 to 6 ring members and from 1 to 4 heteroatoms, or from 5 to 6 ring members and from 1 to 3 heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups can be substituted or unsubstituted.

As used herein, the term “cycloalkyl” can refer to a saturated monocyclic, bicyclic, fused bicyclic or bridged polycyclic ring assembly containing from 3 to 12 ring atoms, or the number of atoms indicated. Cycloalkyl can include any number of carbons, such as 3 to 6 carbon atoms, 4 to 6 carbon atoms, 5 to 6 carbon atoms, 3 to 8 carbon atoms, 4 to 8 carbon atoms, 5 to 8 carbon atoms, 6 to 8 carbon atoms, 7 to 8 carbon atoms, 3 to 9 carbon atoms, 4 to 9 carbon atoms, 5 to 9 carbon atoms, 6 to 9 carbon atoms, 7 to 9 carbon atoms, 8 to 9 carbon atoms, 3 to 10 carbon atoms, 4 to 10 carbon atoms, 5 to 10 carbon atoms, 6 to 10 carbon atoms, 7 to 10 carbon atoms, 8 to 10 carbon atoms, 9 to 10 carbon atoms, 3 to 11 carbon atoms, 4 to 11 carbon atoms, 5 to 11 carbon atoms, 6 to 11 carbon atoms, 7 to 11 carbon atoms, 8 to 11 carbon atoms, 9 to 11 carbon atoms, 10 to 11 carbon atoms, 3 to 12 carbon atoms, 4 to 12 carbon atoms, 5 to 12 carbon atoms, 6 to 12 carbon atoms, 7 to 12 carbon atoms, 8 to 12 carbon atoms, 9 to 12 carbon atoms, 10 to 12 carbon atoms, and 11 to 12 carbon atoms. Monocyclic cycloalkyl rings comprise, for example, cyclopropyl, cyclobutyl, cyclopentyl, cyclohexyl, and cyclooctyl. Bicyclic compounds comprise spirocyclic compounds, fused bicyclic compounds and bridged bicyclic compounds. Bicyclic and polycyclic cycloalkyl rings include, for example, norbornane, bicyclooctane, decahydronaphthalene and adamantane. When cycloalkyl is a monocyclic C3-8 cycloalkyl, exemplary groups include, but are not limited to cyclopropyl, cyclobutyl, cyclopentyl, cyclohexyl, cycloheptyl and cyclooctyl. When cycloalkyl is a monocyclic C3-6 cycloalkyl, exemplary groups include, but are not limited to cyclopropyl, cyclobutyl, cyclopentyl, and cyclohexyl. Cycloalkyl groups can be substituted or unsubstituted.

In embodiments, cycloalkyl compounds can comprise cycloalkenyl compounds. As used herein, the term “cycloalkenyl” can refer to a mono- or multi-cyclic hydrocarbon ring system that contains one or more double bonds in at least one ring. However, if there is more than one double bond, the double bonds cannot form a fully delocalized pi-electron system throughout all the rings (otherwise the group would be “aryl,” as described herein). When composed of two or more rings, the rings can be connected together in a fused fashion. Cycloalkenyl can comprise any number of carbons, such as 3 to 6 carbon atoms, 4 to 6 carbon atoms, 5 to 6 carbon atoms, 3 to 8 carbon atoms, 4 to 8 carbon atoms, 5 to 8 carbon atoms, 6 to 8 carbon atoms, 7 to 8 carbon atoms, 3 to 9 carbon atoms, 4 to 9 carbon atoms, 5 to 9 carbon atoms, 6 to 9 carbon atoms, 7 to 9 carbon atoms, 8 to 9 carbon atoms, 3 to 10 carbon atoms, 4 to 10 carbon atoms, 5 to 10 carbon atoms, 6 to 10 carbon atoms, 7 to 10 carbon atoms, 8 to 10 carbon atoms, 9 to 10 carbon atoms, 3 to 11 carbon atoms, 4 to 11 carbon atoms, 5 to 11 carbon atoms, 6 to 11 carbon atoms, 7 to 11 carbon atoms, 8 to 11 carbon atoms, 9 to 11 carbon atoms, 10 to 11 carbon atoms, 3 to 12 carbon atoms, 4 to 12 carbon atoms, 5 to 12 carbon atoms, 6 to 12 carbon atoms, 7 to 12 carbon atoms, 8 to 12 carbon atoms, 9 to 12 carbon atoms, 10 to 12 carbon atoms, and 11 to 12 carbon atoms. Representative cycloalkenyl groups comprise, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. A cycloalkenyl group can be unsubstituted or substituted.

As used herein, the term “heterocyclyl” can refer to a cycloalkyl as described herein, having from 3 to 12 ring members and from 1 to 4 heteroatoms of N, O and S. As used herein, the terms “heterocyclyl” and “heterocycloalkyl” can be used interchangeable. As used herein, heterocyclyl comprises bicyclic compounds which comprise a heteroatom. Bicyclic compounds comprise spirocyclic compounds, fused bicyclic compounds, and bridged bicyclic compounds The heteroatoms can also be oxidized, such as, but not limited to, —S(O)— and —S(O) 2-. Heterocycloalkyl groups can include any number of ring atoms, such as, 3 to 6, 4 to 6, 5 to 6, 3 to 8, 4 to 8, 5 to 8, 6 to 8, 3 to 9, 3 to 10, 3 to 11, or 3 to 12 ring members. Any suitable number of heteroatoms can be included in the heterocycloalkyl groups, such as 1, 2, 3, or 4, or 1 to 2, 1 to 3, 1 to 4, 2 to 3, 2 to 4, or 3 to 4. The heterocycloalkyl group can include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxetane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. The heterocycloalkyl groups can also be fused to aromatic or non-aromatic ring systems to form members including, but not limited to, indoline. Heterocycloalkyl groups can be unsubstituted or substituted. For example, heterocycloalkyl groups can be substituted with C1-6 alkyl or oxo (—O), among many others.

As used herein, the term “imide” can refer to —C(O) NR′R″, wherein R′ and R″ are each independently hydrogen, or a substituted or unsubstituted alkyl, cycloalkyl, alkenyl, alkynyl, aryl aralkyl, heterocyclyl or heterocyclylalkyl group as defined herein.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

As used herein, the terms “amine” and “amino” are art-recognized and refer to both unsubstituted and substituted amines, e.g., a moiety that can be represented by the general formula:

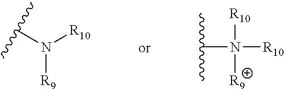

wherein R₉, R₁₀, and R₁₀′ each independently represent a hydrogen, an alkyl, an alkenyl, —(CH₂)ₘ-Rs or R₉ and R₁₀ taken together with the N atom to which they are attached complete a heterocycle having from 4 to 8 atoms in the ring structure; R₅ represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R₁₀′) each independently represent a hydrogen, an alkyl or cycloalkyl, an alkenyl or cycloalkenyl, or alkynyl. Thus, the term “alkylamine” as used herein can refer to an amine group, as defined above, having a substituted (as described above for alkyl) or unsubstituted alkyl attached thereto, i.e., at least one of R₉ and R₁₀ is an alkyl group.

In embodiments, the BCI monomer or derivative thereof comprises less than about 1 weight %, about 1 weight %, about 5 weight %, about 10 weight %, about 15 weight %, about 20 weight %, about 25 weight %, about 30 weight, about 40 weight %, about 50 weight %, about 60 weight %, about 70 weight %, about 75 weight %, about 80 weight %, about 90 weight %, or greater than about 90 weight %. For example, the BCI monomer or derivative thereof can comprise about 10 weight % to about 90 weight %.

In embodiments, the amine is comprises less than about 1 weight %, about 1 weight %, about 5 weight %, about 10 weight %, about 15 weight %, about 20 weight %, about 25 weight %, about 30 weight, about 40 weight %, about 50 weight %, about 60 weight %, about 70 weight %, about 75 weight %, about 80 weight %, about 90 weight %, or greater than about 90 weight %. For example, the amine can comprise about 10 weight % to about 90 weight %.

In embodiments, the Michael acceptor additive comprises about 1 weight %, about 1 weight %, about 5 weight %, about 10 weight %, about 15 weight %, about 20 weight %, about 25 weight %, about 30 weight, about 40 weight %, about 50 weight %, about 60 weight %, about 70 weight %, about 75 weight %, about 80 weight %, about 90 weight %, or greater than about 90 weight %. For example, the Michael acceptor can be present in about 1 weight % to about 90 weight % of the resin.

Aspects of the invention are drawn towards a method of producing a polymer, a polymer foam, or polymer matrix while capturing a byproduct to form a tunable filler. For example, the polymer, polymer foam, or polymer matrix can comprise a polycarbonate, a polycarbonate foam, a polycarbonate matrix, a polyurethane, a polyurethane foam, a polyurethane matrix, a thiourethane, a thiourethane foam, a thiourethane matrix, or a co-polymer, a co-polymer matrix, a co-polymer foam, or composite thereof thereof.

In embodiments, the method can comprise combining a bis-carbonylimidazolide (BCI) monomer, or derivative thereof, and a Michael acceptor additive to produce a pre-reaction mixture; reacting the pre-reaction mixture with at least one multifunctional nucleophile, thereby producing a polymer or polymer material, wherein the polymer or polymer material releases a Michael donor byproduct; and reacting the Michael donor byproduct with the Michael acceptor additive, thereby capturing the Michael donor byproduct by forming a Michael addition filler.

In embodiments, the Michael donor byproduct comprises a Michael donor. For example, the Micheal donor can be any Michael donor known in the art. In embodiments, the Michael donor comprises:

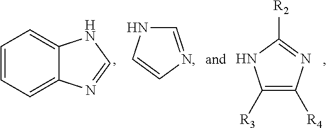

wherein, wherein R₂ is selected from the group consisting of a hydrogen, an alkyl group, an aryl group, a vinyl group, or an inorganic substituent; wherein R₃ is selected from the group consisting of a hydrogen, an alkyl group, an aryl group, a vinyl group, or an inorganic substituent; and wherein R₄ is selected from the group consisting of a hydrogen, an alkyl group, an aryl group, a vinyl group, or an inorganic substituent. In embodiments, the bis-carbonylimidazolide (BCI) monomer or derivative thereof can be any BCI monomer or derivative thereof known in the art. In embodiments, the bis-carbonylimidazolide (BCI) monomer or derivative thereof is

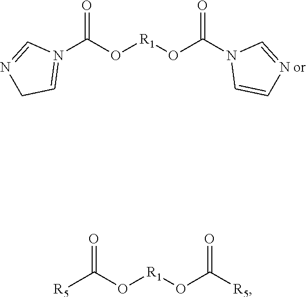

wherein —O—R₁—O— is taken together and selected from the group consisting of a polyol, a diol, an aliphatic alcohol, a cyclic alcohol, and an aromatic alcohol; or R₁ is selected from the group consisting of:

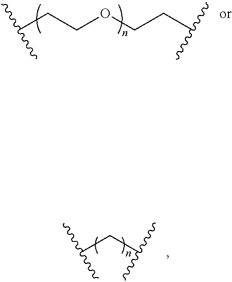

wherein n=1-10; alkyl-; -aryl-; -cycloalkyl-; -heterocyclyl-; -heteroaryl-;

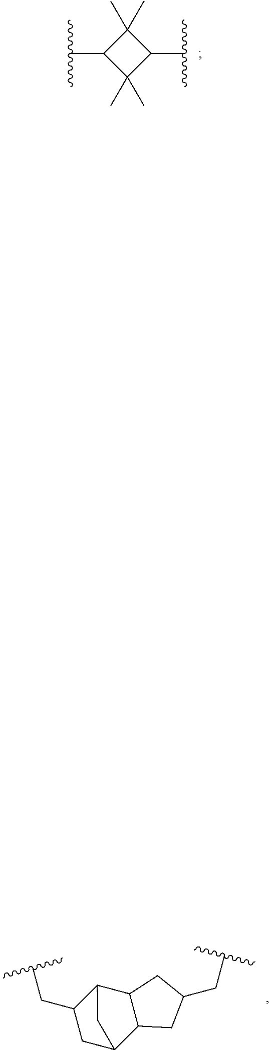

or a substituted derivative thereof; and
wherein, R₅ is selected from the group consisting of:

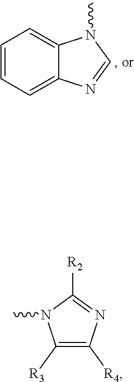

and
wherein R₂ is selected from the group consisting of a hydrogen, an alkyl group, an aryl group, a vinyl group, or an inorganic substituent; wherein R₃ is selected from the group consisting of a hydrogen, an alkyl group, an aryl group, a vinyl group, or an inorganic substituent; and wherein R₄ is selected from the group consisting of an alkyl group, an aryl group, a vinyl group, or an inorganic substituent. In embodiments, the polyol is a polyethylene glycol (PEG), a polypropylene glycol (PPG), a polyester diol, or a polydimethylsiloxane (PDMS) diol. In embodiments, the cyclic alcohol is isosorbide.

In embodiments, the Michael acceptor additive comprises a Michael acceptor. In embodiments, the Michael acceptor comprises:

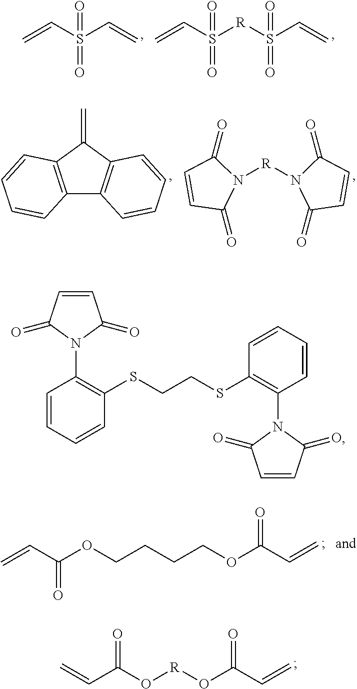

wherein R is selected from the group consisting of:

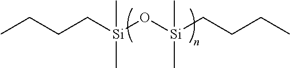

and n=1-10,

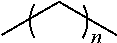

and n=1-10,

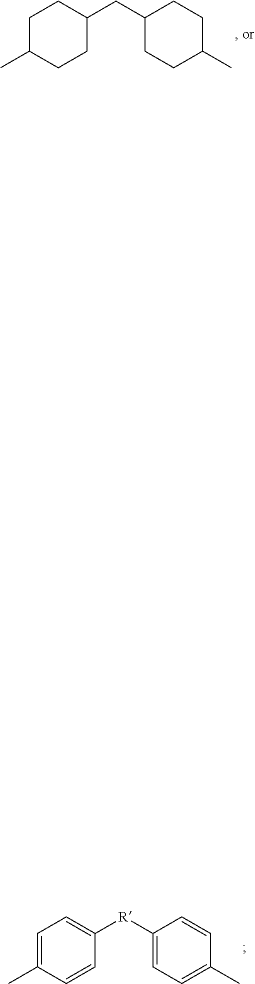

wherein R′ is an electron withdrawing group, an electron donating group, or a neutral group. Non-limiting examples of R′ can comprise comprise O, SO₂, PHO, a phosphine oxide, a ketone, C, C(CX₃)₂, CX₂, or a nitro group, wherein X is Cl, F, or Br.

For example, the multifunctional nucleophile can comprise,

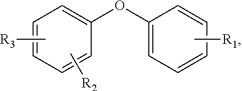

wherein R₁, R₂, and R₃ are independently selected from the group consisting of —H, —NH₂, —NR₄, —OH, or —SH, wherein R₄ is an alkyl group. In embodiments, the multifunctional nucleophile can comprise

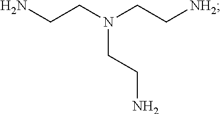

a polyetherimide;

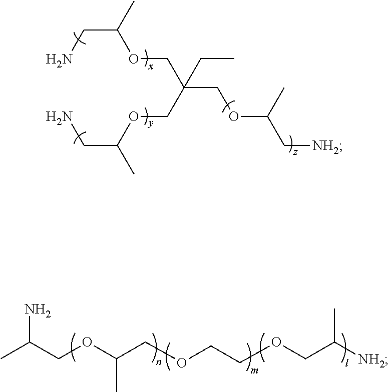

a dendritic nucleophile; or

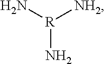

wherein R is a trialkylamine.
In embodiments, x, y, and z can independently be 0, 1, 2, 3, 4, 5, 6, 7, 8, 9, 10, 11, 12, 13, 14, 15, 16, 17, 18, 19, 20, or greater than 20. For example, x can be 2, y can be 2, and z can be 2. For example, x can be about 2, y can be about 2, and z can be about 3. For example, x can be 2 or 3, y can be 2 or 3, and z can be 2 or 3. For example, x can be 2, y can be 5, and z can be 10. In embodiments, n, m, and l can independently be 0, 1, 2, 3, 4, 5, 6, 7, 8, 9, 10, 11, 12, 13, 14, 15, 16, 17, 18, 19, 20, 21, 22, 23, 24, 25, or greater than 25. For example, n can be about 1 to about 3, 1 can be about 1 to about 3, and m can be about 19. In embodiments R₄ can be any alkyl or substituted alkyl. For example, R₄ can be ethyl or methyl.

In embodiments, the multifunctional nucleophile comprises a multifunctional aromatic nucleophile or a multifunctional aliphatic nucleophile. In embodiments, the multifunctional nucleophile can comprise any multifunction nucleophile known in the art. For example, the multifunctional nucleophile can comprise:

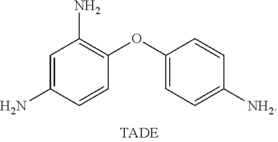 [SMILES: Nc1ccc(Oc2ccc(N)cc2N)cc1]

In further embodiments, the method comprises further adjusting the reaction rate by tuning the Michael acceptor additive comprising: determining if the reaction rate should be increased or decreased; and selecting a more electron withdrawing Michael acceptor to increase the reaction rate, or selecting a less electron withdrawing Michael acceptor to decrease the reaction rate.

In further embodiments, the method comprises targeting polymer and/or polymer matrix mechanical properties by tuning the Michael acceptor additive comprising: targeting an increased T_{g} and modulus or targeting a decreased T_{g} and modulus; and selecting a rigid Michael acceptor additive to increase T_{g} and modulus, or selecting a flexible Michael acceptor additive to decrease T_{g} and modulus.

Aspects of the invention are drawn towards a method of producing a polymer foam. In embodiments, the method can comprise any method known in the art for producing foam. For example, the method can comprise heating a polymer resin to a temperature sufficient to produce a polymer melt, adding a blowing agent to the polymer melt, mixing the polymer melt with the blowing agent, allowing the polymer melt to nucleate, cooling the nucleated polymer melt, thereby forming a polymer foam. In embodiments, the blowing agent can be produced from the same monomer that is found in the foam product. For example, the blowing agent can be produced by a BCI monomer. For example, heating the reaction mixture can decarboxylate a reactant in the polymer melt, thereby producing CO₂.

Aspects of the disclosure are drawn towards a polymer, a polymer material, or a polymer foam produced by any method described herein.

### Non-Limiting, Exemplary Tuning of Properties via Polymer Additives

Those of ordinary skill in the art can use any method known in the art to tune the properties of the polymer or polymer materials described herein via a polymer additive described herein. For example, the Michael acceptors described herein can be tuned with different chemistries to target various thermomechanical properties. These properties can comprise modulus, dielectric constant, T_{g}, toughness, stiffness, and stress-relaxation. More rigid Michael acceptor compounds can act as a rigid filler after reaction, leading to a tougher material and increase in the modulus, dielectric constant, T_{g}, toughness, stiffness, and stress-relaxation. A more flexible Michael acceptor can allow for softening of the final thermoset. This can be used to match acceptor and thermoset characteristics. For example, balancing the Michael acceptor chemical structure to tune final properties as well as mixing of the final thermoset and filler that prevents blooming or leaching of the additive. These characteristics comprise T_{g}, modulus, toughness, and thermal stability. Without wishing to be bound by theory, R groups can comprise inorganic groups, linear aliphatic groups, hindered cyclic aliphatic groups, and aromatic groups that can tune electronic properties in addition to physical ones. For example, dielectric properties and modulus. Control over R groups and Michael acceptor chemical structures can allow tuning of miscibility with curing matrix.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

Non-Isocyanate Polyurethanes from Carbonyl Diimidazole (CDI)-New Monomers for Rigid Foam Formulations, Imidazole Capture, and Onboarding Efforts

### Chemical Background

The synthesis of non-isocyanate polyurethanes from biscarbonyl imidazolide (BCI) monomers has been shown (1, 2). These monomers liberated imidazole as the polymerization progressed, leading to issues where byproducts contaminated the final thermoset, requiring extraction before final part use. The new methodology described herein leverages a Michael addition to circumvent this removal process. The addition of a mono- or multifunctional Michael acceptor enables the quantitative capture of this condensate, indicated through in-situ FTIR and thermogravimetric analysis. Scheme 1 outlines this chemistry. The final Michael addition product acts as a stiffening agent for the final product, however this property is tunable by altering the chemical structure of the Michael acceptor. Rigid acceptors can increase structural stability, while flexible moieties can retain low modulus. Rigid Michael acceptors comprise chemical structures that inhibit molecular mobility of the final thermoset. For example, small molecule acceptors that contain cyclic or aromatic structures. Additionally, hydrogen bond moieties and pi-pi stacking present in the acceptors can stiffen the final material. Flexible moieties comprise siloxane or etheric containing acceptors or flexible aliphatic chains. Utilizing flexible or rigid Michael acceptors can tune compressive modulus. For example, the Michael acceptors can tune the compressive modulus from about 0.01 to about 2000 psi.

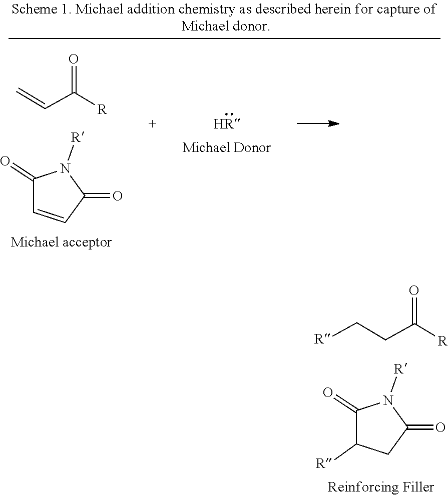

### Synthesis of New BCI Monomers for Rigid Foam Applications:

Rigid BCI and amine monomers produce high T_{g} foams imparted with high compressive moduli. These monomers included TADE, an aromatic triamine, and BCI monomers derived from cyclohexane dimethanol and cyclohexane diol. While the resulting foams demonstrated favorable thermomechanical properties, elevated processing temperatures of 180-230° C. prevented a practical implementation of these monomers. Due to these issues, low melting monomers capable of high-performance foams was still of interest. Two commercial diols, 2,2′-4,4′-tetramethylcyclobutane (CB) and tricyclodecane dimethanol (TCD) were chosen for BCI monomer synthesis. Both CB and TCD contain bulky substituents, which result in decreased backbone mobility, in turn raising T_{g}. Furthermore, the bulkiness of the BCI monomer can decrease packing efficiency, lowering the melting point of the monomer. To that end, two new BCI monomers were synthesized and evaluated for use in a foam procedure, shown in Scheme 2. In embodiments, without wishing to be bound by theory, a BCI derivative can be used in place of BCI.

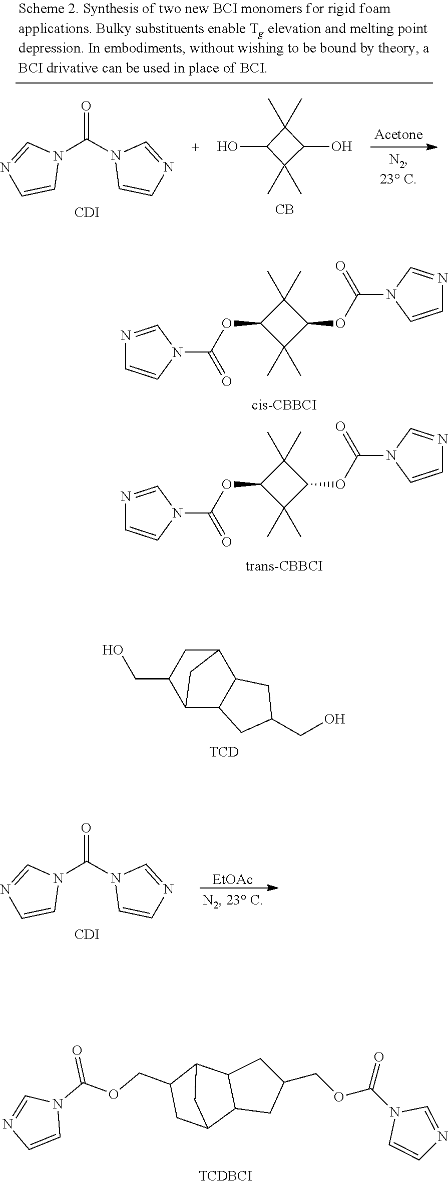

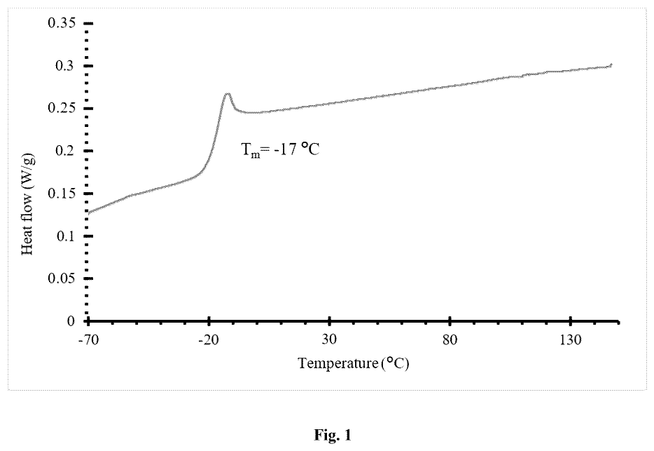

Both monomers proved to possess interesting properties. The TCDBCI monomer presented as a liquid at room temperature, which was necessary to achieve the desired processing conditions of 100° C. DSC analysis revealed a low melting point of −17° C., FIG. 1. However, this low melting point was accompanied by high monomer viscosity.

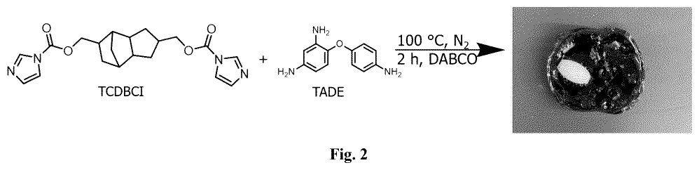

The low melting point of TCDBCI monomer allowed us to probe CO₂ generation at lower temperatures. Studies on low temperature CO₂ generation have been limited by the melting point of the BCI monomer (>140° C.). Without wishing to be bound by theory, this can be due to the bimolecular reaction kinetics involved in the β-hydrogen elimination. The decarboxylation of BCI monomers can be an avenue for foam blowing (see, e.g., Sintas et al., Polm. Chem., 2023, 14, 1487). Results indicate that the DABCO catalyst enhances both reactivity and CO₂ generation. Leveraging this tertiary amine catalyst enabled the first ever synthesis of a BCI NIPU foam at a temperature of 100° C. Figure. 2 highlights exemplary reaction conditions for this achievement as well as the cured product.

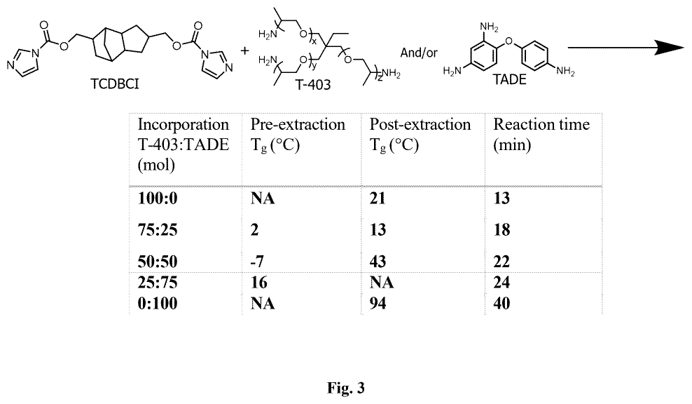

Excitingly, low temperature foam synthesis as well as increased thermomechanical performance were achieved. Lower processing temperatures can be beneficial for consuming less energy consumption. Additionally, because the reaction itself is exothermic, as you scale this reaction up the possibility of reaching exceedingly high temperatures is increased. This can lead to fires. The flammability of the NIPU foams made here have not been evaluated. The liquid monomers can also allow for mixing of reactive compounds at lower temperatures, enabling low temperature reactions to commence. The TCDBCI-TADE homopolymer produced a microcellular structure with a T_{g} of 94° C. Upon extraction the homopolymer partially dissolved in the chloroform media, indicating incomplete crosslink conversion. This can be explained by the high T_{g} of the homopolymer. As monomers react and build molecular weight, their properties (T_{g}, viscosity, etc.) increase as well. As the T_{g} of this foam approached 94° C. the mobility of reacting chains dramatically decreased. With the reaction temperature of 100° C., the high T_{g} prevented any mobility of reacting chains, causing incomplete crosslinking. In order to achieve a fully crosslinked foam while maintaining a reaction temperature of 100° C. a second, flexible amine was incorporated. The addition of this amine lowered the T_{g} of the foam so that the mobility of growing chains remained sufficient for continued reactions, FIG. 3.

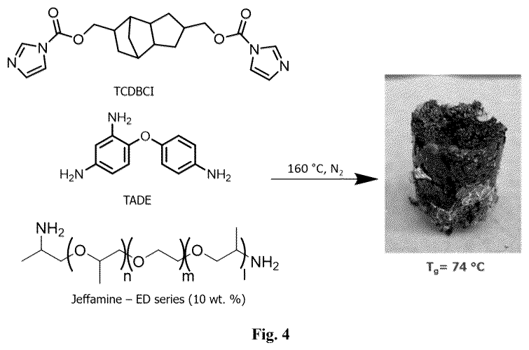

The incorporation of T-403 decreased the final T_{g} value, while also lowering reaction times. The lower reaction times are a direct result of more reactive aliphatic amines. These results impart increased versatility in relation to reaction temperatures, kinetics, and thermal properties. Building off this understanding, new additives were explored. Flexible, difunctional crosslinkers were employed instead of a flexible trifunctional crosslinker. This allows for increased conversion during the foaming process by decreasing kinetic limitations that crosslinks impose. To mimic the structure-property relationships of T-403, another polypropylene glycol Jeffamine (ED-2003) was employed. FIG. 4 displays a foam synthesized with 10 wt. % of this amine. We were able to effectively target T_{g}. For example, by adding ED-2003. In embodiments, the platform described herein can target a range of T_{g} values for a range of applications.

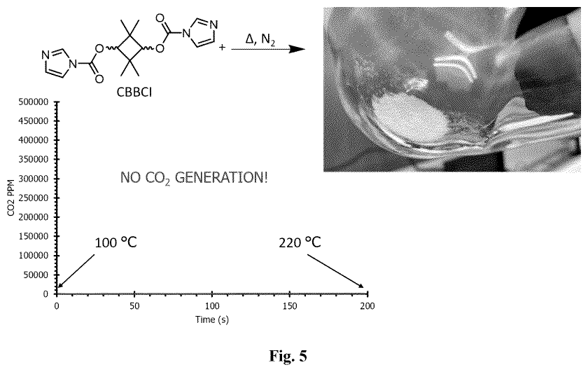

While TCDBCI succeeds at producing structural foams, another new BCI monomer, CBBCI was also evaluated. The lack of β-hydrogens makes this monomer unique and allows for further exploration of the suspected decarboxylation pathways leveraged to produce foams. FIG. 5 displays results from a decarboxylation experiment proving that CBBCI does not produce CO₂ over relevant temperature ranges. The monomer exhibited melting between 140-175° C., a broad range attributed to the mixtures of isomers present. The molten monomer remained clear and colorless throughout its molten state.

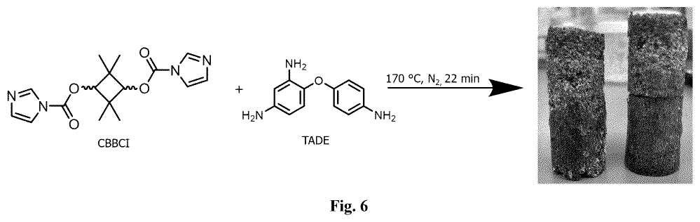

This result posed questions regarding blowing mechanisms for BCI foams; for example, if CO₂ was the sole blowing agent, or if the released imidazole also contributed. To explore this question, a crosslinked NIPU was formulated. TADE reacted with CBBCI, producing a porous structure, FIG. 6. This result was surprising, because no CO₂ was generated during the reaction indicating that imidazole acted as the blowing agent. Imidazole melts at about 90° C. then sublimes. This result indicates that at 130° C. we were subliming enough imidazole to create a porous structure.

### Non-Limiting Advances in Surfactant and Catalyst Optimization

Previous reported reaction times for foaming ranged from about 1.5 to about 6 min. These times were dependent on the chemical composition of the monomers with aliphatic amines reacting faster than aromatic amines, as expected for less nucleophilic aryl amines. These differences in foaming times provided insight to the working time for BCI foaming, which has impacts when filling molds. Mold sizes and part demands can vary, so developing a method for tuning reaction rates was investigated. Reaction rates can be tuned with temperature and catalyst loading. Higher temperatures can accelerate the reaction and decrease viscosity, thus this variable can be tuned for mold-filling applications. Because higher reaction rates can hasten curing while decreased viscosity can allow for faster mold filling, catalyst can be employed. Dibutyltin dilaurate is a catalyst that can be used for isocyanate PU synthesis, however in the BCI system it can act as an inhibitor, leading to a handle for increasing pot life (timescale in which the material is workable). Another catalyst, DABCO, can both expedite the reaction through a nucleophilic catalytic effect and can later slow the of the reaction due to DABCO competing with free amines for reaction surfaces. Thus, we can tune the amount of DABCO to add for mold filling.

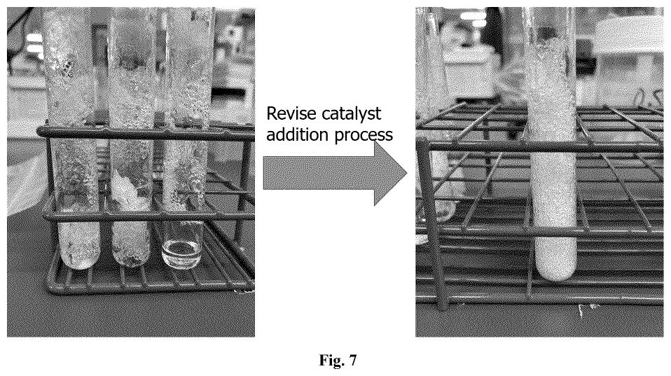

We have optimized catalyst and surfactant amount as well as addition order. FIG. 7 indicates the effect of addition order of surfactants and catalysts on BCI foams. If the catalyst was added to the BCI monomer component instead of the amine component, then decarboxylation reactions excel and dominate before amine addition. This resulted in substantial reactive group degradation and prevents high conversion. By including the catalyst with the amine and surfactant stream, degradation was avoided, and foams are successfully synthesized.

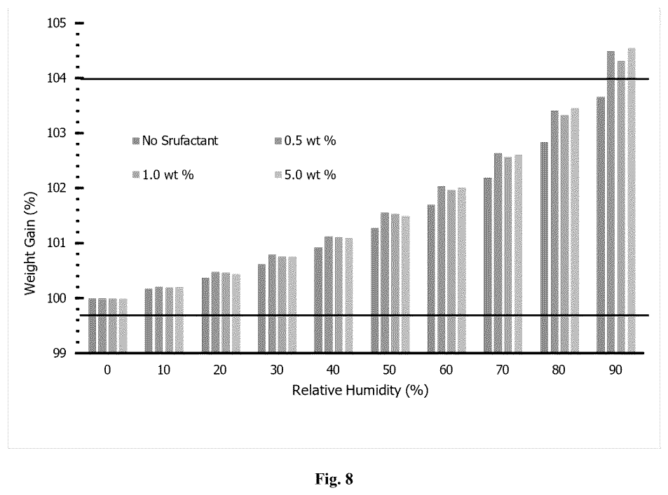

Water sorption studies were also completed to evaluate pore structure effects on foam water uptake. Different surfactant loadings resulted in different pore structures. TG-SA experiments were used to see if the surface area change between closed and open cell structures influenced water uptake, FIG. 8. The TGA-SA plot indicates that water uptake is a bulk property of BCI foams, and not influenced by surface area. This result applies to equilibrium water uptake values, as water uptake rates are surface area mediated.

### Imidazole Capture

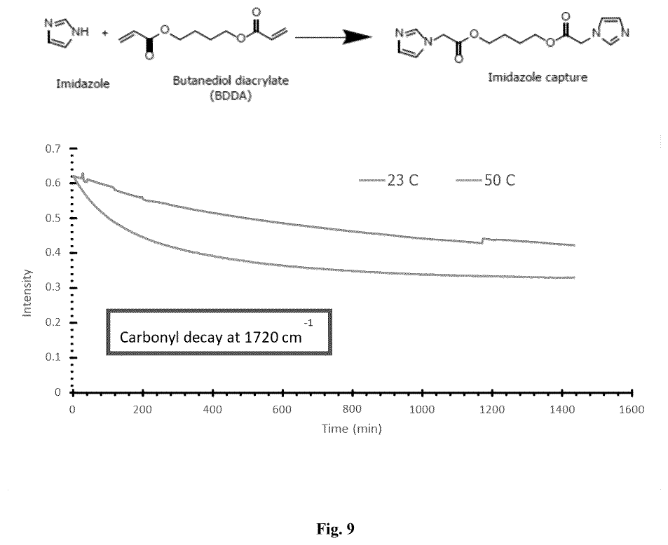

Methods for removing imidazole involve solvent extractions followed by subsequent drying. Experiments (FIG. 3) show an increased T_{g} after extraction, which can be due to the removal of plasticizers such as unreacted chains and imidazole. To remove this post-processing step, a method to capture imidazole in-situ is described herein. Previous methods included utilizing ionic liquids to pacify released imidazole, but those endeavors resulted in reactivity issues within the BCI monomers. Imidazole itself is a Michael donor, enabling another avenue of capture. In-situ FTIR spectroscopy allowed efficient evaluation of imidazole's effectiveness as a Michael donor. Butanediol diacrylate (BDDA) is a difunctional Michael acceptor that is readily available and was used to design a model compound study on the process. Temperature effects were also explored, as BCI foaming reactions are done at 100° C. and hotter. FIG. 9 displays the results of this experiment.

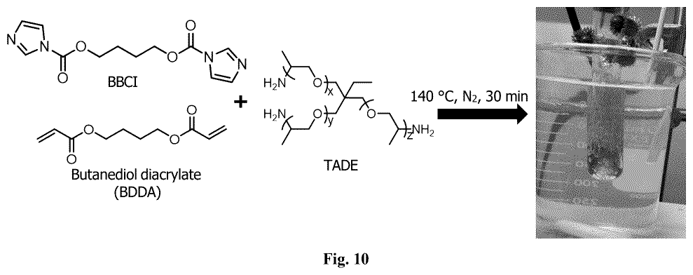

Success in small molecule imidazole capture in solution prompted implementation in a standard foaming procedure, FIG. 10. The addition of BDDA did not inhibit the production of a porous structure, although the reaction time was increased. Competing reactions of the primary amine with imidazole for Michael additions can explain this phenomenon.

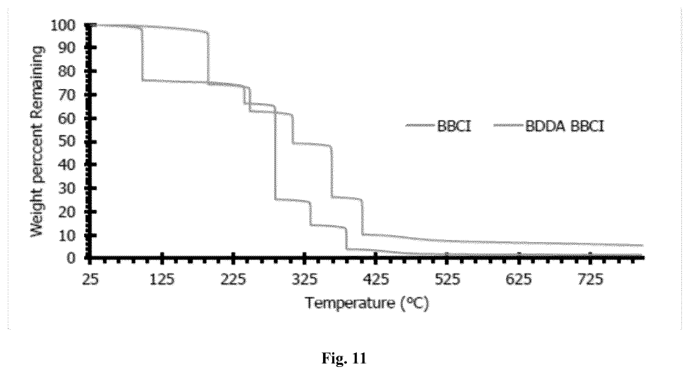

TGA weight loss curves, FIG. 11, highlight the successful capture of imidazole with the BDDA additive. A BCI foam produced without the additive exhibits weight loss at 90° C., characteristic of imidazole volatilization, while the foam made with the additive displays extended weight retention. The foam produced with BDDA, however, displayed a decrease in mechanical stability likely due to incomplete crosslinking. Aliphatic amines are more reactive than aromatic amines resulting in Michael additions from the T-403 to BDDA, inhibiting crosslinking. Due to this result, new difunctional Michael acceptors were explored and less reactive aromatic amines were utilized.

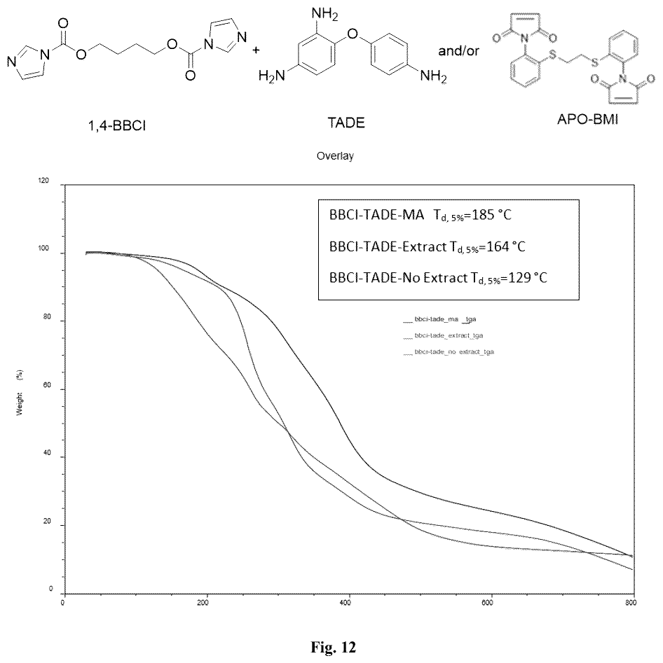

Surprisingly, we have found that Michael accepters can be used in syntactic foams. This additive can produce different pore appearances and surface finishes compared to foams without the Michael accepter additive. Thermogravimetric analysis displays an increased T_{d, 5%} when compared to unextracted foams without this additive, indicating successful imidazole capture, FIG. 12. TGA weight loss curve for the unextracted sample will differ with sample age. Immediately after foaming, the released imidazole remains dispersed in the polymer bulk, however, gradually blooms to the surface, presenting as crystallites. The age of the sample will alter the amount of imidazole that vacated the foam bulk. Depending on the amount of imidazole remaining dispersed, the weight loss curve will shift. Pure imidazole shows complete weight loss on TGA at 90° C. and step-wise TGA analysis highlights this weight loss step.

Further, foam molding was explored to explore part formation with BCI monomers. A 4-piece mold was designed comprised of a lid, bottom, and two clam shell sides. The 4-piece construction allowed for facile release of the molded part. The aluminum construction enabled efficient heat transfer from the oven to the mold to provide the energy needed to foam. Experiments indicate that pre-mixing of the powder reagents can maximize the uniformity of the foam, though the density gradient throughout the entire foam was not consistent. The bottom of the molded foam contained more material than the top of the mold. This result can indicate that the monomers reacted following melting and rise after achieving sufficient viscosity. For example, if the time between this rise and final cure is not enough for full rising, this can lead to a density discrepancy. For example, the foams comprised of BBCI-TADE reactions achieved densities of 17 lb/ft³ and 23 lb/ft³ for neat unextracted and Michael accepter filled foams respectively. Lower density foams can be used for flexible/shock absorbing applications, while higher density foams can be used structural components. There can be a range of foam densities which can be tuned depending on the application.

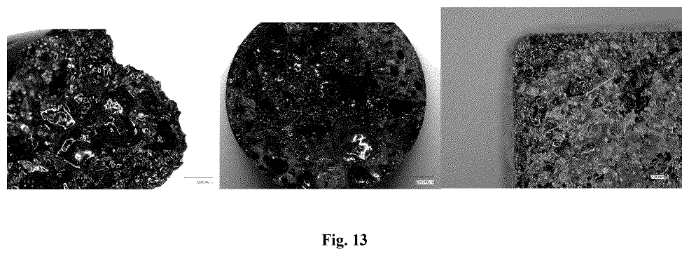

Without wishing to be bound by theory, the foam density can range from about 0.8 to about 30 lb/ft³. The non-filled foam resulted in a lower density, which can be due to the stoichiometry change leading to more CO₂ generation. Higher foam density can be achieved by synthesizing BCI macro monomers that result in less BCI moieties present and thus less decarboxylation. For a 1×1×2 inch mold, a polymer loading of about 12 g can produce densities of about 20 lb/ft³. FIG. 13 displays microscopy images of several molded foams. Non-Limiting NIPU Process Scale Up:

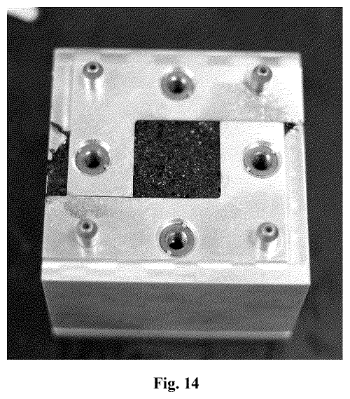

The scale up effort for BCI monomers involved considerations for production area and personnel capabilities. The synthesis of the BBCI monomer can lend itself to scale up efforts, as large batch reactors can readily adapt to this process. TCDBCI, however, requires additional steps for isolation and purification. The crude TCDBCI reaction is precipitated into water, then centrifuged to collect the monomer. For example, see precipitation procedures in Sintas et al., Polymer Chemistry 2023, 14 (13), 1497-1506 and Wolfgang et al., Macromolecular Rapid Communications 2021, 42 (13), 2100163. Centrifuges and drying ovens can further allow the adaptation of this synthesis. Experiments with foam molding indicate that BCI foams can be molded then machined to the desired shape. For example, FIG. 14 displays a molded foam. For direct encapsulation efforts, monomer selection can be tuned to achieve lower temperature foaming. For example, TCDBCI and catalyst loading can produce low temperature reactions. For example, a flexible polyol derived BCI monomer can produce a lower temperature reactions as well. For example, a PEG or PPG based polyol.

### REFERENCES

1. Sintas, et al., Carbamate thermal decarboxylation for the design of non-isocyanate polyurethane foams, Polym. Chem., 2023,14, 1497-1506.
2. Wolfgang et al., Non-isocyanate Polyurethanes from 1,1′-Carbonyldiimidazole: A Polycondensation Approach. Macromol Rapid Commun. 2021 July; 42 (13): e2100163. doi: 10.1002/marc.²⁰²¹⁰⁰¹⁶³. Epub 2021 May 24. PMID: 34031942.

### Example 2

### Non-Limiting, Exemplary Method for Byproduct Capture

Exemplary Synthetic Scheme for Imidazole Capture with Michael Acceptor

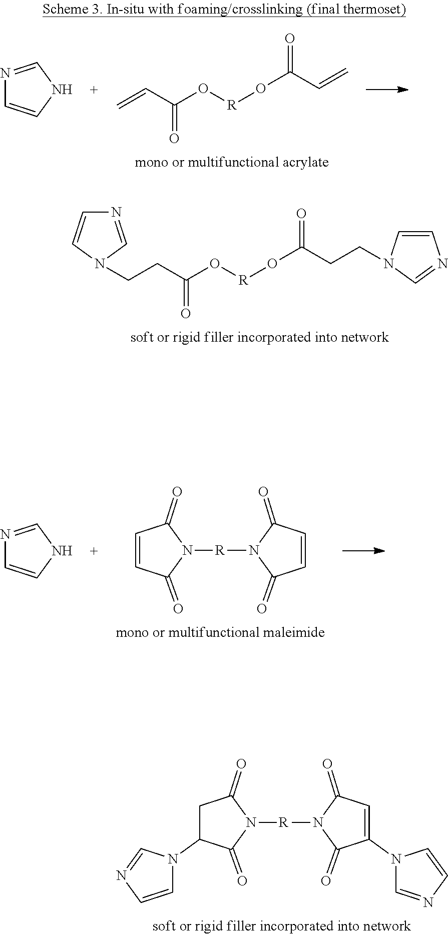

In embodiments, equimolar (to imidazolide end groups) amounts of Michael acceptor can be added for imidazole capture. For example, a dimichael acceptor it can be added in a about a 1:1 with BCI monomer. For example, a trifunctional acceptor can be added in about a 1:0.66 BCI:acceptor molar ratio. In embodiments, without wishing to be bound by theory, a BCI derivative can be used in place of BCI.

### Exemplary Thermoplastic Polyurethane Synthesis (Scheme 4)

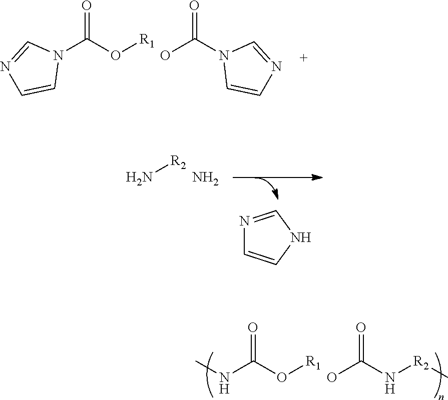

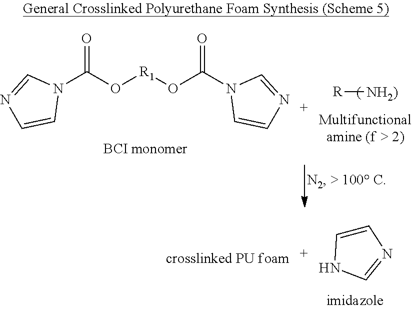

### Synthesis of Polyurethane Foams:

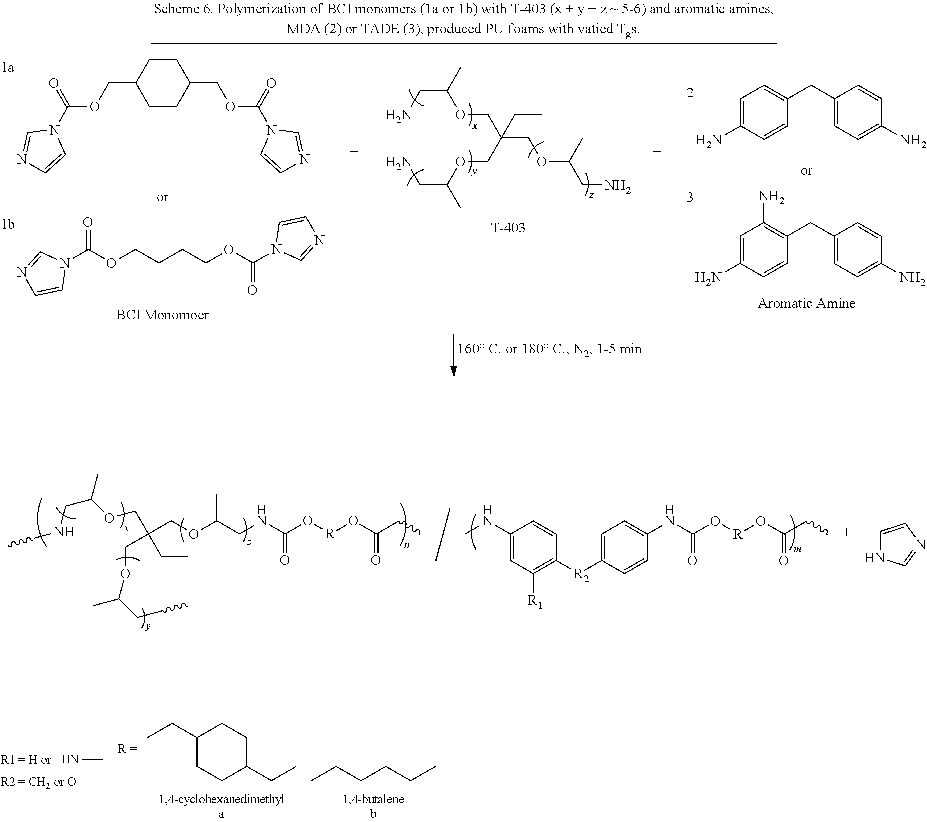

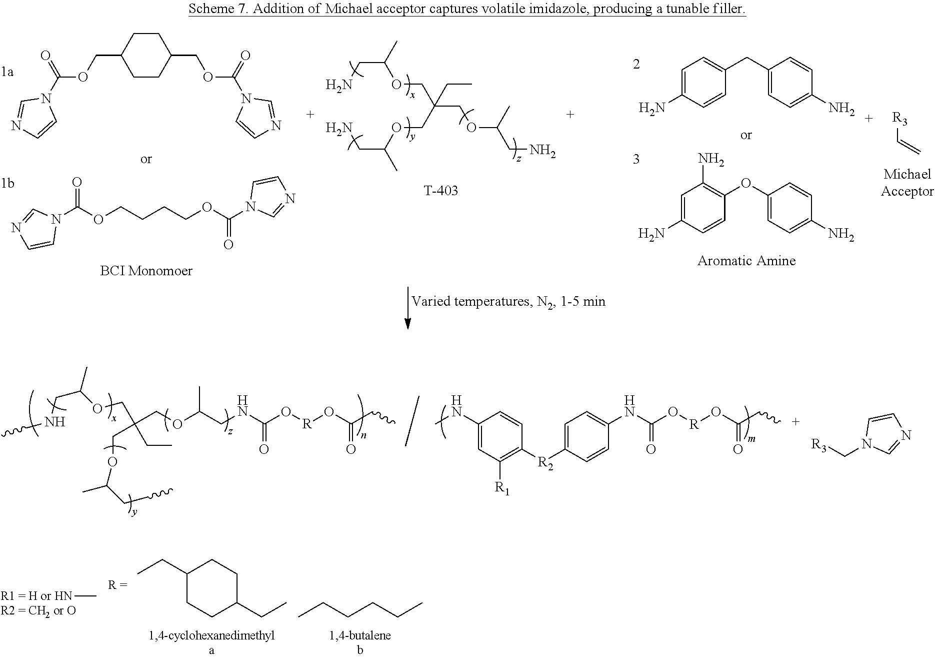

### Exemplary Synthetic Scheme for BCI Monomer and Derivatives Thereof

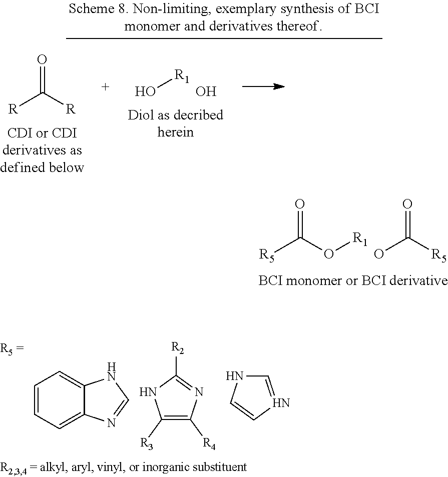

1a and 1b were used to synthesize PU foams with varied T_{g}s by incorporating aromatic amines according to Scheme 6. BBCI (5.00 g, 18.0 mmol) was added to a 50 mL single-neck round bottomed flask with a stir bar and a twin connecting hose joint to allow for nitrogen flow over the flask. The flask was purged with nitrogen for 5-10 min before lowering the flask into an oil bath at 160° C. to melt the monomer. Once the BBCI was in the melt (<5 min), the T-403 (5.17 g, 11.7 mmol) was quickly added to the reaction with a syringe. The reaction proceeded for 1-2 min before curing. The final product was yellow in color and soft to the touch. The foam was placed in a 250 mL jar with enough methanol to cover the foam and was submerged for 18 h to extract the imidazole byproduct. The foams were then placed in an oven at 80° C. for 16 h before applying reduced pressure for an additional 18 h. This process was repeated for all the MDA-containing foams where MDA was added in molar ratios of 0:100, 20:80, 40:60, and 60:40 mol:mol, MDA:T-403; however, the 60:40 product never reached gelation for the BBCI-based foams. MDA was added immediately prior to the addition of the T-403, after the BBCI was molten. CHDMBCI-based PU foams were synthesized in an identical fashion, but the reaction temperature was increased to 180° C. to accommodate the higher melting point of the monomer, and the reactions proceeded for 3-5 min before curing. In embodiments, without wishing to be bound by theory, a BCI derivative can be used in place of BCI.

Synthesis of PU foams with Michael Acceptor

1a and 1b were used to synthesize PU foams with varied T_{g}s by incorporating aromatic amines according to Scheme 7. BBCI (5.00 g, 18.0 mmol) was added to a 50 mL single-neck round bottomed flask with a stir bar and a twin connecting hose joint to allow for nitrogen flow over the flask. The flask was purged with nitrogen for 5-10 min before lowering the flask into an oil bath at 160° C. to melt the monomer. A di-Michael acceptor (for example, butane diol diacrylate (18.0 mmol) or APO BMI (18.0 mmol) was also added and heated with the BBCI monomer. Once the BBCI was in the melt (<5 min), the T-403 (5.17 g, 11.7 mmol) was quickly added to the reaction with a syringe. The reaction proceeded for 1-10 min before curing. The final product was brown-yellow in color and soft to the touch. In embodiments, without wishing to be bound by theory, a BCI derivative can be used in place of BCI.

### Example 3

### Non-Limiting, Exemplary Summary

Thermosetting resins are popular for a variety of commercial applications. One requirement of this class of polymer is the absence of volatile byproducts, which omits the implementation of certain classes of chemistries for use in thermosetting applications. Herein a new application for Michael acceptor compounds is disclosed. This results in an additive for capturing volatile components in a thermosetting resin, therefore allowing new chemistries to enter the space of thermosetting resins and their applications. Two classes of compounds are described including multifunctional acrylates and maleimides.

Bis-carbonylimidazolide (BCI) chemistry was developed as a route to synthesize polyurethanes without the use of isocyanates and with increased access to complex chemical structures previously unachievable. BCI chemistry allowed for the efficient synthesis of linear non-isocyanate polyurethanes (NIPUs). Crosslinked NIPU's, however, retained residual condensate (imidazole) within the matrix. This poses several problems to the NIPU foam and requires an additional processing step to remediate. To circumvent this processing step, we have implemented a Michael acceptor (for a Michael reaction). Experiments with a diacrylate indicated that the Michael addition between imidazole and an acrylate is possible, and the rate increases with temperature. Foaming experiments with the acrylate additive showed successful imidazole capture while lowering stiffness, modulus, and T_{g}. A new additive-a bismaleimide was explored instead of an acrylate since it retains its Michael acceptor functionality. This invention can broaden the applicability of non-isocyanate chemistry. Additionally, the concept of a Michael acceptor additive to capture volatile byproducts in resin curing is new and can widen the chemistry usable for commercial polymer applications.

Leveraging a di-Michael acceptors as additives in thermosetting applications is disclosed herein. If a thermosetting process forms a volatile reagent during curing, these additives can be employed to capture such byproducts. This enables the use of a broader range of thermosets commercially due to the elimination of additional processing procedures. For example, amines react with BCI groups and imidazole is released. If a bismaleimide is added to a curing polyurethane, then as imidazole is released it will react with the di-Michael acceptor present and be fully captured within the foam. The maleimide or acrylate additive can further react with the matrix to become covalently integrated, preventing byproduct leaching. This disclosure utilizes known chemistry as a new pathway for pacifying byproducts of thermosetting reactions.

Bismaleimides (BMIs) and acrylates are a class of monomer capable of producing both thermoplastic and thermoset polymers. Their increased thermal and oxidative stability (for example, up to about 400° C.), mechanical properties (for example, over about 1 gigapascal modulus values at temperatures over about 300° C.), and reactivity render them prime candidates for high performance applications including aerospace and 3D printing. However, their use has been limited to the polymeric matrix for thermosets and thermoplastics. Their nonobvious use described herein is an application of these monomers in an additive in polymer composite applications. Their use as an additive has a goal of trapping volatile byproducts that can be formed during some curing processes, eliminating the need for post-processing of cured thermosets, which is time consuming and expensive. An additional effect of this additive is the increase in thermal stability that BMIs endow. As such, traditional thermosetting resins can receive increased physical and thermal properties from this additive. Additionally, this means that chemistries that were traditionally not viable for commercial applications due to harmful byproducts have the opportunity for commercialization with this additive, for example BCI chemistry. This chemistry behind the success of this additive is a Michael addition across the maleimide or acrylate double bond. The Michael addition allows for orthogonal chemistries in complex curing systems when coupled with radical processes.

### Non-Limiting, Exemplary Surprising Features

Described herein are new applications of maleimides and acrylates to capture volatiles. Bismaleimides and diacrylates can be used in thermosetting applications, sometimes with the addition of radicals. The use of the maleimide or acrylate moiety for a Michael addition during curing in a binary system is not known. Utilizing the Michael reaction to capture a volatile component in an adjacent process is new. The resulting matrix that is filled allows for increased mechanical properties (that can be tunable based off of the chemistry of the Michael acceptor) and no leaching of volatile byproducts.

BMI or acrylate additives enable a broader range of thermoset chemistries for commercial use. The orthogonality in curing chemistries can produce minimal impact of percent cure, while bolstering properties. Current technologies including non-isocyanate chemistries release a volatile byproduct that impedes mechanical performance. For example, these byproducts can cause plasticizing, leaching, and blooming. The use of BMIs as an additive for volatile byproduct capturing that also increases mechanical properties that can drive emerging technologies forward and strengthens current ones.

This new application for bismaleimides can produce an expanded range of commercially valuable thermosetting polymer resins. Their incorporation in different stoichiometric amounts can produce tunable physical properties in commercial resins, and the orthogonal chemistry can produce new architectures. For example, the added Michael acceptors can form hydrogen bonds between the filler and polymer network, achieving a miscible system with synergistic boosts in properties. Consequentially, the miscible filler can then restrict the long-range movement of polymeric chains, which can boost T_{g} and modulus. Conversely, if flexible acceptors are used, they can act as a plasticizer and can produce increased polymer chain mobility. For example, the physical properties as described herein can be tuned by varying the incorporation of rigid and flexible Michael acceptors in a resin formulation. This can produce a broader range of properties and application methods.

### Example 4

### Orthogonal Curing of Non-Isocyanate Polyurethane Foams

Non-isocyanate thermoplastic and thermoset polyurethanes (NIPUs) have been synthesized through the use of carbonyldiimidaozle functionalized diols, denoted bis-carbonylimidazolide (BCI) monomers. These NIPUs displayed good mechanical properties while devoid of undesirable hydroxyl groups in the backbone that result from other isocyanate free methods. In-situ decarboxylation allows for the formation of porous structures during crosslinking, similar to traditional isocyanate-based polyurethane foaming. Surfactant and catalyst manipulations can produce fine-tuned material properties and working times, while monomer selection can produce control over structure-property relationships. In addition, BCI chemistry can synthesize of new polyurethanes and new engineering platforms under green conditions. Advances described herein leverage orthogonal reactions, including the Michael Addition, which can capture a Michael donor (e.g., imidazole) byproduct. These small molecule additives further tune mechanical properties by forming either flexible plasticizers or rigid fillers in-situ with urethane formation. The BCI or BCI derivative functional group nitrogen can be leveraged to synthesize new, double charged ionic liquids that show increased chemical resistance. The BCI chemistries described herein can be used to synthesize a versatile range of NIPUs.

### Example 5

### Carbamate Thermal Decarboxylation for the Design of Non-Isocyanate Polyurethane Foams

Polyurethane foams remain at the forefront of cushioning, insulation, packaging, and structural applications. Risk of exposure to isocyanate-containing precursors during foaming operations directly contributes to the regulation of isocyanates, thus prompting investigations into non-isocyanate alternatives. This work presents non-isocyanate polyurethanes (NIPUs) that are readily prepared from carbonyldiimidazole (CDI) derived monomers for efficient synthetic methods that strive to adhere to the principles of green chemistry. Various bis-carbonylimidazolide (BCI) monomers undergo β-hydrogen elimination at temperatures exceeding 140° C., which liberates a carbamic acid that subsequently decarboxylates. Decarboxylation provides an in situ blowing agent, and carbon dioxide is capable of producing a microcellular foam with concurrent crosslinking. BCI difunctional monomers in presence of trifunctional crosslinking agents enabled the synthesis of both rigid and flexible NIPU foams, and the addition of conventional surfactants and catalysts allowed for precise control over pore structure. Thermomechanical analysis elucidated foam glass transition temperatures ranging from 0 to 120° C. and coefficients of thermal expansion on the order of 10-6 mm/mm° C. Scanning electron microscopy enabled characterization of pore size and foam structure. Optimized catalyst and surfactant levels enabled a range of flexible and rigid foam compositions. Fundamental structure-property-processing relationships were established for new BCI-derived NIPU foams to reliably predict performance.

### INTRODUCTION

Polyurethane (PU) foams are ubiquitous for porous material applications due to versatile mechanical performance and structural diversity.¹⁻⁴ Their low density, thermal conductivity, and extensive vibrational damping encourage insulation, padding, and weight reduction applications.⁵⁻⁸ Although enabling chemical structure-property relationships exist for PU foams, their mechanical properties are derived from cell size and structure, density, and fill gas.⁹⁻¹¹ Closed-cell foams are ideal for structural and insulation applications, while an open-cell structure allows for flexible foams, typically found in padding. In addition to common additives, i.e., catalysts and flame retardants, surfactants dictate pore formation and structure. Specialized foams utilize tailored fill gasses, e.g., pentane or chlorofluorocarbons, to fine tune thermal conductivity and decrease reaction exotherms during foam manufacturing.¹² PUs possess excellent mechanical strength, elongation at break, compositional modularity, abrasion resistance, and performance retention over extended temperature ranges due to nano-scale phase separation.¹³⁻¹⁵ The combination of these highly desirable properties and modularity enables their use in the furniture, insulation, biomedical, transportation, and clothing industries. From a sustainability standpoint, foams enable multi-faceted impact from material light weighting, decreased polymer consumption, and energy-saving insulation.¹⁶ Their crosslinked nature allows for minimal aging or creep, allowing increased service life for long term applications.

Conventional synthesis of PUs and PU foams take advantage of the rapid reaction of isocyanates and diols with differing chemical compositions and functionalities.¹⁷ Commercial PUs involve a tailored mixture of isocyanates, polymeric isocyanates, diols, oligomeric polyols, and other additives to tune final properties. Dimeric hydrogen bonding occurs between urethane-containing hard segments, further bolstering thermomechanical properties. Soft segments commonly include polyols, typically low glass transition temperature polyethers, and low concentrations of urethane linkages. These hard and soft segments undergo nano-phase separation, resulting in a multi-phase morphology with covalently bound low and high T_{g} segments, i.e., a soft phase for elasticity and a hard phase for structural integrity.¹⁴ During foam manufacturing, the addition of water in tandem with isocyanates produces an amine and CO₂ from the decarboxylation of an unstable carbamic acid intermediate. The released CO₂ generates micron-scale pores that are stabilized with surfactants, resulting in a microcellular structure in the final PU thermoset.¹⁸ The versatile and highly reactive nature of the isocyanate functional group enables this multifaceted reaction sequence and leads to a commercially viable manufacturing process. However, the inherent toxicity of the isocyanate group leads to allergic reactions or asthma upon mild, consistent contact, while more significant exposures are potentially fatal. This toxicity drives the search for alternative chemistries and hence the long-standing attention to NIPU foams.¹⁹

While safer synthetic pathways are a principle of green chemistry, foams themselves exemplify several aspects of sustainability. Porous structures enable lightweight alternatives to traditional materials, while reducing material consumption. Useful for aerospace applications where lower density is paramount, lightweight materials offer avenues for decreased material consumption if applied to other fields. For example, vehicle weight is directly correlated to fuel consumption in the automotive industry.²⁰ Various economic analyses indicate that the prevalence of lightweight vehicles will increase over time, resulting from increased fuel prices and greenhouse gas regulation. Thus, high performance foams remain a contemporary subject for investigation and are a central avenue for increased global sustainability.^{21, 22} Additional examples for energy saving applications include materials for insulation to increase energy efficiency while lowering costs. PU foams offer substantial benefits to sustainability; however, the research community continues the search for greener synthetic pathways.

The most prevalent non-isocyanate polyurethane (NIPU) synthetic method is the cyclic carbonate route.²³ Dicyclic carbonates react with diamines to form linear polyurethanes with pendant secondary and primary hydroxyl groups adjacent to the carbamate. Past NIPU foam formulations involved these cyclic carbonates, producing residual hydroxyl groups along the polyurethane backbone, which resulted in a loss of desirable properties.²⁴ The presence of these groups increases water uptake, mitigating weight reduction and resulting in plasticization.²⁵ Moreover, the pendant hydroxyl group compromises the hydrogen bonding interactions, thus negatively influencing the formation of a well-defined multi-phase morphology. In addition, the carbonate-amine reaction requires a catalyst to compensate for slow reaction kinetics and produces flammable H₂ gas during the foaming process.²⁶ Other processes remedy the off-gassing of H₂, however they require addition of thiols to produce CO₂ and require reaction times up to 4 h for curing.²⁷ Our previous work demonstrated the synthesis of NIPU using carbonyldiimidazole (CDI) functionalized bis-carbonylimidazolide (BCI) monomers.²⁸ This BCI pathway exhibited greater versatility compared to previous NIPU pathways due to increased compositional diversity compared to cyclic carbonate and isocyanate approaches.²⁹⁻³² BCI monomers provided an isocyanate-free pathway to a highly versatile platform for the future synthesis of polyurethanes. Furthermore, BCI monomers offer the benefits of an expansive selection of commercial diols, thus providing a wide range of achievable polymer properties. For example, the versatility of CDI functionalization enabled the unprecedented synthesis of 1,4-cyclohexanedimethanol-derived BCI monomer to investigate the structure-property effects of rigid BCI monomers on the thermal performance of synthesized foams (Scheme 3.1). Room temperature reaction conditions, high yields, low-cost diols, and simple workup allowed for large-scale synthesis of these monomers.

Linear PUs from the BCI approach displayed thermal and mechanical properties comparable to conventional PUs, but earlier literature omitted crosslinked polyurethanes. This manuscript demonstrates that BCI monomers react with multifunctional amines to provide crosslinked porous foams, thus introducing a non-isocyanate route for PU foam manufacturing. One inventive aspect of this approach leverages in situ CO₂ generation through an elimination mechanism in the absence of additional catalyst. The inherent solvent- and isocyanate-free nature of this synthetic method proves desirable, as safer reagents and the absence of solvent align with several principles of green chemistry.³³ Thermal analysis of these foams revealed T_{g} tunability through assorted BCI and triamine monomers. Our research results herein explore the effects of catalysts and surfactants on foam curing time, cell structure, and foam density. A fundamental understanding of BCI chemistry enables fine tuning of final foam properties and a deeper understanding of structure-property relationships for crosslinked NIPU foams with potential impact on many emerging technologies.

### Experimental/Methods

### Instruments

¹H and ¹³C nuclear magnetic resonance (NMR) spectroscopy utilized a Varian Unity 400 spectrometer functioning at 399.87 MHz and 23° C. (solution concentration of 10 mg mL⁻¹). A Mel-Temp 1101D digital melting point apparatus operating at 5° C. min⁻¹ provided melting points for BCI monomers. A ThermoFisher Scientific Nicolet iS5 FTIR spectrometer iD7 ATR, with a diamond cell, confirmed PU foam structure after 32 scans. A TA Instruments Discovery Series TGA 5500 facilitated thermogravimetric analysis (TGA) by utilizing a heating rate of 10° C. min⁻¹ from 25-800° C. with a steady nitrogen purge. The T_{d,5%}, or temperature where 5% of the original sample mass is lost, stands as an indicator for sample thermal stability. Stepwise isothermal TGA followed by ramping from 25-800° C. at 10° C. min⁻¹ until the weight change was >0.1% min⁻¹, and the TGA would isotherm until the weight change was <0.05% min⁻¹. A TA Instruments Discovery Series DSC 2500 with heat/cool/heat cycles of 10° C. min^{-1, 10}° C. min⁻¹, and 10° C. min⁻¹, respectively, provided differential scanning calorimetry (DSC) data where the sample was under a nitrogen environment throughout the experiment. DSC provided the glass transition temperatures from the midpoint of the endothermic transition in the 2^{nd} heat. A TA instruments TMA Q400 temperature ramp, operating at a rate of 5° C. min⁻¹ in air from −20-150° C., provided coefficient of thermal expansion (CTE) and T_{g} of PU foams. A JEOL JSM IT500HR or JEOL 6300 scanning electron microscope coupled with a Cressington sputter coater 208 HR using an Au/Pd conductive layer provided micrographs of PU foams. The 30 nm Au/Pd layer allowed for high-resolution images at 10×, 25×, 100×, and 500× magnification, and the secondary electron detector maintained 15.0 kV for all images. A Gas Lab CM-0177, S8 CO₂ sensor kit enabled the detection of CO₂ released from the reaction.

### Materials

1,4-butanediol (>99.0%), 1,1′-carbonyldiimidazole (CDI) (>97.0%), 4,4′-methylenedianiline (MDA) (>97.0%), 1,4-cyclohexanedimethanol (CHDM) (mixture of isomers, 99%), Dabco® 33LV, and dibutyltin dilaurate (95%) were purchased from Sigma Aldrich and stored in a desiccator under reduced pressure. 4,4′-dihidroxydiphenylmethane (BPF) (>99.0%), was purchased from TCI and used as received. 4-(4-aminophenoxy)benzene-1,3-diamine, or triaminodiphenylether, (TADE) (97%) was provided by SABIC and stored in a desiccator under reduced pressure. Jeffamine® T-403 polyetheramine was provided by Huntsman and had a number-average molecular weight of 440 g mol⁻¹. The Jeffamine® was dried at 60° C. under reduced pressure prior to use. Dabco® DC193 was provided by Honeywell NSC and used as received. Ethyl acetate (>99.5%, ACS grade), acetone (99.6% ACS reagent), and methanol (>99.8%, ACS grade) were purchased from Fisher Scientific and used as received. Nitrogen gas (99.999% UHP-T) was purchased from Praxair Distribution. Deuterated chloroform (CDCl₃) was purchased from Cambridge Isotope Laboratories, Inc.

### Synthesis of 1,4-butyl(bis-carbonylimidazolide) (BBCI), 1b, and 1,4-cyclohexanedimethyl(bis-carbonylimidazolide) (CHDMBCI), 1a

Synthesis followed from our previous literature (Scheme S1).²⁸ 1,4-butanediol (27.04 g, 0.3 mol) was added to a three-necked, 1 L round-bottomed flask outfitted with a magnetic stir bar, nitrogen inlet, nitrogen outlet, and rubber septa. The butanediol was dissolved in ethyl acetate (600 mL) at 25° C. for 10 min under a nitrogen purge. 1,1′-Carbonyldiimidazole (CDI) (121.61 g, 0.7 mol) was added to the flask in partitions to allow for even mixing and to reduce the propensity for cyclization.³⁹ The initial ˜60 g of CDI dissolved readily in the solvent, producing a transparent and colorless solution. CDI solution saturation and product formation resulted in a turbid, white slurry. An additional 60 mL of ethyl acetate was added to ensure reagents were well mixed. The reaction was allowed to proceed for ˜2 h prior to filtration using a fritted funnel. The white powder was washed twice with ethyl acetate to remove byproducts (500 mL total) and dried at 60° C. and ˜25 in-Hg for 18 h. The final isolated yield was >90% with a melting point range of 138-140° C. ¹H NMR (CDCl₃, δ, Figure S1) 8.13-8.14 (t, 2H, 3), 7.41-7.42 (t, 2H, 2), 7.07-7.08 (m, 2H, 1), 4.47-4.51 (t, 4H, 5) 1.95-2.00 (m, 4H, 6). The synthesis for 1a followed the same procedure as above and provided a yield >80% with a melting point range of 170-174° C. and was also a white powder. The mixture of cis and trans isomers presents multiple peaks in NMR, specifically the splitting at 4.3 ppm and 1.6 ppm. ¹H NMR (CDCl₃, δ, Figure S2) 8.12-8.14 (t, 2H, 3), 7.41-7.42 (t, 2H, 2), 7.07-7.08 (m, 2H, 1), 4.25-4.37 (d, 4H, 4) 1.11-2.11 (m, 10H, 5-7).

### Synthesis of 4,4′-diphenylmethane (bis-carbonylimidazolide) (BCIF)

Due to the increased solubility of the BCIF monomer, reaction conditions deviated from 1a and 1b. BPF (10 g, 0.05 mol) was added to a three-necked, 1 L round-bottomed flask outfitted with a magnetic stir bar, nitrogen inlet, nitrogen outlet, and a rubber septum. The BPF was dissolved in 250 mL of ethyl acetate and purged. CDI (20.27 g, 0.125 mol) was dissolved and the reaction was allowed to proceed for 2 h for full conversion. The reaction mixture was evaporated using a rotary evaporator and the solids were collected and dissolved in 20 mL of acetone. The dissolved mixture was then precipitated into reverse osmosis purified water and allowed to stir for 15 min. The solid was filtered on a fritted funnel then dried in a vacuum oven for 6 h at 25° C. under vacuum (˜25 in-Hg). The temperature was then augmented to 60° C. and dried for an additional 18 h. The final yield was >85% and melting point range of 125-127° C. ¹H NMR (CDCl₃, δ, Figure S1) 8.21-8.22 (t, 2H), 7.48-7.49 (t, 2H,), 7.19-7.20 (d, 4H) 7.12-7.15 (d, 4H), 7.06-7.12 (t, 2H), 3.95-4.01 (s, 2H).

### Synthesis of Polyurethane Foams

1a and 1b were used to synthesize PU foams with varied T_{g}s by incorporating aromatic amines according to Scheme 3.1. BBCI (5.00 g, 18.0 mmol) was added to a 50 mL single-neck round bottomed flask with a stir bar and a twin connecting hose joint to allow for nitrogen flow over the flask. The flask was purged with nitrogen for 5-10 min before lowering the flask into an oil bath at 160° C. to melt the monomer. Once the BBCI was in the melt (<5 min), the T-403 (5.17 g, 11.7 mmol) was quickly added to the reaction with a syringe. The reaction proceeded for 1-2 min before curing. The final product was yellow in color and soft to the touch. The foam was placed in a 250 mL jar with enough methanol to cover the foam and was submerged for 18 h to extract the imidazole byproduct. The foams were then placed in an oven at 80° C. for 16 h before applying reduced pressure for an additional 18 h. This process was repeated for all the MDA-containing foams where MDA was added in molar ratios of 0:100, 20:80, 40:60, and 60:40 mol:mol, MDA:T-403; however, the 60:40 product never reached gelation for the BBCI-based foams. MDA was added immediately prior to the addition of the T-403, after the BBCI was molten. CHDMBCI-based PU foams were synthesized in an identical fashion, but the reaction temperature was increased to 180° C. to accommodate the higher melting point of the monomer, and the reactions proceeded for 3-5 min before curing.

An aromatic triamine was utilized to further increase the T_{g} of the PU foams, shown in Scheme 3.2. Following the same procedure, BBCI (1.88 g, 6.7 mmol) and TADE (0.95 g, 4.4 mmol) were added to a 50 mL single-neck round bottomed flask with a stir bar and a twin connecting hose joint to allow for nitrogen flow over the flask. The flask was purged with nitrogen for 5-10 min before lowering the flask into an oil bath at 160° C. to melt the monomers. Once the reagents were in the melt, the reaction cured in <3 min. This process was repeated for the T-403-containing foams where T-403 was added in molar ratios of 100:0, 90:10, 80:20, 70:30, and 60:40 mol:mol, TADE:T-403. A low concentration, 0.8 wt. %, of Dabco® DC193 was added to select PU foams to elucidate the effect on cell structure and overall homogeneity. The surfactant was added with the BCI monomer prior to the addition of the amines and surfactant-containing foams were not used for thermal characterization.

### Results and Discussion

The reaction of difunctional BCI monomers with aliphatic or aromatic triamines results in a crosslinked NIPU, as depicted in Scheme 3.1. The polycondensation reaction, which liberates imidazole, between 1b and T-403 (a polypropylene based triamine) at 25° C. in an organic solvent (e.g., chloroform) showcased crosslinking efficacy with the observation of organogels. Performing these reactions at elevated temperatures in the bulk resulted in spontaneous decarboxylation of the BCI monomer and subsequent network formation to generate a porous microcellular structure.

Spontaneous foaming during BCI crosslinking was not reported earlier, and thus

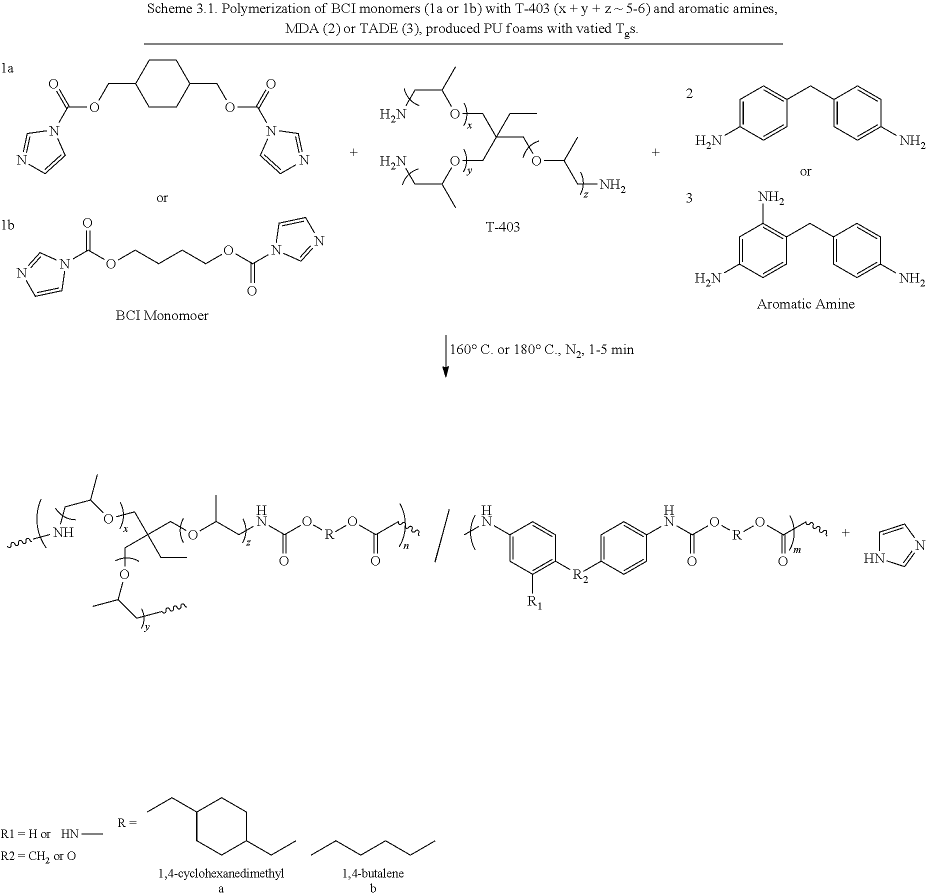

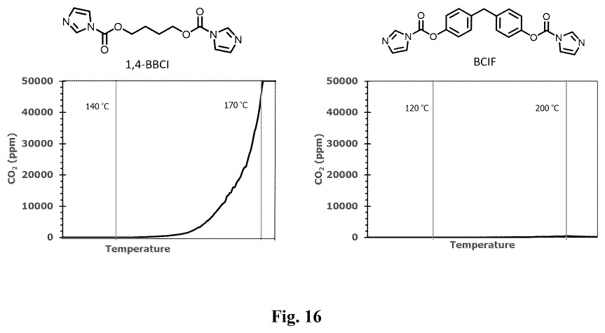

FIG. 16 displays CO₂ generation for an aliphatic BCI monomer with abstractable β-hydrogens and the aromatic BCIF monomer that is not amenable to decarboxylation. As predicted, the aromatic monomer did not decarboxylate, thus supporting the decarboxylation mechanism as shown in Scheme 3.2.

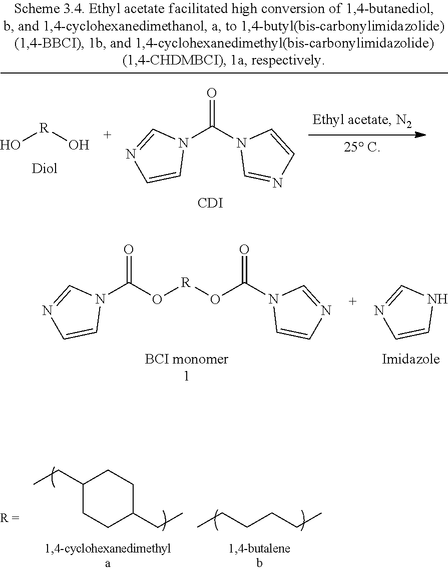

Additionally, FTIR spectroscopy displays the appearance of a carbon-carbon double bond absorbance in the spectrum of a BBCI-T-403 foam (Scheme 3.4). This further suggests the formation of a vinyl group during decarboxylation.

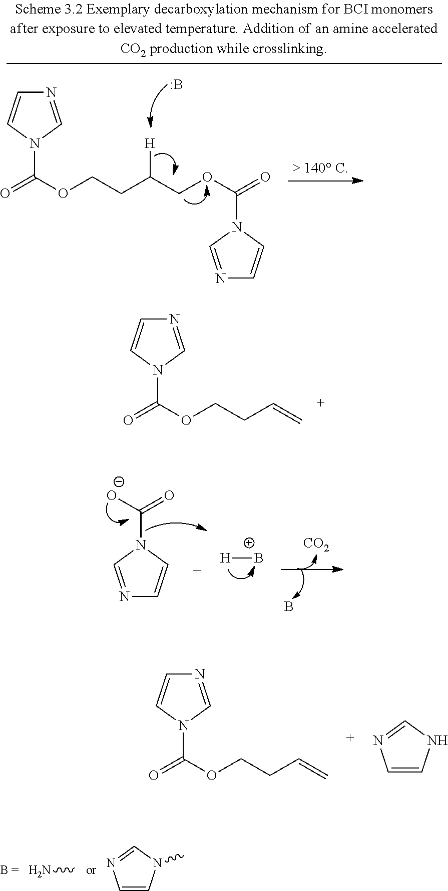

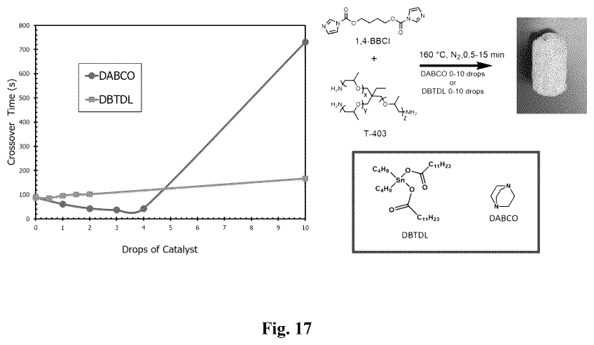

Cure times are also a critical consideration when designing a foaming platform. Molds for final foam parts range in size and complexity, often requiring different cure times for different applications. Traditional catalysts for PU foams vary and include different organic and inorganic compounds, i.e., 1,4-diazabicyclo[2.2.2]octane (DABCO) and dibutyltin dilaurate (DBTDL).^{14, 36} A combination of catalysts is typically employed to optimize reaction kinetics and foam formation, although tin-based catalysts are currently under scrutiny.^{37, 38} A BBCI-T-403 homopolymer synthesized with varying amounts of an organotin or tertiary amine catalyst elucidated the degree of kinetic control available to BCI monomers. Foams with varying amounts of catalyst quantified the effect of catalyst loading on reaction times. Catalyst was added dropwise, with 1 drop=50 μL, on a 2 g reaction scale and cure times were noted when the foam structure prohibited stirring. The DBTDL catalyst decreased reaction kinetics, likely from free amines complexing with the tin center or displacing the lauryl groups through an amidation reaction, however the exact mechanism is still under investigation. DABCO, however, effectively catalyzed the BCI-amine transcarbamoylation reaction. An optimal concentration of 3-4 drops of DABCO boasted the most potent catalytic effects, with higher concentrations of catalyst resulting in increased reaction times. This significant increase in reaction times at higher DABCO loadings is likely due to competition between the tertiary and primary amine for electrophilic carbonyl addition.^{39, 40} Overall, DABCO presented an effective pathway for both tuning reactivity and ensuring precursor stability for BCI foams, displayed in FIG. 17.

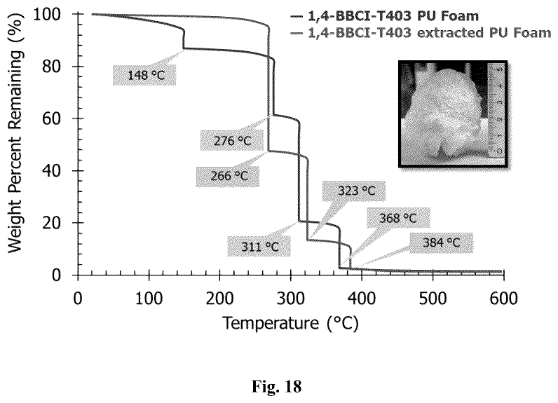

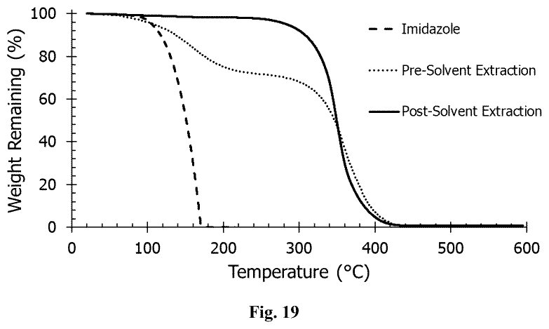

The polycondensation reaction of BCI monomers with various multifunctional amines liberated imidazole as a low molar mass condensate. This condensate did not pose a problem, as imidazole is readily soluble in numerous organic and aqueous solvents and sublimes above 90° C. with reduced pressure resulting in a facile recovery. A stepwise isothermal TGA of the foam product before (red curve) and after (blue curve) extraction with methanol and subsequent drying confirmed that a low level of imidazole remained in the foam after reaction, as shown in FIG. 18. A temperature ramp experiment also illustrated the effect of extraction on PU foams (FIG. 19). Solvent extraction quantitatively removed residual imidazole and low molecular weight, soluble, oligomers, providing a ˜100° C. increase in T_{d,5%}.

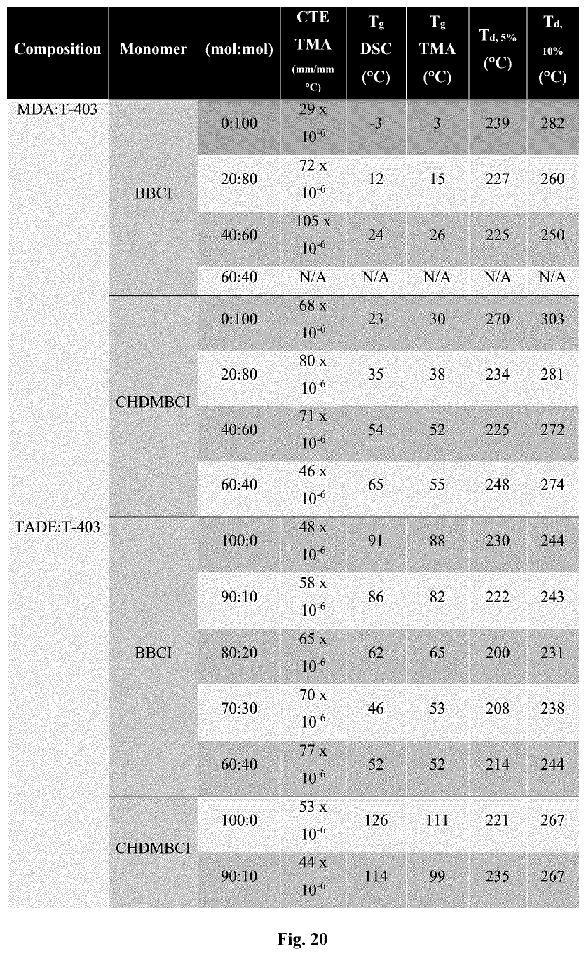

BCI functionality enabled the synthesis of a library of NIPUs with diverse compositions. Backbone rigidity, hydrogen bonding, and crosslink density drove key structure-property relationships within this series. Thermomechanical analysis (TMA) and DSC probed thermal transitions for foams as synthesized in Scheme 3.1. Temperature ramps also revealed coefficients of thermal expansion, and thermogravimetric analysis allowed for weight loss profiles (FIG. 19). FIG. 20 summarizes these findings, allowing for an in-depth comparison. Incorporating either a cyclohexyl (la) or a butyl (1b) BCI monomer and a two-part amine reagent containing varying ratios of either MDA and T-403 or TADE and T-403 enabled decoupling of backbone chemistry effects for thorough investigation. Homopolymer foams of chemical composition, la-T-403, 1b-T-403, la-TADE, and 1b-TADE were synthesized for comparison. The consistent urethane structures garnered from BCI chemistry served as controls and isolated the effects of butyl, cyclohexyl, phenyl, and ether groups on thermal performance. As expected, units that impart restricted rotation give rise to higher glass transition temperatures, while more mobile groups decrease T_{g} (as shown in Figure S7-S9). Aromatic foams containing difunctional MDA linkages display lower T_{g}s compared to aromatic, trifunctional TADE foams, which exemplify the effects of crosslink density on thermal performance

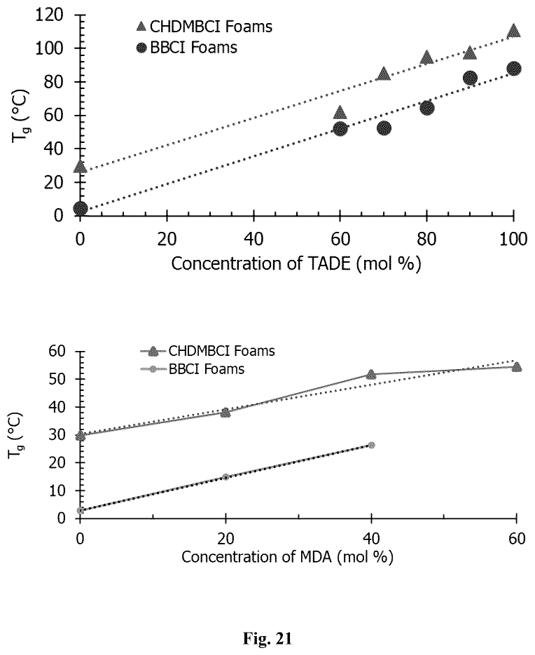

BCI foams comprised of aromatic amines displayed increased closed-cell content with incorporation of a silicon-based surfactant, as discussed later using scanning electron microscopy. As expected, the incorporation of aromatic amines increased the T_{g} and impacted foam structure. This linear, predictable increase as shown in FIG. 21 displays tunable properties. In addition, FIG. 21 demonstrates this trend is also valid for difunctional rigid monomers. Poor structural integrity of the 60 mol % BBCI:MDA foam prohibited mechanical testing. The dark appearance of TADE-based foams presumably arises from the color of the TADE monomer.

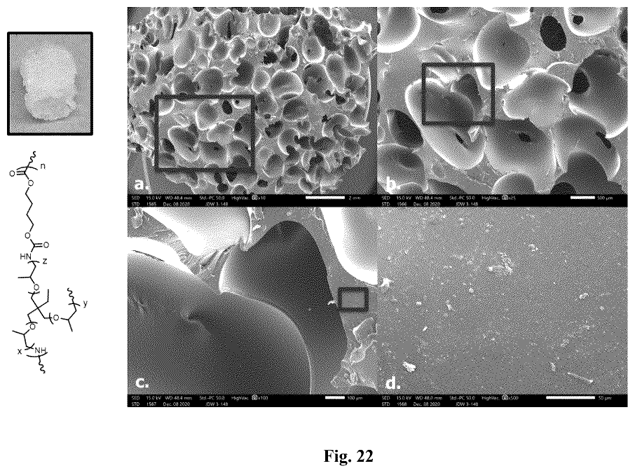

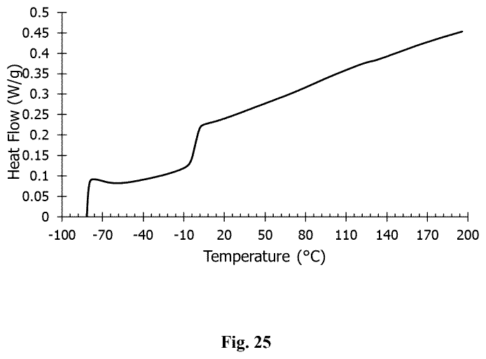

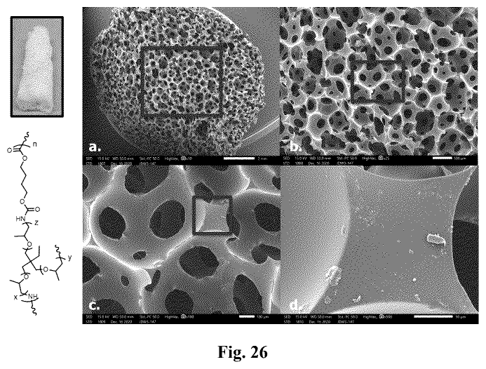

Foam thermal properties arise from both chemical composition and microscale foam structure. Thus, it is imperative to understand the microscale structure of BCI foams to enable performance tunability. Scanning electron microscopy (SEM) provided micron-scale features of the PU foams (FIGS. 22-24 and 25 and 26). Micrographs of the BBCI-MDA:T-403 0:100, BBCI-TADE:T-403 100:0, and CHDMBCI-TADE:T-403 100:0 PU foams, with and without surfactant, enabled visualization of foam structures. Neat BBCI:T-403 homopolymer foams displayed partially closed cells with uneven pore distributions, as illustrated in FIG. 22. The absence of surfactant results in low pore stability, which explains the abnormal pore distribution.

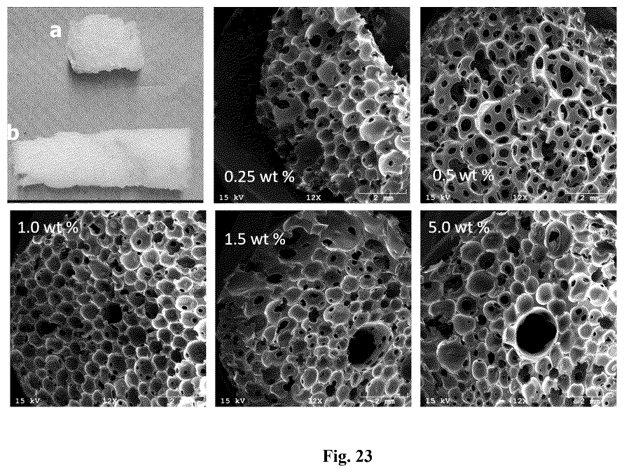

Closed-cells impart better insulating properties compared to open-cells, which are more frequently used in vibrational damping and cushioning applications. Cell structures were on the order of ˜500 μm and ˜1000 μm for the BBCI-MDA:T-403 0:100 and BBCI-TADE:T -403 100:0, respectively. Holes were evident in cell walls for each of the samples, which was consistent with an open-cell character, however, closed-cell structure dominated. The addition of surfactant significantly changed the appearance, density, texture, and cellular structure of the foams, as shown in FIG. 23.

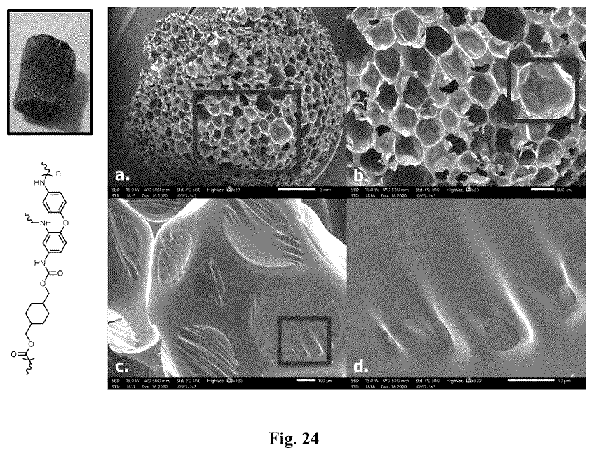

Silicon-ether copolymer surfactants represent a widely accepted standard for rigid foam applications.¹² Altering the siloxane:ether ratio in these surfactants impart great versatility for tuning surface tension. Consequentially, their tunability allows siloxane-ether surfactants to achieve a diverse range of pore structures. FIG. 24 displays the effect of 0.8 wt. % Dabco® DC193 (a siloxane-ether surfactant) loading on the final pore structure of a CHDMBCI:TADE homopolymer foam. During foam crosslinking, the surfactant lowers the surface energy of the polymer matrix and allows for stabilization of growing pores.⁴¹ This uniform stabilization results in a well-defined cell structure and more isotropic foam properties. DSC confirmed that surfactant loading did not influence the T_{g} of the final foam.

### Conclusions

Described herein is synthetic methodology for isocyanate-free foaming of polyurethane structures. A thermal decarboxylation mechanism of bis-carbonylimidazolide monomers for in situ blowing resulted from the BCI monomer β-hydride elimination to produce CO₂ and imidazole. CO₂ was captured in the polymer melt with the aid of a surfactant to achieve a final foamed structure. Two series of foams with varied concentrations of aromatic di- and triamines, in concert with an aliphatic triamine, enabled predictable tailoring of thermal properties. The increase in MDA or TADE incorporation yielded foams with higher T_{g}s and more rigid structures, which were confirmed with consistent DSC and TMA results. SEM indicated that the process described herein provided closed-cell foams, except when adding a surfactant into the low-T_{g} system. A simple solvent extraction removed low molar mass byproducts; however, further work will investigate pathways for their in situ capture and retention in the final foam. Investigations of BCI foam catalysis revealed DABCO as an avenue for tuning BCI reactivity and flowability in molding applications. Overall, BCI functional monomers introduce a new synthetic methodology for non-isocyanate polyurethanes that is impactful for both thermoplastics and thermosets. BCI foams show predictable cure times, T_{g}, and porosity control, which suggests potential impact for a multitude of traditional and emerging polyurethane foam applications.

### References Cited in this Example

1. H. M. C. C. Somarathna, S. N. Raman, D. Mohotti, A. A. Mutalib and K. H. Badri, Construction and Building Materials, 2018, 190, 995-1014.
2. N. V. Gama, A. Ferreira and A. Barros-Timmons, Materials, 2018, 11, 1841.
3. P. Singhal, W. Small, E. Cosgriff-Hernandez, D. J. Maitland and T. S. Wilson, Acta Biomaterialia, 2014, 10, 67-76.
4. F.-L. Jin, M. Zhao, M. Park and S.-J. Park, Polymers, 2019, 11, 953.
5. J.-W. Wu, W.-F. Sung and H.-S. Chu, International Journal of Heat and Mass Transfer, 1999, 42, 2211-2217.
6. H. Zhang, W.-Z. Fang, Y.-M. Li and W.-Q. Tao, Applied Thermal Engineering, 2017, 115, 528-538.
7. F. M. Casati, R. M. Herrington, R. Broos and Y. Miyazaki, Journal of Cellular Plastics, 1998, 34, 430-466.
8. T. Khan, V. Acar, M. R. Aydin, B. Hülagü, H. Akbulut and M. Ö. Seydibeyoğlu, Polymer Composites, 2020, 41, 2355-2400.
9. G. F. Smits, Journal of Thermal Insulation and Building Envelopes, 1994, 17, 309-329.
10. M. Thirumal, D. Khastgir, N. K. Singha, B. S. Manjunath and Y. P. Naik, Journal of Applied Polymer Science, 2008, 108, 1810-1817.
11. M. Thirumal, N. K. Singha, D. Khastgir, B. S. Manjunath and Y. P. Naik, Journal of Applied Polymer Science, 2010, 116, 2260-2268.
12. R. Hansen, Journal of Polymer Science Part A: Polymer Chemistry, 1993, 31, 1344-1344.
13. J. P. Sheth, S. Unal, E. Yilgor, I. Yilgor, F. L. Beyer, T. E. Long and G. L. Wilkes, Polymer, 2005, 46, 10180-10190.
14. I. Yilgör, E. Yilgör and G. L. Wilkes, Polymer, 2015, 58, A1-A36.
15. A. Aneja and G. L. Wilkes, Polymer, 2003, 44, 7221-7228.
16. E. Burgaz, Polyurethane Insulation Foams for Energy and Sustainability, Springer Cham, 2019.
17. E. Delebecq, J.-P. Pascault, B. Boutevin and F. Ganachaud, Chemical Reviews, 2013, 113, 80-118.
18. V. S. Daniel Klempner, Handbook of Polymeric Foams and Foam Technology Hanser Gardner Pulications Inc., Cincinnati, Ohio, 2nd edn., 2004.
19. H. Khatoon, S. Iqbal, M. Irfan, A. Darda and N. K. Rawat, Progress in Organic Coatings, 2021, 154, 106124.
20. J. W. McAuley, Environmental Science & Technology, 2003, 37, 5414-5416.
21. A. T. Mayyas, A. Qattawi, A. R. Mayyas and M. Omar, Journal of Cleaner Production, 2013, 40, 177-189.
22. M. Fadzil, A. B. Abdullah, Z. Samad, F. Yusof and Y. H. P. Manurung, in Design for Sustainability, eds. S. M. Sapuan and M. R. Mansor, Elsevier, 2021, DOI:
https://doi.org/10.1016/B978-O-12-819482-9.00006—X, pp. 435-463.
23. H. Blattmann, M. Fleischer, M. Bähr and R. Mülhaupt, Macromolecular Rapid Communications, 2014, 35, 1238-1254.
24 E. K. Leitsch, G. Beniah, K. Liu, T. Lan, W. H. Heath, K. A. Scheidt and J. M. Torkelson, ACS Macro Letters, 2016, 5, 424-429.
25. Y.-J. Yu, K. Hearon, T. S. Wilson and D. J. Maitland, Smart Materials and Structures, 2011, 20, 085010.
26. H. Blattmann, M. Lauth and R. Mülhaupt, Macromolecular Materials and Engineering, 2016, 301, 944-952.
27. F. Monie, B. Grignard, J.-M. Thomassin, R. Mereau, T. Tassaing, C. Jerome and C. Detrembleur, Angewandte Chemie International Edition, 2020, 59, 17033-17041.
28. J. D. Wolfgang, B. T. White and T. E. Long, Macromolecular Rapid Communications, 2021, 42, 2100163.
29. E. B. Anderson and T. E. Long, Polymer, 2010, 51, 2447-2454.
30. R. Gao, M. Zhang, S.-W. Wang, R. B. Moore, R. H. Colby and T. E. Long, Macromolecular Chemistry and Physics, 2013, 214, 1027-1036.
31. K. Zhang, A. M. Nelson, S. J. Talley, M. Chen, E. Margaretta, A. G. Hudson, R. B. Moore and T. E. Long, Green Chemistry, 2016, 18, 4667-4681.
32. J. M. Dennis, L. I. Steinberg, A. M. Pekkanen, J. Maiz, M. Hegde, A. J. Müller and T. E. Long, Green Chemistry, 2018, 20, 243-249.
33. R. A. Sheldon, Chemical Society Reviews, 2012, 41, 1437-1451.
34. M. Ravey and E. M. Pearce, Journal of Applied Polymer Science, 1997, 63, 47-74.
35. N. Yoshitake and M. Furukawa, Journal of Analytical and Applied Pyrolysis, 1995, 33, 269-281.
36. J. O. Akindoyo, M. D. H. Beg, S. Ghazali, M. R. Islam, N. Jeyaratnam and A. R. Yuvaraj, RSC Advances, 2016, 6, 114453-114482.
37. F. A. Milton, M. G. Lacerda, S. B. P. Sinoti, P. G. Mesquita, D. Prakasan, M. S. Coelho, C. L. de Lima, A. G. Martini, G. T. Pazzine, M. d. F. Borin, A. A. Amato and F. d. A. R. Neves, Frontiers in Pharmacology, 2017, 8.
38. S. Zhang, L. Wang, Z. Wang, D. Fan, L. Shi and J. Liu, Chemosphere, 2017, 171, 142-148.
39. A. Farkas and P. F. Strohm, Industrial & Engineering Chemistry Fundamentals, 1965, 4, 32-38.
40. H. Sardon, A. Pascual, D. Mecerreyes, D. Taton, H. Cramail and J. L. Hedrick, Macromolecules, 2015, 48, 3153-3165.
41. X. D. Zhang, C. W. Macosko, H. T. Davis, A. D. Nikolov and D. T. Wasan, Journal of Colloid and Interface Science, 1999, 215, 270-279.

### Example 6

Non-Isocyanate Polyurethane Segmented Copolymers from Bis-Carbonylimidazolides

Bis-carbonylimidazolide (BCI) functionalization enabled an efficient synthetic strategy to generate high molecular weight segmented non-isocyanate polyurethanes (NIPUs). Melt phase polymerization of ED-2003 Jeffamine®, 4,4′-methylenebis(cyclohexylamine), and a BCI monomer that mimics a 1,4-butanediol chain extender enabled polyether NIPUs that contain varying concentrations of hard segments ranging from 40 to 80 wt. %. Dynamic mechanical analysis and differential scanning calorimetry revealed thermal transitions for soft, hard, and mixed phases. Hard segment incorporations between 40 and 60 wt. % displayed up to three distinct phases pertaining to the poly(ethylene glycol) (PEG) soft segment T_{g}, melting transition, and hard segment T_{g}, while higher hard segment concentrations prohibited soft segment crystallization, presumably due to restricted molecular mobility from the hard segment. Atomic force microscopy (AFM) allowed for visualization and size determination of nanophase-separated regimes, revealing a nanoscale rod-like assembly of HS. Small-angle x-ray scattering confirmed nanophase separation within the NIPU, characterizing both nanoscale amorphous domains and varying degrees of crystallinity. These NIPUs, which were synthesized with BCI monomers, displayed expected phase separation that is comparable to isocyanate-derived analogues. This work demonstrates nanophase separation in BCI-derived NIPUs and the feasibility of this non-isocyanate synthetic pathway for the preparation of segmented PU copolymers.

Polyurethanes (PUs) enable various technologies due to modular molecular design that provides tunable thermomechanical properties. This modular design empowers versatile applications including coating, adhesive, insulation, textile, and additive manufacturing industries, among others.¹⁻⁴ Covalently bound nanoscale phase separated domains allow for modularity through monomer selection to yield targeted thermomechanical or adhesive properties. Traditionally, PUs leverage rapid kinetics between diverse isocyanates and alcohols in a polyaddition reaction to form urethane bonds linking hard and soft domains.⁵ Immiscibility between hard and soft segments results in nanoscale phase separated domains.^{6, 7} The hard segment (HS) imparts physical crosslinking due to dimeric hydrogen bonding, which increases T_{g} and modulus compared to the adjacent soft segment (SS).^{8, 9} Modulation of the chemical structure and concentration of the isocyanate and chain extender provides further

### INTRODUCTION

control over thermomechanical properties with chain extenders playing a crucial role in driving phase separation.^{10, 11} Chain extender symmetry, length, and composition directly correlate to phase separation behavior; critical parameters include rigidity, hydrogen bonding, and packing considerations.^{10, 12-15} Conversely, flexible oligomeric polyols comprise the SS to impart flexibility, impact resistance, low temperature performance, and damping properties. 16 Both of these domains are covalently bound through urethane linkages, enabling a unique combination of properties. Thus, fundamental understanding and promoting phase separation in PUs is essential for enhancing thermomechanical performance.

While the polyaddition of isocyanates allows for the efficient formation of hard and soft domains through control of reaction conditions and monomer stoichiometry, growing awareness of environmental and health considerations encouraged exploration of alternative synthetic routes for producing PUs while maintaining their desirable properties.¹⁷⁻¹⁹ The literature pervasive amine-driven ring-opening of cyclic carbonates facilitates the synthesis of linear and crosslinked hydroxy non-isocyanate polyurethanes (NIPUs).²⁰⁻²² This process offers mild reaction conditions and achieves moderate molecular weight, however, without addressing residual pendent hydroxyl groups there exists negative impacts on thermomechanical properties, i.e., increased hydrophilicity and reduced phase separation.^{23, 24} Furthermore, achieving control of the pendent hydroxyl, i.e., a primary or secondary alcohol, presents a challenge. Notably, these pendent hydroxyls increase water uptake resulting in plasticization.^{25, 26}

Likewise, the hydroxyls screen hydrogen bonding in the HS and increase miscibility between the HS and SS in polyether urethanes, resulting in a decrease of phase separation that produces a deviation from expected thermomechanical performance.²³ Torkelson et. al. demonstrated a poly(ethylene glycol) (PEG) SS led to increased phase mixing resulting from hydrogen bonding with pendant hydroxyl groups, while a poly(tetramethylene glycol) (PTMO) SS led to phase separation with a very broad interphase that improved damping, however, is not commonly desired or observed with traditional non-hydroxy PUs.^{23, 27} Several innovative chemistries serve to overcome this disadvantage through careful SS selection or introducing specialty chain extenders.^{23, 28-30} These methods proved effective in achieving nanophase separation for the cyclic carbonate NIPU system, however a facile approach that avoids pendant hydroxyl groups remains desired.

Bis-carbonylimidazolide (BCI) functionality provides a viable strategy for synthesizing NIPUs while leveraging legacy melt polymerization conditions. This synthesis readily produces both linear and crosslinked architectures and exhibits in-situ CO₂ formation for producing NIPU foams.^{31, 32} The phase separation behavior of BCI-derived NIPU segmented copolymers has not been thoroughly investigated or reported. This manuscript demonstrates phase separation within polyether urethanes synthesized in the absence of isocyanates. Dynamic mechanical analysis (DMA) and differential scanning calorimetry (DSC) evaluated thermal transitions in phase separated NIPUs, while atomic force microscopy (AFM) allowed for surface visualization of hard and soft domain size and shape. Small-angle x-ray scattering (SAXS) enabled characterization of the bulk morphology, providing further understanding of phase separation within these NIPU systems. The results presented expand the scope of knowledge regarding phase separation within BCI-based NIPUs while maintaining traditional PU chemical compositions.

### Experimental Section

### Instruments

¹H and ¹³C nuclear magnetic resonance (NMR) spectroscopy utilized a Bruker Avance NEO 500 MHz spectrometer functioning at 500.15 MHz and 23° C. (solution concentration of 10 mg mL⁻¹). A Mel-Temp 1101D digital melting point apparatus operating at 5° C. min 1 provided melting points for the monomer. A ThermoFisher Scientific Nicolet iS10 FTIR spectrometer, with a diamond cell at 25° C., confirmed PU structure after 64 scans of melt-pressed films. A TA Instruments TGA 5500 facilitated thermogravimetric analysis (TGA) by utilizing a heating rate of 10° C. min 1 from 25 to 600° C. with a steady nitrogen purge. The T_{d,5%}, or temperature where 5% of the original sample mass loss, served as an indicator for thermal stability of the sample. A TA Instruments DSC 2500 with heat/cool/heat cycles of 10° C. min⁻¹ provided differential scanning calorimetry data, where the sample was under a nitrogen environment throughout the experiment. DSC provided the glass transition temperatures (T_{g}s) from the midpoint of the endothermic transition in the second heat. Compression molding provided thin films by compressing the PU between Mylar sheets at 200° C. on a PHI hydraulic press. McLube Mold Release, a silicone-based mold release agent, ensured facile removal of the PU films. A TA Instruments DMA Q800 with a temperature ramp of 3° C. min 1 from −90° C. to 180° C. at 1 Hz provided a T_{g} derived from the maximum of the tan δ. Liquid nitrogen cooling permitted the cryogenic temperatures required to observe the thermal transitions of the PU films. A TA Instruments TGA-SA enabled water uptake measurements between 5% and 95% relative humidity in 5% stepwise increments. A Bruker MultiMode 8-HR enabled atomic force microscopy (AFM) of melt processed NIPU films. AFM samples were prepared by heating NIPUs on an AFM stage, resulting in sample flow and a smooth surface finish upon cooling. Insolubility of these compounds prevented solvent casting or spin coating sample preparation techniques. This instrument leveraged a MikroMasch chromium and gold coated silicon AFM probe operating at 355.952 kHz with a drive amplitude of 24.4 mV. Scans were completed in a 256 by 256 raster pattern with an aspect ratio of 1 for all magnifications.

### SAXS/WAXS Measurement

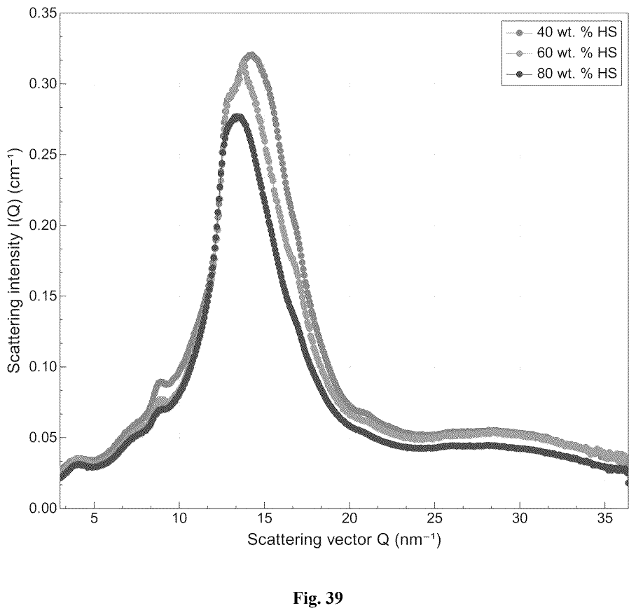

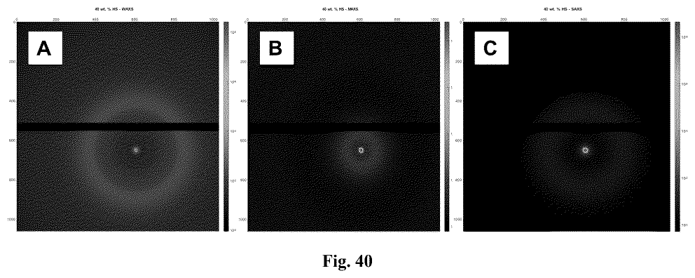

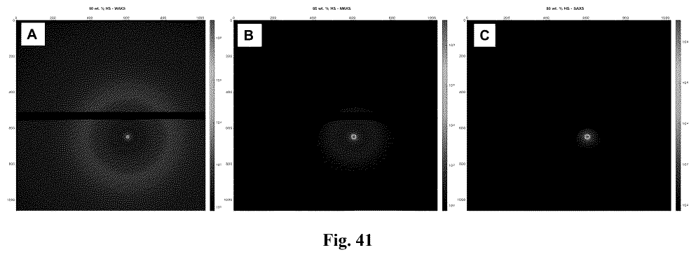

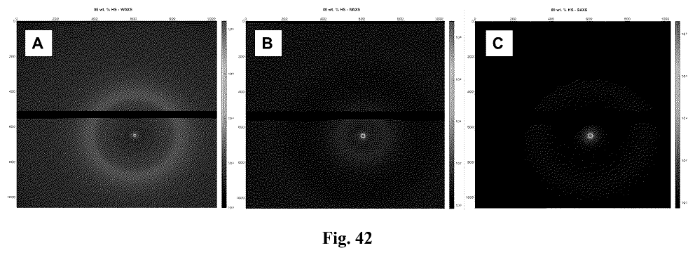

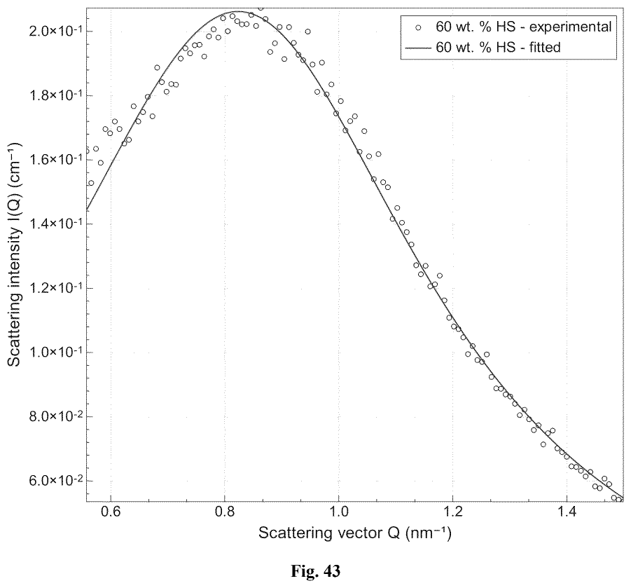

Small- and wide-angle x-ray scattering (SAXS/WAXS) measurements were performed on a Xenocs Xeuss 3.0 SAXS/WAXS instrument. A GeniX3D Cu High Flux Very Long (HFVL) focus source was used to produce an 8 KeV Cu K alpha collimated X-ray beam with a wavelength of 1.541891 Å (generated at 50 kV and 0.6 mA). A windowless EIGER2 R 1M DECTRIS Hybrid pixel photon counting detector was used to collect the scattering signals at three sample-to-detector distances of 50 mm, 370 mm, and 900 mm (denoted as WAXS, MAXS and SAXS in the Xeuss system) to cover a broad Q range between ˜0.05 nm⁻¹ and ˜36.37 nm⁻¹ correspond to length scale range between ˜0.17 nm and ˜127.61 nm. “High resolution” configuration was used for WAXS with a beam size of 0.4 mm. Measuring time was 30 min for the samples of 40 wt. % HS and 80 wt. % HS, and 1 h for the sample of 60 wt. % HS to account for thickness. “Standard” configuration was used for MAXS with a beam size of 0.7 mm and SAXS with a beam size of 0.5 mm. Larger beam sizes give higher flux for MAXS and SAXS which have longer sample-to-detector distances. For MAXS configuration, measuring time was 40 min for the samples of 40 wt. % HS and 80 wt. % HS, and 1 h 20 min for the sample of 60 wt. % HS. For SAXS configuration, measuring time was 1 h for the samples of 40 wt. % HS and 80 wt. % HS, and 2 h for the sample of 60 wt. % HS. Each raw 2D scattering image was reduced by azimuthal average in 360° to a 1D scattering curve considering geometrical corrections and transmitted intensity. Finally, each 1D scattering curve of sample was subtracted by the corresponding 1D scattering curve of direct beam considering sample thickness (FIG. 39-43). The 2D scattering curves for the SAXS, WAXS, and MAXS display clear isotropic features, where a 5 mm gap between the two detector modules are represented as a black rectangular region.

### Materials

1,4-butanediol (>99.0%), 1,1′-carbonyldiimidazole (CDI, >97.0%), and Jeffamine ED-2003 (ED-2003, average Mₙ=1900 g mol⁻¹) were purchased from Sigma Aldrich and stored in a desiccator under reduced pressure. 4,4′-methylenebis(cyclohexylamine) (HMDA, 95%, technical grade) was purchased from Sigma Aldrich and used as received. Ethyl acetate (>99.5%, ACS grade) was purchased from Fisher Scientific and used as received. Nitrogen gas (99.999% UHP-T) and liquid nitrogen (LC240 22 PSI) were purchased from Praxair Distribution. Deuterated chloroform (CDCl₃) was purchased from Cambridge Isotope Laboratories, Inc. All reagents and solvents were used as received unless stated otherwise.

### Synthesis of 1,4-Butyl(bis-carbonylimidazolide) (BBCI)

Synthesis adhered to our previous literature procedure.^{31, 32} 1,4-butanediol (27.04 g, 0.3 mol) was added to a three-necked, 1 L round-bottomed flask outfitted with a magnetic stir bar, nitrogen inlet, nitrogen outlet, and rubber septa. 1,4-butanediol was dissolved in ethyl acetate (600 mL) at 25° C. for 10 min under a nitrogen purge. 1,1′-carbonyldiimidazole (CDI) (121.61 g, 0.7 mol) was added to the flask in partitions to allow for even mixing and to reduce the propensity for cyclization. The initial ˜60 g of CDI dissolved readily in the solvent, producing a transparent and colorless solution. CDI solution saturation and product formation resulted in a turbid, white slurry. An additional 60 mL of ethyl acetate was added to ensure reagents were well mixed. The reaction was allowed to proceed for ˜2 h prior to filtration using a fritted funnel. The white powder was washed twice with ethyl acetate to remove byproducts (500 mL total) and dried at 60° C. and ˜25 mmHg for 18 h. The final isolated yield was >90% with a melting point range of 138-140° C. ¹H NMR (CDCl₃, δ) 8.13-8.14 (t, 2H, 3), 7.41-7.42 (t, 2H, 2), 7.07-7.08 (m, 2H, 1), 4.47-4.51 (t, 4H, 5) 1.95-2.00 (m, 4H, 6).

### Synthesis of Phase Separated NIPUs

Synthesis of the phase separated NIPUs utilized melt polycondensation conditions similar to conventional polyester reactors. ED-2003, BBCI, and HMDA were degassed and dried at reduced pressure at 80° C. for 12 h prior to reacting. Stochiometric equivalents of BBCI, ED-2003, and HMDA were added to a 100 mL round-bottomed flask with a glass t-neck adapter, metal stir rod, and glass stir rod adapter. A distillation arm was connected to collect the imidazole condensate. An overhead mechanical stirrer enabled mixing. The stoichiometry of BBCI to diamine (ED-2003 and HMDA) was maintained at a 1:1 molar ratio for all NIPU compositions. The stoichiometry of ED-2003 and HMDA were modulated to tune HS wt. % such that the final mass of BBCI after imidazole loss and HMDA comprised the HS, and ED-2003 comprised the SS. An exemplary synthetic stoichiometry for the 60 wt. % hard segment NIPU is as follows: 4.5 g (2.3 mmol) of ED-2003 Jeffamine®, 6.27 g (22.5 mmol) of BBCI (wherein imidazole accounts for 3.07 g of the BBCI used and is therefore not included in HS calculations), and 4.23 g (20.2 mmol) are added to a round-bottomed flask. The first step of the reaction was completed under a nitrogen environment to build molecular weight and decrease reactant volatility, then vacuum was introduced to remove the imidazole condensate and promote reaction progress, as shown in Scheme 4.1. Yields for all NIPUs ranged from 94-97% due to transfer loss of product as it was extracted from the round bottom.

### Results and Discussion

A facile, one-pot synthesis comprising of BBCI, HMDA, and ED-2003 Jeffamine® synthesized a series of phase separated NIPUs. The ED-2003 Jeffamine® contains a triblock topology where m=39 repeating units and the sum of n and 1=6 repeating units, resulting in a majority PEG backbone. A reaction temperature of 120° C. ensured melting of all reagents for homogenous mixing in the absence of solvent. Additionally, the lower molecular weight of HMDA compared to ED-2003 resulted in the preferential reaction of BBCI and HMDA to form HS units prior to ED-2003 addition. Previous PU literature describes similar phenomenon when utilizing the “one-shot” synthetic method.⁴ Furthermore, the introduction of reduced pressure to the reaction promoted molecular weight increase due to the efficient removal of the imidazole condensate. Tuning the stoichiometry of HMDA and ED-2003 enabled control over HS and SS concentration with BBCI and HMDA comprising the HS and ED-2003 comprising the SS.

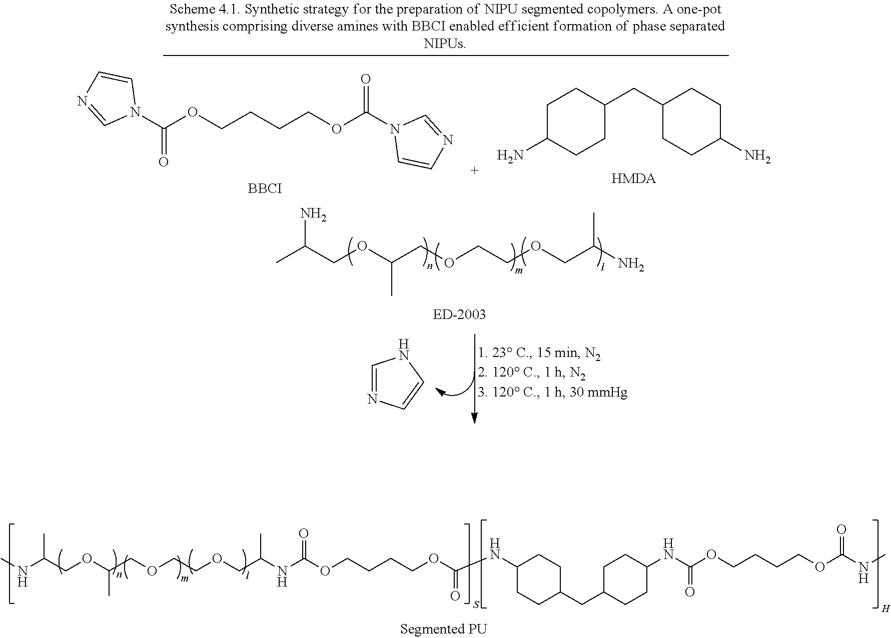

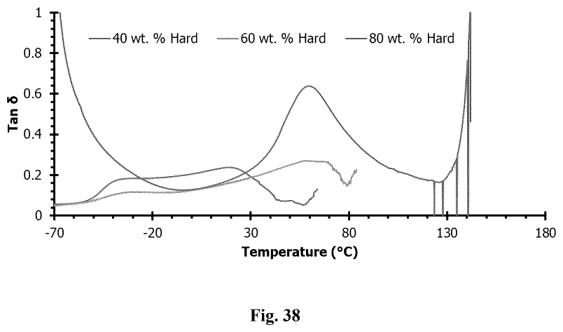

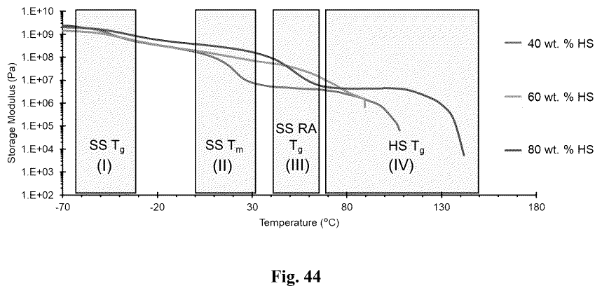

DMA probed thermal transitions present in melt-pressed NIPU films. All NIPU compositions achieved a storage modulus greater >2 GPa below the lowest T_{g} value, however exhibited varied transitions aligning with HS concentration upon heating, shown in FIG. 44. As expected, as HS concentration increased, the storage modulus value loss attributed to the SS T_{g} decreased. This result aligned with expectations in nanophase-separated PU systems that contain different concentrations of structural HS. Additionally, a tan δ maxima at 20° C. present in the 40 wt. % HS (FIG. 38) corresponded to melting of semi-crystalline PEG, confirmed by the presence of a sharp endothermic peak in the DSC trace. While a lower Tₘ than traditionally observed for PEG, propylene oxide repeating units between the PEG backbone and urethane linkage explained a lower Tₘ as compared to the Tₘ of pure PEG. Notably, this melting transition intensity decreased with increasing HS concentration, presumably due to smaller PEG domains that limit crystal formation, or a lower overall concentration of SS. The 60 wt. % HS sample displayed a melting transition with DMA that overlapped slightly with HS T_{g}, however possessed an independent, sharp melting endotherm in DSC data that decoupled these transitions. A lower ultimate T_{g} for the 60 wt. % HS sample suggested a degree of phase mixing between the HS and SS. This contrasted to the 40 wt. % sample, which displayed an elevated ultimate T_{g}, which was not expected due to a greater concentration of SS. However, a larger degree of phase separation that resulted in more uniform HS domains supported this elevated T_{g} and was further supported by SAXS scattering data that revealed a decrease in domain size dispersity for the 40 wt. % HS sample. As expected, the 80 wt. % HS sample maintained the highest HS T_{g}, and additionally displayed the absence of a melting transition in both the DMA and DSC traces. Tan & analysis of this sample indicated a small PEG T_{g} followed by an intense transition at 40° C., belonging to a rigid amorphous T_{g} that was likely due to restricted rotation of the PEG segments adjacent to the HS. Rigid amorphous regions, which exist bound to the rigid HS, extend several nanometers into the polymer amorphous SS region.³³ This interphase size, coupled with SAXS analysis that displays interdomain spacing on the order of 6.8 nm, implies in the formation a substantial rigid amorphous region compared to the mobile amorphous domain elucidated in the −56° C. DMA transition for the 80 wt. % HS sample. SSs and HSs within the PU matrix are covalently attached, resulting in good interfacial relations between the SS and HS, further explaining the phenomenon of the rigid amorphous glass transition temperature, as the amorphous polymer is immobilized on the surface of the “filler” HS that exists below the T_{g} which acts as a glassy, supporting region. 34, 35

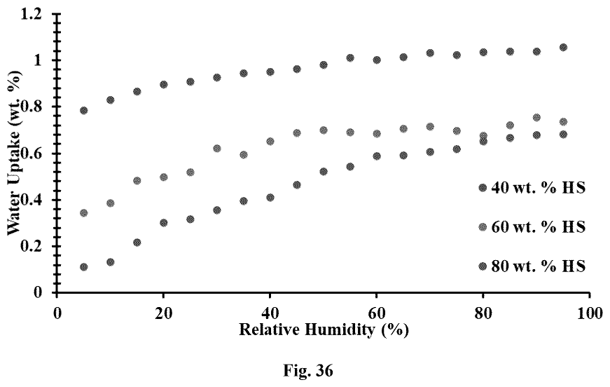

Additional evidence for the appearance of a rigid amorphous region stems from the disappearance of PEG melting endotherms for the 80 wt. % HS sample, signaling the disappearance of PEG crystallites in the NIPU matrix. The disappearance of PEG crystallites resulting from an increase in filler concentration in PU composite systems is well-documented in prior literature, as the constraint of PEG domains results in an increase in the rigid amorphous PU fraction and decrease in PEG crystallites.³³ The distinct transitions present in all NIPU compositions arose from nanoscale phase separation, which is in sharp contrast to previously reported properties belonging to poly(hydroxyurethane) (PHU)-derived NIPUs that contain PEG SSs, where earlier literature reported T_{g} values below room temperature due to phase mixing 23 This was attributed to the absence of pendent hydroxyl groups in the HS, which presented challenges for phase separation analogous to traditional isocyanate-derived PUs. BCI monomers produce NIPUs that maintain structural similarity to conventional PUs, thus resulting in more well-defined thermomechanical properties without additional synthetic complexity.^{12, 14} Likewise, this resulted in reduced water uptake of BCI NIPUs compared to PHUs; the NIPUs in this study displayed a maximum water uptake of ˜1 wt. % compared to ˜8 wt. % for literature PHUs (FIG. 36).²⁶

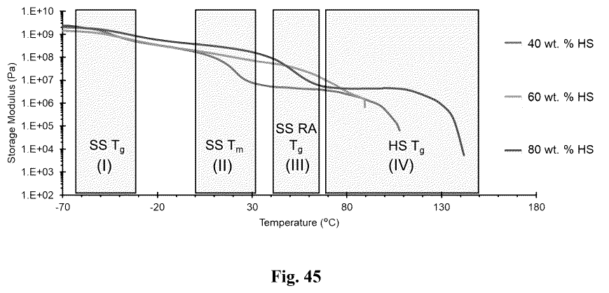

DSC traces corroborated DMA thermal transitions and provided further insight into the nature of the transitions observed, as shown in FIG. 45. Melting endotherms at 22° C. in both the 40 and 60 wt. % HS NIPUs confirmed modulus loss due to melting as opposed to a phase mixed T_{g}. Additionally, the decrease in melt enthalpy between the 40 and 60 wt. % HS samples correlated this melting behavior to PEG SS content, further suggesting that melting was due to PEG crystallites in the NIPU matrix. Likewise, the melting endotherm was absent in the 80 wt. % HS sample, presumably due to the decreased PEG domain size.

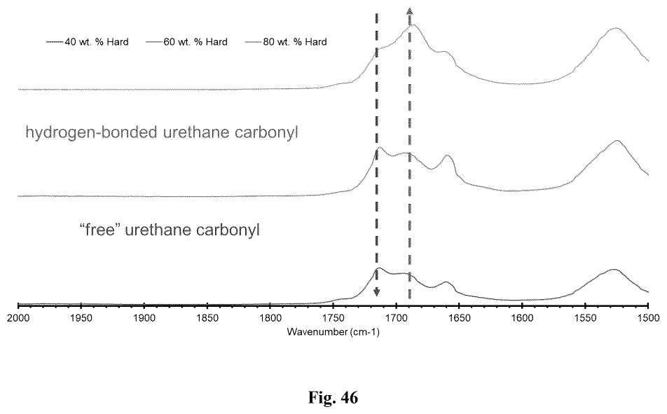

ATR-FTIR spectroscopy enabled further investigations into the relative phase separation of these NIPU systems. Various investigations explore the effect of hydrogen bonding on C═O resonance frequencies within phase separated PU systems that change as a function of hydrogen bonding.³⁶⁻³⁸ “Free” urethane carbonyls without strong dimeric hydrogen bonding present at higher wavenumbers (˜1730-1700 cm⁻¹), dependent on the type of isocyanate (aliphatic or aromatic). Conversely, hydrogen-bonded carbonyls resonate at lower wavenumbers (˜1700-1650 cm⁻¹), depending on the selected isocyanate chemistry or level of carbonyl ordering. Therefore, FTIR analysis enabled a comparison between the 40, 60, and 80 wt. % HS samples. Theory predicts an increase in the relative intensities of hydrogen-bonded urethane carbonyls as HS concentration increases resulting from a greater concentration of urethane linkages present along the polymer backbone.³⁹ Likewise, an increase in HS concentration results in a decrease in “free” carbonyls resulting from a phase mixed environment. FIG. 46 displays the relevant carbonyl region for all synthesized NIPUs, revealing trends that align with literature precedence. Notably, the relative intensity of hydrogen-bonded carbonyls to “free” carbonyls increased as a function of HS concentration. These results aligned with DMA data that displayed a higher plateau modulus as HS concentration increased, resulting from structural, hydrogen-boned urethane linkages.

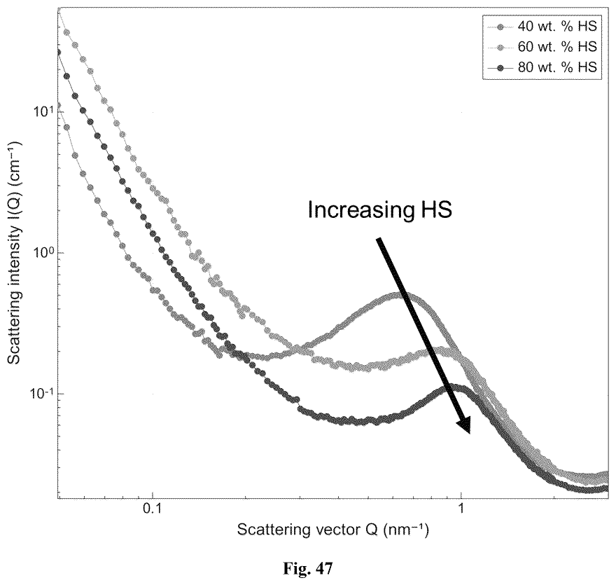

As previously discussed, nanoscale domains display distinct thermomechanical and chemical properties and are probed with a complement of spectroscopic and physical characterization techniques. SAXS and WAXS allowed for measurement of the bulk morphology present in melt-pressed NIPU films.⁴⁰ FIG. 47 displays the SAXS scattering profiles of all NIPUs. Peaks in the scattered intensity revealed nanophase separation for all samples and Lorentzian peak fitting and power law fitting were done in the SAXS region for each sample separately. The peak center shifted from 0.63 nm⁻¹ to 0.94 nm⁻¹ with increasing concentration of HS, corresponding to the decrease of length scale from 9.91 nm to 6.68 nm. This indicated that the average domain size in NIPUs containing a larger concentration of HS were on average smaller. Additionally, the decrease of peak height with increasing concentration of HS revealed an increased dispersity of all domain sizes. The increase of full width half maximum (FWHM) from 0.53 nm⁻¹ to 0.83 nm⁻¹ showed a wider distribution of domain sizes resulting from the increase in HS concentration. The power law exponent, or the slope of the curves at low Q, displayed no significant change between samples, while the intensity at low Q was the highest for the sample with intermediate HS concentration at 60 wt. %. The enhanced complex surface scattering between HS and SS further suggested that the 60 wt. % HS sample contained the most amount of interfacial area, however was comparable with the other samples tested. While domain size dispersity increased with SS loading, the FWHM values displayed a lower dispersity as compared to previously published PHUs and are on the size order for previously reported isocyanate analogues.^{23, 27, 41} This result arises from the structural similarity between BCI NIPUs and isocyanate-derived PUs, which displayed well-understood SS and HS incompatibility leading to more well-defined phase separation. Additionally, WAXS displayed a shift in the peak towards lower Q values, indicating larger d-spacing as HS is increased (FIG. 39).

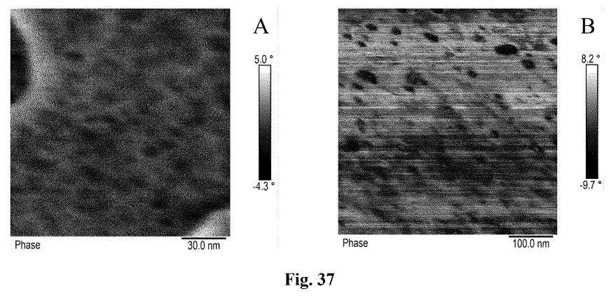

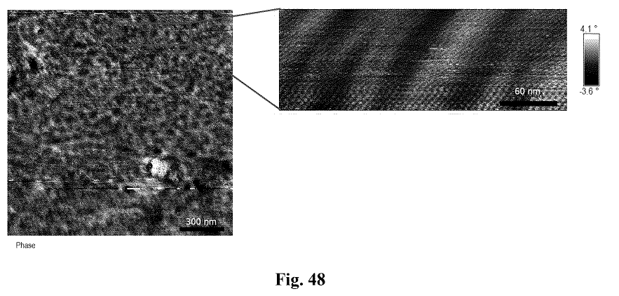

AFM analysis of PU surface phase separation provides extensive literature precedence for the visualization of this phenomenon.^{12, 15, 42} SAXS measurements also characterize domain sizing, however additional shape data from AFM analysis proves useful when visualizing these domains. Tapping mode analysis enabled phase angle measurement across the sample surface, which can be indicative of surface modulus values, however is also influenced by electrostatic interactions that can present as aberrations in the AFM micrograph (FIG. 37). SS and HS domains possess different moduli due to differing T_{g} values at room temperature, producing a corresponding change to phase angles across the surface. This resulted in AFM traces that clearly displayed phase separation in all samples, as depicted in FIG. 48. The higher modulus HS domains appeared as linearly growing rods (lighter color), while the SS was dispersed throughout. Previous literature predicts an interconnected HS network at HS concentrations above 25 wt. % due to volume fraction considerations, apparent in all tested samples (FIG. 37).¹⁴ Overall, AFM displayed expected nanophase separation behavior similar to traditional PUs, however, utilizing an isocyanate-free synthetic pathway. Likewise, surface characterization with AFM aligns with bulk SAXS analysis and DMA thermomechanical evaluation, strongly suggesting the appearance of nano-scale phase separated domains within all synthesized NIPUs possessing PEG SSs.

### Conclusions

BCI chemistry enabled the synthesis of phase separated NIPUs utilizing a melt polycondensation reaction. The absence of pendant hydroxyl groups resulted in well-defined phase separation behavior within the investigated NIPUs. Likewise, BCI chemistry leveraged modern, isocyanate-, solvent-, and catalyst-free reaction conditions. DMA and DSC characterized thermomechanical performance, allowing for the identification of discrete segments within the NIPU matrix. Both 40 and 60 wt. % HS NIPUs displayed PEG T_{g}s and crystalline melting peaks, while the 80 wt. % HS sample offered increased HS T_{g}. AFM revealed phase separation in all compositions containing nanometer domain spacing of melt-processed film surfaces. SAXS measurements further confirmed nanometer domain sizing of the NIPU bulk. This investigation addresses concerns for the negative effects of PHU pendant hydroxyls on nanophase separation, while maintaining an isocyanate-free synthetic pathway. Further investigations into diverse SS and HS compositions will synthesize a library of phase separated NIPUs obtained without the use of isocyanates or presence of pendant hydroxyl groups.

### References Cited in this Example

1. Somarathna, H. M. C. C.; Raman, S. N.; Mohotti, D.; Mutalib, A. A.; Badri, K. H., The use of polyurethane for structural and infrastructural engineering applications: A state-of-the-art review. Construction and Building Materials 2018, 190, 995-1014.
2. Akindoyo, J. O.; Beg, M. D. H.; Ghazali, S.; Islam, M. R.; Jeyaratnam, N.; Yuvaraj, A. R., Polyurethane types, synthesis and applications-a review. RSC Advances 2016, 6 (115), 114453-114482.
3. Gama, N. V.; Ferreira, A.; Barros-Timmons, A., Polyurethane Foams: Past, Present, and Future. Materials 2018, 11 (10), 1841.
4 Szycher, M., Szycher's Handbook of Polyurethanes, First Edition. Taylor & Francis: 1999.
5 Delebecq, E.; Pascault, J.-P.; Boutevin, B.; Ganachaud, F., On the Versatility of Urethane/Urea Bonds: Reversibility, Blocked Isocyanate, and Non-isocyanate Polyurethane. Chemical Reviews 2013, 113 (1), 80-118.
6. Yilgör, I.; Yilgör, E.; Wilkes, G. L., Critical parameters in designing segmented polyurethanes and their effect on morphology and properties: A comprehensive review. Polymer 2015, 58, A1-A36.
7. Kwei, T. K., Phase separation in segmented polyurethanes. Journal of Applied Polymer Science 1982, 27 (8), 2891-2899.
8. Miller, J. A.; Lin, S. B.; Hwang, K. K. S.; Wu, K. S.; Gibson, P. E.; Cooper, S. L., Properties of polyether-polyurethane block copolymers: effects of hard segment length distribution. Macromolecules 1985, 18 (1), 32-44.
9. O'Sickey, M. J.; Lawrey, B. D.; Wilkes, G. L., Structure-property relationships of poly(urethane-urea) s with ultralow monol content poly(propylene glycol) soft segments. III. influence of mixed soft segments of ultralow monol poly(propylene glycol), poly(tetramethylene ether glycol), and tri(propylene glycol). Journal of Applied Polymer Science 2003, 89 (13), 3520-3529.
10. Pourmohammadi-Mahunaki, M.; Haddadi-Asl, V.; Roghani-Mamaqani, H.; Koosha, M.; Yazdi, M., Effect of chain extender length and molecular architecture on phase separation and rheological properties of ether-based polyurethanes. Polymer Bulletin 2022, 79 (10), 8653-8668.
11. Stribeck, A.; Poselt, E.; Eling, B.; Jokari-Sheshdeh, F.; Hoell, A., Thermoplastic Polyurethanes with varying hard-segment components. Mechanical performance and a filler-crosslink conversion of hard domains as monitored by SAXS. European Polymer Journal 2017, 94.
12. Aneja, A.; Wilkes, G. L., A systematic series of ‘model’ PTMO based segmented polyurethanes reinvestigated using atomic force microscopy. Polymer 2003, 44 (23), 7221-7228.
13. Blackwell, J.; Nagarajan, M. R.; Hoitink, T. B., Structure of polyurethane elastomers: effect of chain extender length on the structure of MDI/diol hard segments. Polymer 1982, 23 (7), 950-956.
14. Abouzahr, S.; Wilkes, G. L.; Ophir, Z., Structure-property behaviour of segmented polyether-MDI-butanediol based urethanes: effect of composition ratio. Polymer 1982, 23 (7), 1077-1086.
15. Sheth, J. P.; Aneja, A.; Wilkes, G. L.; Yilgor, E.; Atilla, G. E.; Yilgor, I.; Beyer, F. L., Influence of system variables on the morphological and dynamic mechanical behavior of polydimethylsiloxane based segmented polyurethane and polyurea copolymers: a comparative perspective. Polymer 2004, 45 (20), 6919-6932.
16. Gisselfält, K.; Helgee, B., Effect of Soft Segment Length and Chain Extender Structure on Phase Separation and Morphology in Poly(urethane urea)s. Macromolecular Materials and Engineering 2003, 288 (3), 265-271.
17. Zapp, J. A., Jr., Hazards of Isocyanates in Polyurethane Foam Plastic Production. Arch. Indust. Health 1957, 15 (4), 324-30.
18. Liu, G.; Wu, G.; Huo, S.; Jin, C.; Kong, Z., Synthesis and properties of non-isocyanate polyurethane coatings derived from cyclic carbonate-functionalized polysiloxanes. Progress in Organic Coatings 2017, 112, 169-175.
19. Zhang, K.; Nelson, A. M.; Talley, S. J.; Chen, M.; Margaretta, E.; Hudson, A. G.; Moore, R. B.; Long, T. E., Non-isocyanate poly(amide-hydroxyurethane) s from sustainable resources. Green Chemistry 2016, 18 (17), 4667-4681.
20. Gomez-Lopez, A.; Elizalde, F.; Calvo, I.; Sardon, H., Trends in non-isocyanate polyurethane (NIPU) development. Chemical Communications 2021, 57 (92), 12254-12265.
21. Tomita, H.; Sanda, F.; Endo, T., Model reaction for the synthesis of polyhydroxyurethanes from cyclic carbonates with amines: Substituent effect on the reactivity and selectivity of ring-opening direction in the reaction of five-membered cyclic carbonates with amine. Journal of Polymer Science Part A: Polymer Chemistry 2001, 39 (21), 3678-3685.
22. Blattmann, H.; Fleischer, M.; Bähr, M.; Mülhaupt, R., Isocyanate- and Phosgene-Free Routes to Polyfunctional Cyclic Carbonates and Green Polyurethanes by Fixation of Carbon Dioxide. Macromolecular Rapid Communications 2014, 35 (14), 1238-1254.
23. Leitsch, E. K.; Beniah, G.; Liu, K.; Lan, T.; Heath, W. H.; Scheidt, K. A.; Torkelson, J. M., Nonisocyanate Thermoplastic Polyhydroxyurethane Elastomers via Cyclic Carbonate Aminolysis: Critical Role of Hydroxyl Groups in Controlling Nanophase Separation. ACS Macro Letters 2016, 5 (4), 424-429.
24. Besse, V.; Camara, F.; Mechin, F.; Fleury, E.; Caillol, S.; Pascault, J.-P.; Boutevin, B., How to explain low molar masses in PolyHydroxyUrethanes (PHUs). European Polymer Journal 2015, 71, 1-11.
25. Kotanen, S.; Poikelispää, M.; Efimov, A.; Harjunalanen, T.; Mills, C.; Laaksonen, T.; Sarlin, E., Hydrolytic stability of polyurethane/polyhydroxyurethane hybrid adhesives. International Journal of Adhesion and Adhesives 2021, 110, 102950.
26. Frias, C. F.; Fonseca, A. C.; Coelho, J. F. J.; Serra, A. C., Crosslinked poly(hydroxyurethane) films from biobased carbonates: Structure-properties relationships and the influence of moisture in the mechanical properties. Progress in Organic Coatings 2024, 187, 108100.
27. Beniah, G.; Liu, K.; Heath, W. H.; Miller, M. D.; Scheidt, K. A.; Torkelson, J. M., Novel thermoplastic polyhydroxyurethane elastomers as effective damping materials over broad temperature ranges. European Polymer Journal 2016, 84, 770-783.
28. Bossion, A.; Aguirresarobe, R. H.; Irusta, L.; Taton, D.; Cramail, H.; Grau, E.; Mecerreyes, D.; Su, C.; Liu, G.; Müller, A. J.; Sardon, H., Unexpected Synthesis of Segmented Poly(hydroxyurea-urethane) s from Dicyclic Carbonates and Diamines by Organocatalysis. Macromolecules 2018, 51 (15), 5556-5566.
29. Hu, S.; Chen, X.; Torkelson, J. M., Isocyanate-free, thermoplastic polyhydroxyurethane elastomers designed for cold temperatures: Influence of PDMS soft-segment chain length and hard-segment content. Polymer 2022, 256, 125251.
30. Beniah, G.; Fortman, D. J.; Heath, W. H.; Dichtel, W. R.; Torkelson, J. M., Non-Isocyanate Polyurethane Thermoplastic Elastomer: Amide-Based Chain Extender Yields Enhanced Nanophase Separation and Properties in Polyhydroxyurethane. Macromolecules 2017, 50 (11), 4425-4434.
31. Wolfgang, J. D.; White, B. T.; Long, T. E., Non-isocyanate Polyurethanes from 1,1′-Carbonyldiimidazole: A Polycondensation Approach. Macromolecular Rapid Communications 2021, 42 (13), 2100163.
32. Sintas, J. I.; Wolfgang, J. D.; Long, T. E., Carbamate thermal decarboxylation for the design of non-isocyanate polyurethane foams. Polymer Chemistry 2023.
33. Koutsoumpis, S.; Raftopoulos, K. N.; Oguz, O.; Papadakis, C. M.; Menceloglu, Y. Z.; Pissis, P., Dynamic glass transition of the rigid amorphous fraction in polyurethane-urea/SiO2 nanocomposites. Soft Matter 2017, 13 (26), 4580-4590.
34. Füllbrandt, M.; Purohit, P. J.; Schönhals, A., Combined FTIR and Dielectric Investigation of Poly(vinyl acetate) Adsorbed on Silica Particles. Macromolecules 2013, 46 (11), 4626-4632.
35. Vogiatzis, G. G.; Theodorou, D. N., Structure of Polymer Layers Grafted to Nanoparticles in Silica-Polystyrene Nanocomposites. Macromolecules 2013, 46 (11), 4670-4683.
36. Pangon, A.; Dillon, G. P.; Runt, J., Influence of mixed soft segments on microphase separation of polyurea elastomers. Polymer 2014, 55 (7), 1837-1844.
37. Sahebi Jouibari, I.; Haddadi-Asl, V.; Mirhosseini, M. M., A novel investigation on micro-phase separation of thermoplastic polyurethanes: simulation, theoretical, and experimental approaches. Iranian Polymer Journal 2019, 28 (3), 237-250.
38. Sheth, J. P.; Klinedinst, D. B.; Pechar, T. W.; Wilkes, G. L.; Yilgor, E.; Yilgor, I., Time-Dependent Morphology Development in a Segmented Polyurethane with Monodisperse Hard Segments Based on 1,4-Phenylene Diisocyanate. Macromolecules 2005, 38 (24), 10074-10079.
39. Chen, K.-S.; Leon Yu, T.; Chen, Y.-S.; Lin, T.-L.; Liu, W.-J., Soft- and hard-segment phase segregation of polyester-based polyurethane. Journal of Polymer Research 2001, 8 (2), 99-109.
40. Li, Y.; Gao, T.; Chu, B., Synchrotron SAXS studies of the phase-separation kinetics in a segmented polyurethane. Macromolecules 1992, 25 (6), 1737-1742.
41. Cheng, B.-X.; Gao, W.-C.; Ren, X.-M.; Ouyang, X.-Y.; Zhao, Y.; Zhao, H.; Wu, W.; Huang, C.-X.; Liu, Y.; Liu, X.-Y.; Li, H.-N.; Li, R. K. Y., A review of microphase separation of polyurethane: Characterization and applications. Polymer Testing 2022, 107, 107489.

42. Sheth, J. P.; Wilkes, G. L.; Fornof, A. R.; Long, T. E.; Yilgor, I., Probing the Hard Segment Phase Connectivity and Percolation in Model Segmented Poly(urethane urea) Copolymers. Macromolecules 2005, 38 (13), 5681-5685.

### Example 7

Divalent Imidazolium Ionic Liquids from Bis-Carbonylimidazolide Monomers

Reactive imidazolide nitrogens present in biscarbonylimidazolide (BCI) monomers enabled an S2N reaction with alkyl halides resulting in a new divalent ionic liquid, BBCI IL. This ionic liquid possessed improved thermal stability up to 260° C. while maintaining chemical resistance to amine nucleophiles. In-situ FTIR spectroscopy coupled with ¹³C NMR and computational modeling revealed a deactivation of the electrophilic carbonyl present in BCI monomers after conversion to the ionic liquid state. Dielectric relaxation spectroscopy revealed the temperature and frequency dependence of the ionic conductivity possessed by BBCI IL, revealing εₛ=16. Lastly preliminary investigations into the synthesis of conductive ionenes derived from BCI monomers provided a series of polymers capable of thermomechanical property tuning, however displaying poor air stability.

### INTRODUCTION

Common descriptions of ionic liquids (ILs) classify them as salts with melting points below that of water, with some definitions requiring a molten status at ambient temperatures.¹ Unique physicochemical properties encourage their use for specialty applications that require low volatility, toxicity, flammability, high temperature stability, large thermal use window, or specialty dielectric environments.²⁻⁵ Diverse molecular structures, chemical composition, counterion selection, and molecular weight control endow these physicochemical properties throughout a large temperature range. Furthermore, the low vapor pressure ILs possess impart environmentally friendly aspects to their use, providing green alternatives to traditional volatile solvents.⁶ Several chemical structures encompass IL formulations including imidazolium, pyridinium, ammonium, or phosphonium functionalities that possess halide, tetrafluoroborate, hexafluorophosphate, or bis-trifluoromethanesulfonimide counterions.^{7, 8} Of these various chemical compositions, imidazolium ILs have emerged as a dominant choice due to their facile synthesis and tunable properties. Furthermore, imidazolium ILs containing halide counterions found specialty use as solvents for the dissolution of cellulose and carbohydrates.⁹

Imidazolium functional groups comprise a prevalent class of small molecule and polymeric IL's due to their electrochemical stability, low toxicity, catalytic effects, and desirable thermal properties.¹⁰⁻¹² Furthermore, divalent ionic liquids (ILs with a charge of +2) offer several advantages over their monovalent counterparts exemplifying greater solvation capabilities, lower volatility, and enhanced catalytic effects.^{13, 14} These ionic liquids are based on imidazolium cations that contain two positive charges, rendering them distinct from traditional monovalent imidazolium ionic liquids. Research in this area has focused on the synthesis, characterization, and application of these ionic liquids, as well as the exploration of their fundamental properties and behavior. Despite their promise, divalent imidazolium ionic liquids also present some challenges and limitations, including the complexity of their synthesis, potential toxicity, and environmental impact. Thus, a new synthetic method that remediates these issues is desired.

The versatility of imidazole as a reagent extends beyond IL formation, i.e. the recent use of imidazolide functionalized monomers for the synthesis of non-isocyanate polyurethane (NIPU) thermoplastic and foams.^{15, 16} Bis-carbonylimidazolide (BCI) monomers, generated from an imidazole reagent, enabled the efficient melt polymerization of NIPUs containing various backbone chemistries and topologies. Additionally, these monomers enable the efficient synthesis of polycarbonates through careful selection of reaction conditions.^{17, 18} The pendent imidazolide functional groups BCI monomers offer an atom-efficient reaction mechanism towards a new IL synthetic pathway, outlined in this manuscript. A facile S_{N}2 reaction between the nucleophilic imidzaolide nitrogen present in BCI monomers and an electrophilic alkylhalide enabled the quantitative synthesis of new divalent imidazolium ionic liquids with carbamate functionalities. Divalent, imidazolium ionic liquids derived from BCI monomers have not been previously discussed in literature, prompting their exploration.

### Materials

1,4-Butanediol (ReagentPlus®, 99%), 1,1′-Carbonyldiimidazole (CDI, 97%), 1-iodobutane (99%), poly(ethylene glycol) (PEG, BioReagent, 400 g mol⁻¹), potassium carbonate (K2CO₃, ACS reagent, ≥99.0%), 6-bromohexanoyl chloride (>97%), and acetonitrile (anhydrous, 99.8%) were purchased from Sigma-Aldrich and used as received. Ethyl Acetate (HPLC), anhydrous ethyl ether, ethanol (200 proof) and PEG (Bioreagent, 2,000 g mol⁻¹) were purchased from Fisher Scientific and used as received. 1,12-dibromododecane (DBD, 98%) was purchased from Sigma-Aldrich and was recrystallized from ethanol before use. N,N-dimethylformamide (DMF, extra dry, 99.8%) and dichloromethane (DCM, extra dry, 99.9%) were purchased from Acros Organics. Ultra-high purity nitrogen gas (99.999%) was purchased from Praxair

### Synthesis of BBCI

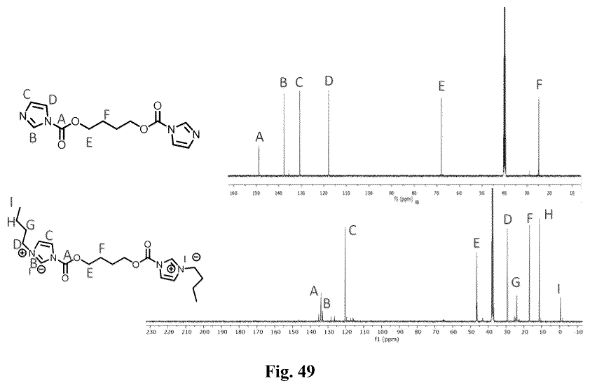

The synthesis of BBCI followed the procedure reported by previous pubications.^{19 1,4}-butanediol (10.000 g, 111 mmol) was added via powder funnel to a three-necked round bottomed flask equipped with a magnetic stir bar. Ethyl acetate (220 mL) was added to the flask and the mixture was stirred until the butanediol dissolved completely. CDI (44.981 g, 277 mmol) was added slowly to the solution to allow for easier dissolution. The reaction was allowed to proceed for 2 h at room temperature while stirring. The BBCI product precipitated from the clear solution as it was formed resulting in a white slurry. The product was filtered with a fritted filter and washed twice with additional ethyl acetate (˜50 mL) to remove any unreacted reagents. The resultant white powder was dried in vacuo at 60° C. for 18 h to give a >95% yield. The melting point of the pure white powder measured between 135-137° C.). ¹H NMR (CDCl₃, δ, FIG. 49) 8.12-8.14 (t, 2H), 7.41-7.43 (t, 2H), 7.07-7.09 (m, 2H), 4.47-4.52 (t, 4H) 1.94-2.00 (m, 4H).

### Synthesis of BBCI IL

BBCI (5 g, 18 mmol) and 1,4-iodobutane (6.61 g, 36 mmol) were added to a three-necked round bottom flask with a magnetic stir bar and dissolved in acetonitrile. The reaction was allowed to react under reflux at 80° C. for 30 hours. An in-situ FTIR probe was inserted into the reactor and was used to monitor reaction times. Acetonitrile and excess 1,4-iodobutane were removed at 120° C. under reduced pressure for 12 h.

### Synthesis of Imidazolium Ionenes

The synthesis of segmented and non-segmented ionenes were carried out using the following general procedure. For a segmented ionene containing 30 wt % HS, BBCI (2.128 g, 7.65 mmol), PEG₄₀₀ dibromide (2.518 g, 3.52 mmol), and DBD (1.353 g, 4.12 mmol) were added to a three-necked round bottomed flask equipped with a condenser and a magnetic stir bar. Anhydrous DMF was added via syringe and the flask was purged with N₂. The solution was heated at 80° C. for 48 h under constant nitrogen flow. The heterogeneous solution became homogeneous within min of heating. The polymer solution was precipitated in ether and dried in vacuo at 60° C. to afford a viscous pale-yellow liquid.

### Analytical Methods

Nuclear magnetic resonance (NMR) spectroscopy was carried out on an Agilent U4-DD2 spectrometer operating at 400 MHz or a Bruker 500 MHz and 23° C. All NMR samples were prepared from either a DMSO-d₆ or CDCl₃ solution at approximately 10 mg mL” 1. A TA instruments Q2000 facilitated differential scanning calorimetry (DSC) measurements under nitrogen flow and cooled with a refrigerated cooling system. The glass transition temperatures (T_{g}) were taken as the inflection point of the step transition that occurred during the second heating step. FTIR was performed on a Nicolet iS5 spectrometer equipped with an iD7 ATR stage at room temperature. A Mettler Toledo ReactIR 15 allowed for the in-situ monitoring of imidazolium formation. The spectra were taken 2 min apart from each other and consisted of 32 scans each. Molecular modeling of electrostatic potential was completed using WebMO.net under standard Hückel parameters.

Dielectric relaxation spectroscopy (DRS) measurements were performed using a Solartron 1260 Impedance/Gain-Phase Analyzer with a Solartron 1296A Dielectric Interface. The sample cell was a DHR rheometer accessory made by TA Instruments which utilized the rheometer's ETC to provide temperature control and a continuous dry nitrogen atmosphere for the electrode cell. The electrodes were 25 mm in diameter, made of stainless steel, and polished to a flat, mirror finish. Inside a glovebox, liquid sample was sandwiched between two electrodes separated by 50 μm silica fibers. The test chamber was dried at 150° C. for 1 h under a continuous nitrogen flow (10 L/min) before cooling to room temperature. The sample cell was quickly transferred into the test chamber at room temperature, purged with nitrogen, and further dried under constant nitrogen flow at 100° C. for 1 h to remove any remaining moisture. The sample was then subjected to an oscillating potential of 0.1 V over a frequency range of 1-106 Hz and measured at 10 points per decade using an auto-integration period≤10 s. This was performed at discrete temperatures from 30-0° C. DC conductivity (o′DC) was obtained by fitting horizontal lines to the plateau region of the frequency-dependent, real conductivity. Relative static permittivity (εₛ) values were obtained by fitting the frequency-dependent relative permittivity (ε′(ω)) to a sum of the real form of the Havrilak-Negami function and a power law function (i.e. Aω⁻ⁿ) to account for electrode polarization.²⁰

### Results and Discussion

Previous findings revealed the facile, high-yield synthesis of non-isocyanate polyurethane precursors known as bis-carbonylimidazolide (BCI) monomers.^{19, 21} These BCI monomers readily polymerize in the presence of multifunctional amines, producing both thermoplastic and thermoset NIPUs. A base-catalyzed elimination mechanism leveraging the proton beta to the urethane carbonyl facilitated in-situ CO₂ generation for NIPU foam production. The imidazolide nitrogen lone electron pair on BCI monomers enables the self-catalysis of this elimination, resulting in spontaneous decarboxylation at elevated temperatures.¹⁶ This reactivity, however, enables the application of additional elementary S₂N chemistry. BBCI readily adds to 1-iodobutane to form an imidazolium ion terminated BCI monomer, Scheme 5.1. An excess of 1-iodobutane enables the quantitative conversion of the BCI monomer to the IL form and is subsequently removed under vacuum.

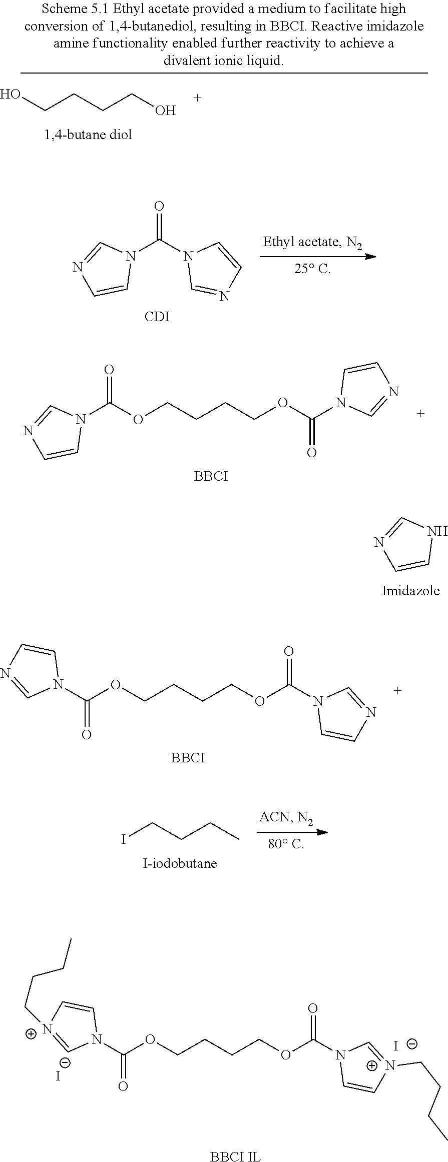

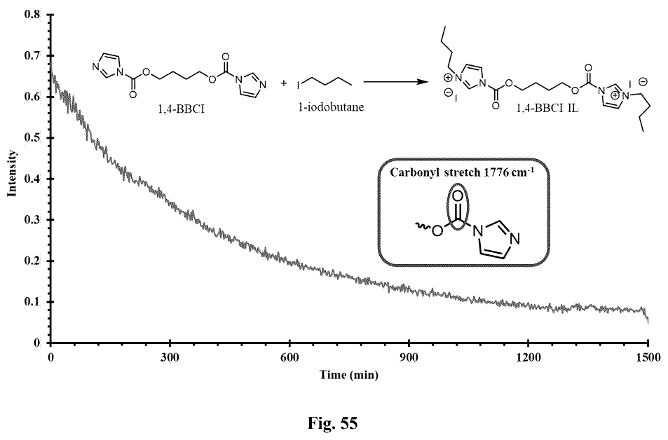

In-situ FTIR spectroscopy revealed reaction kinetics for the formation of BBCI IL, FIG. 55. The disappearance of the BBCI carbonyl absorbance with the formation of the imidazolium moiety allows monitoring of reaction progress. This experiment revealed complete conversion of the imidazolide unit after 25 h of reaction. The carbonyl absorbance shifted to a lower wavenumber, as expected due to the electron withdrawing nature of the adjacent imidazolium moiety. A fascinating discovery, however, is the extent of the observed carbonyl shift. Carbonyl stretches are rarely observed in the vicinity of 1564 cm⁻¹, however this new ionic liquid structure provides additional insight on the effects of electron withdrawing substituents on carbonyl bond characteristics and stability.²²

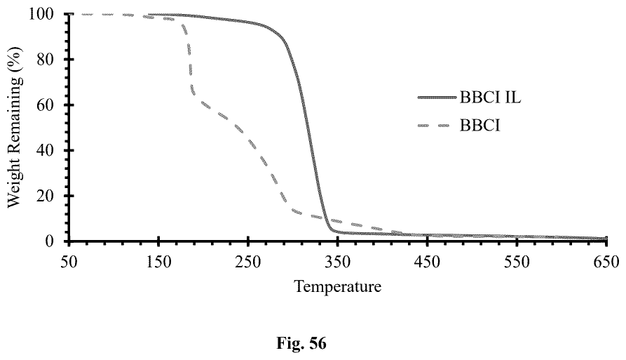

Non-ionic BCI monomers exhibit rapid weight loss at elevated temperatures due to a spontaneous decarboxylation event directed by the basic imidazolide nitrogen. Earlier literature thoroughly explored this mechanism by monitoring weight loss and CO₂ release at elevated temperatures.²³ Weight loss profiles for the imidazolium functionalized ionic liquid displayed an increased T_{d,5%} of 260° C., which aligns favorability for previously reported imidazolium ILs with iodide counterion literature values, FIG. 56.^{24, 25} This increase in weight loss temperature suggests the elimination of reactive imidazolide nitrogen lone pairs due to complete functionalization with the alkyl halide. Further decarboxylation experiments revealed no CO₂ generation throughout a range of elevated temperatures. These results are favorable, as functionalization removes reactivity from the final ionic liquid.

In-situ FTIR spectroscopy further evaluated IL stability to carbonyl attack by a nucleophile. Unfunctionalized BCI monomers display reactivity towards amines, displacing the imidazole moiety and forming a new carbamate linkage. Transforming the imidazolide moiety to an imidazolium fortuitously deactivates the carbonyl to nucleophilic attack. In-situ FTIR spectroscopy, ¹³C NMR, and elementary molecular orbital modeling explored this phenomenon. The frequency of resonance for similar IR stretches directly correlates to the polarizability and strength of the probed bond. The symmetric carbonyl stretch generally ranges from 1900 to 1600 cm⁻¹ and appears as an intense and sharp peak due to its large dipole moment. Generally, aromatic carbonyl absorbances fall lower than aliphatic ones due to pi interactions that draw electron density away from the carbonyl bond.

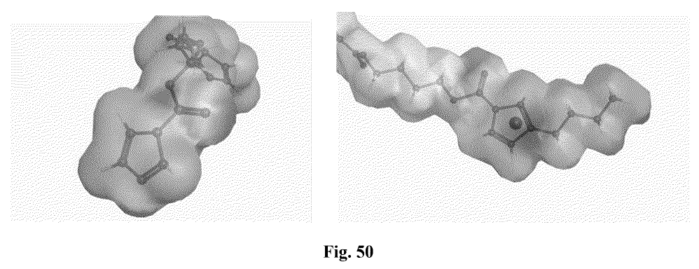

When attached to an imidazolium group, carbonyl pi electrons are drawn with a greater intensity away from that bond due to induction, resulting in an even lower stretching frequency. This is seen in the carbonyl absorbance of BBCI-IL, as the carbonyl stretch decreased from 1776 to 1564 cm⁻¹. The displacement of electron density from the carbonyl pi system, largely centered on the electronegative oxygen atom, results in an increase of electron density around the carbonyl carbon. This directly impacts reactivity, as the positive dipole moment on the carbonyl carbon directly contributes to its affinity for nucleophilic attack. ¹³C NMR probed the change in electronic environment of the carbonyl carbon. Generally, downfield shifts in ¹³C NMR signify a deshielded carbon environment, while higher electron density results in more upfield shifts. ¹³C NMR spectra before and after imidazolium functionalization reveal a change in the carbonyl carbon electronic environment in a manner that suggests shielding of the carbonyl carbon (Figure S₁). Molecular orbital (MO) modeling revealed expected electron density distributions within BBCI IL that further displayed this shielded environment (FIG. 50).

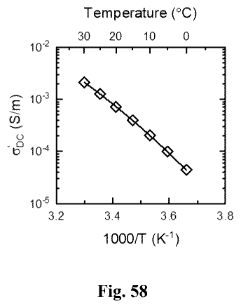

The temperature-dependent ionic conductivity (σ′_{DC}) of BBCI IL, shown in FIG. 58, displays the expected non-Arrhenius behavior of ILs.²⁶ The ionic conductivity of BBCI IL is comparable with other dicationic imidazolium ILs which exhibit similar glass transition temperatures.²⁷ Pitawala et al. demonstrated T_{g} to be the dominant factor governing differences in ionic conductivity between five dicationic imidazolium ILs investigated, determined based on superimposing conductivity profiles on a T_{g}-scaled Arrhenius plot.²⁷

TABLE 5.1
VFT equation parameters and fitting error of the
ionic conductivity data for BBCI IL.
VFT equation: σ = σ_{∞} e^{-B/(T - T}^{₀}⁾

| σ_{∞} (S/m) | B (K) | T₀ (K) |
|---|---|---|
| 631 ± 400 | 1608 ± 160 | 176 ± 6 |

The conductivity data for BBCI IL in FIG. 58 were fit to the Vogel-Fulcher-Tammann (VFT) equation, listed in Table 5.1. The Vogel temperature, To defines the theoretical or “ideal” glass transition temperature and generally lies ˜50 K below the experimental T_{g}, in close agreement with that obtained here (T_{g}−T₀=60 K). The preexponential factor, Go represents the high temperature limit of conductivity; B is related to dynamic activation barriers and can be useful when quantifying and comparing the extent to which conductivity depends on temperature.²⁸ The value of B obtained for BBCI IL is >2× larger than that found for similar dicationic ILs (600 vs 1600 K), implying that the ionic conductivity of BBCI IL exhibits a greater temperature dependence.²⁹ This can be interpreted as the dynamic interactions surrounding carbonylimidazolide groups possessing greater temperature dependence than those surrounding alkyl imidazolium groups.

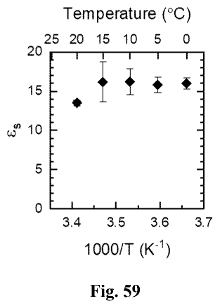

Relative static permittivity (εₛ), or dielectric constant, values for BBCI IL were obtained by fitting the real part of the relative permittivity to the proper form of the Havriliak-Negami function, FIG. 59.²⁰ The static permittivity of BBCI IL closely reflects literature values for several common alkyl imidazolium ILs, indicating that the carbonyl group does not significantly alter the capacitive properties of imidazolium-type species.³⁰ This is somewhat surprising considering the expanded resonant structures/states within carbonylimidazolide as compared to alkyl imidazolium.

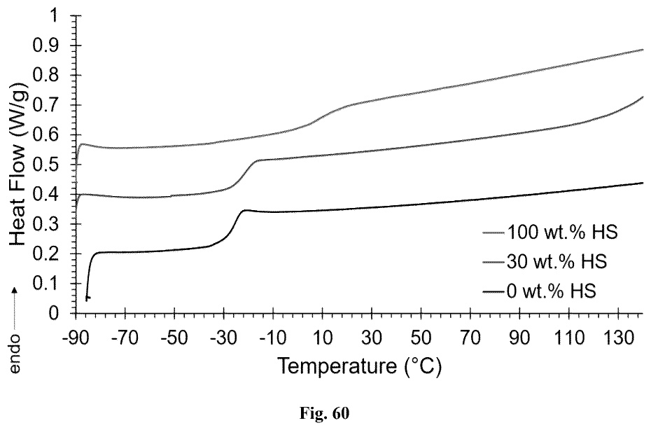

While the divalent BBCI IL displays unique chemical and electrical properties, preliminary investigations into the formation of polymeric ionenes are desired. Difunctional alkyl halides demonstrated polyaddition reactions with BBCI, resulting in linear, polyurethane ionenes demonstrated in Scheme 5.7. The facile synthesis of BBCI provided a route towards new imidazolium ionenes with unique backbone structures. Specifically, the inclusion of a carbamate group into the imidazolium ionene structure provides a hydrogen bond acceptor, which imparting unique thermal properties. Scheme 5.7 details the synthesis of imidazolium ionenes based on PEG dibromide and BBCI with an optional dibromide chain extender. In this case, the soft segment (SS) consists of the PEG dibromide reacted with the BBCI while the hard segment (HS) comprises of DBD reacted with BBCI. FIG. 60 displays the effect that HS incorporation imparts on the thermal properties of the resulting ionenes.

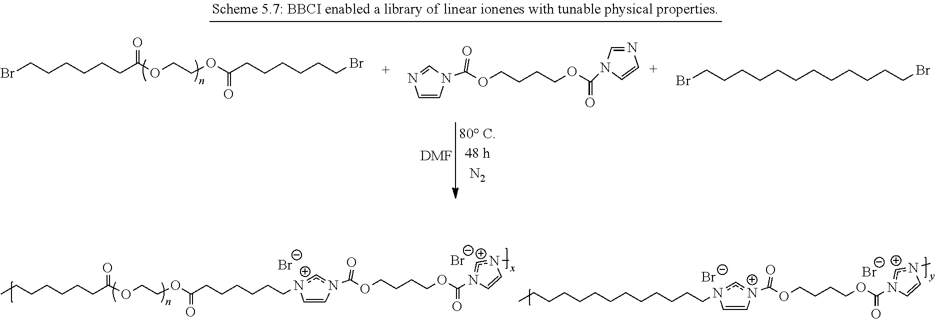

Literature indicates that incorporating lower molecular weight, amorphous PEG enhanced the ionic conductivity of the ionene compared to higher molecular weight, semi-crystalline PEGs.³¹ The synthesis of ionenes based on PEG₄₀₀ (n=9) resulted in highly viscous liquids, which suggested the formation of polymers in both the segmented and non-segmented compositions. However, the inability of these polymers to form free-standing films suggests that their molecular weights remain below the critical molecular weight required for mechanical performance. Next, PEG₂k (n=45) was utilized for this reaction using the rationale that starting with a higher molecular weight precursor should result in higher molecular weight polymers at similar conversions to the PEG₄₀₀ system. However, attempts to cast films of these polymers resulted in waxy, brittle solids comparable to neat PEG₂k. In a final attempt to achieve high molecular weight ionenes, BBCI and DBD reacted to form a homopolymer of the proposed HS. This reaction yielded a solid powder when precipitated, and solvent casting resulted in a free-standing film.

Upon removing all solvent from the film in a vacuum oven, the film exhibited some flexibility, however failed when attempting to crease the film. Furthermore, exposing the film to atmosphere overnight resulted in a sticky polymer that no longer maintained mechanical integrity. This suggests that the polymer absorbed a significant amount of water from the atmosphere, which plasticized it and lowered the T_{g}. Water adsorption studies revealed a large affinity for water uptake, outlined in (Figure S3). Additionally, this ionene as well as all the others synthesized, displayed complete water solubility in an excess of DI water, which indicates atmospheric water uptake. Table 5.2 summarizes the compositions and thermal properties of resultant BBCI ionenes.

TABLE 5.2
Summary of BBCI ionene compositions and resultant thermal properties.

| | Targeted | | | | |
|---|---|---|---|---|---|
| | HS content | PEG | BBCI | DBD | T_{g}^{a} |
| | (wt. %) | mol. % | mol. % | mol % | (° C.) |
| PEG₄₀₀ | 0 | 50 | 50 | 0 | −25 |
| | 30 | 23 | 50 | 27 | −21 |
| PEG₂ₖ | 0 | 50 | 50 | 0 | n/a |
| | 30 | 18 | 50 | 32 | n/a |
| DBD | 100 | 0 | 50 | 50 | 4 |

### Conclusions

A BCI monomer, BBCI, provided a pathway for the efficient synthesis of divalent imidazolium ILs and ionene derivatives. In-situ FTIR spectroscopy revealed minal reactivity of the small molecule BBCI IL to nucleophilic attack, displaying the favorable effect of imidazolium formation on the reactivity of BBCI. Furthermore, TGA suggested increased thermal stability afforded by the deactivation of reactive imidazolide nitrogens. DRS of BBCI IL displayed relatively low conductivity at a wide frequency range, postulated to result from the high molecular weight of the compound and halide counterion. Future work including IL doping and counterion modulation can serve to remediate this issue. Reactivity of BBCI was further probed by the formation of BBCI-derived ionenes containing PEG SSs and 1,12-dibromododecane HSs that displayed additional control over T_{g}. However, the substantial water uptake of BBCI-derived ILs resulted in plasticization and potential degradation of the PEG containing ionenes, limiting the probing of mechanical properties.

### References Cited in this Example

1 Wilkes, J. S., A short history of ionic liquids-from molten salts to neoteric solvents. Green Chemistry 2002, 4 (2), 73-80.
2. Chen, M.; White, B. T.; Kasprzak, C. R.; Long, T. E., Advances in phosphonium-based ionic liquids and poly(ionic liquid) s as conductive materials. European Polymer Journal 2018, 108, 28-37.
3. Kunz, W.; Häckl, K., The hype with ionic liquids as solvents. Chemical Physics Letters 2016, 661, 6-12.
4. Noorhisham, N. A.; Amri, D.; Mohamed, A. H.; Yahaya, N.; Ahmad, N. M.; Mohamad, S.; Kamaruzaman, S.; Osman, H., Characterisation techniques for analysis of imidazolium-based ionic liquids and application in polymer preparation: A review. Journal of Molecular Liquids 2021, 326, 115340.
5. Green, M. D.; Long, T. E., Designing Imidazole-Based Ionic Liquids and Ionic Liquid Monomers for Emerging Technologies. Polymer Reviews 2009, 49 (4), 291-314.
6 Earle, M. J.; Seddon, K. R., Ionic liquids. Green solvents for the future. Pure and Applied Chemistry 2000, 72 (7), 1391-1398.
7. Chiappe, C.; Pomelli, C. S., Point-Functionalization of Ionic Liquids: An Overview of Synthesis and Applications. European Journal of Organic Chemistry 2014, 2014 (28), 6120-6139.
8. Fraser, K. J.; MacFarlane, D. R., Phosphonium-Based Ionic Liquids: An Overview. Australian Journal of Chemistry 2009, 62 (4), 309-321.
9 Ueno, K.; Tokuda, H.; Watanabe, M., Ionicity in ionic liquids: correlation with ionic structure and physicochemical properties. Physical Chemistry Chemical Physics 2010, 12 (8), 1649-1658.
10. Fonseca, G. S.; Umpierre, A. P.; Fichtner, P. F. P.; Teixeira, S. R.; Dupont, J., The Use of Imidazolium Ionic Liquids for the Formation and Stabilization of Ir0 and Rh0 Nanoparticles: Efficient Catalysts for the Hydrogenation of Arenes. Chemistry-A European Journal 2003, 9 (14), 3263-3269.
11. Migowski, P.; Dupont, J., Catalytic Applications of Metal Nanoparticles in Imidazolium Ionic Liquids. Chemistry-A European Journal 2007, 13 (1), 32-39.
12. Baranyai, K. J.; Deacon, G. B.; MacFarlane, D. R.; Pringle, J. M.; Scott, J. L., Thermal Degradation of Ionic Liquids at Elevated Temperatures. Australian Journal of Chemistry 2004, 57 (2), 145-147.
13. Bakis, E.; van den Bruinhorst, A.; Pison, L.; Palazzo, I.; Chang, T.; Kjellberg, M.; Weber, C. C.; Costa Gomes, M.; Welton, T., Mixing divalent ionic liquids: effects of charge and side-chains. Physical Chemistry Chemical Physics 2021, 23 (8), 4624-4635.
14. Avila, J.; Lepre, L. F.; Goloviznina, K.; Guazzelli, L.; Pomelli, C. S.; Chiappe, C.; Pádua, A.; Costa Gomes, M., Improved carbon dioxide absorption in double-charged ionic liquids. Physical Chemistry Chemical Physics 2021, 23 (40), 23130-23140.
15. Wolfgang, J. D.; White, B. T.; Long, T. E., Non-isocyanate Polyurethanes from 1,1′-Carbonyldiimidazole: A Polycondensation Approach. Macromolecular Rapid Communications 2021, 42 (13), 2100163.
16. Sintas, J. I.; Wolfgang, J. D.; Long, T. E., Carbamate thermal decarboxylation for the design of non-isocyanate polyurethane foams. Polymer Chemistry 2023.
17. Olsson, J. V.; Hult, D.; García-Gallego, S.; Malkoch, M., Fluoride-promoted carbonylation polymerization: a facile step-growth technique to polycarbonates. Chemical Science 2017, 8 (7), 4853-4857.
18. Houlihan, F. M.; Bouchard, F.; Frechet, J. M. J.; Willson, C. G., Thermally depolymerizable polycarbonates. 2. Synthesis of novel linear tertiary copolycarbonates by phase-transfer catalysis. Macromolecules 1986, 19 (1), 13-19.
19. Wolfgang, J. D.; White, B. T.; Long, T. E., Non-Isocyanate Polyurethanes from 1,1′-Carbonyldiimidazole: An Activated Carbamate Approach. Submitted for Publication 2021.
20. Schönhals, A.; Kremer, F., Analysis of Dielectric Spectra. In Broadband Dielectric Spectroscopy, Kremer, F.; Schönhals, A., Eds. Springer Berlin Heidelberg: Berlin, Heidelberg, 2003; pp 59-98.
21. Sintas, J. I.; Wolfgang, J. D.; Long, T. E., Carbamate thermal decarboxylation for the design of non-isocyanate polyurethane foams. Polymer Chemistry 2023, 14 (13), 1497-1506.
22. Introduction to Vibrational Spectroscopy. In Fourier Transform Infrared Spectrometry, 2007; pp 1-18.
23. Delebecq, E.; Pascault, J.-P.; Boutevin, B.; Ganachaud, F., On the Versatility of Urethane/Urea Bonds: Reversibility, Blocked Isocyanate, and Non-isocyanate Polyurethane. Chemical Reviews 2013, 113 (1), 80-118.
24. Cao, Y.; Mu, T., Comprehensive Investigation on the Thermal Stability of 66 Ionic Liquids by Thermogravimetric Analysis. Industrial & Engineering Chemistry Research 2014, 53 (20), 8651-8664.
25. Haddad, B.; Kiefer, J.; Brahim, H.; Belarbi, E.-h.; Villemin, D.; Bresson, S.; Abbas, O.; Rahmouni, M.; Paolone, A.; Palumbo, O., Effects of C(2) Methylation on Thermal Behavior and Interionic Interactions in Imidazolium-Based Ionic Liquids with Highly Symmetric Anions. Applied Sciences 2018, 8 (7), 1043.
26. Tokuda, H.; Ishii, K.; Susan, M. A. B. H.; Tsuzuki, S.; Hayamizu, K.; Watanabe, M., Physicochemical Properties and Structures of Room-Temperature Ionic Liquids. 3. Variation of Cationic Structures. The Journal of Physical Chemistry B 2006, 110 (6), 2833-2839.
27. Pitawala, J.; Matic, A.; Martinelli, A.; Jacobsson, P.; Koch, V.; Croce, F., Thermal Properties and Ionic Conductivity of Imidazolium Bis(trifluoromethanesulfonyl)imide Dicationic Ionic Liquids. The Journal of Physical Chemistry B 2009, 113 (31), 10607-10610.
28. Ikeda, M.; Aniya, M., Understanding the Vogel-Fulcher-Tammann law in terms of the bond strength-coordination number fluctuation model. Journal of Non-Crystalline Solids 2013, 371-372, 53-57.
29. Moosavi, M.; Khashei, F.; Sharifi, A.; Mirzaci, M., Transport Properties of Short Alkyl Chain Length Dicationic Ionic Liquids-The Effects of Alkyl Chain Length and Temperature. Industrial & Engineering Chemistry Research 2016, 55 (33), 9087-9099.
30. Huang, M.-M.; Jiang, Y.; Sasisanker, P.; Driver, G. W.; Weingärtner, H., Static Relative Dielectric Permittivities of Ionic Liquids at 25° C. Journal of Chemical & Engineering Data 2011, 56 (4), 1494-1499.
31. Lee, M.; Choi, U. H.; Salas-de 1a Cruz, D.; Mittal, A.; Winey, K. I.; Colby, R. H.; Gibson, H. W., Imidazolium polyesters: structure-property relationships in thermal behavior, ionic conductivity, and morphology. Advanced Functional Materials 2011, 21 (4), 708-717.

### Example 8

### Michael Acceptors as Reactive Fillers in Bis-Carbonylimidazolide-Derived Non-Isocyanate Polyurethane Foams

Investigations pertaining to bis-carbonylimidazolide (BCI) monomers described a facile approach for the synthesis of non-isocyanate polyurethane (NIPU) foams with tunable thermomechanical properties. While effective at producing NIPU foams, processing difficulties arose from high melting point monomers and the need for an additional post-processing step to remove the imidazole condensate from the foam matrix. This work describes the synthesis of a new BCI monomer that displays a melting point of −17° C., allowing for a decrease in NIPU foam reaction temperatures. Additionally, the incorporation of an acrylate- or maleimide-functionalized filler enabled efficient imidazole sequestration through a Michael addition pathway. In-situ FTIR spectroscopy validated Michael addition kinetics in a model system comprised of imidazole and butanediol diacrylate compounds, demonstrating increased kinetics at elevated temperatures. Thermogravimetric analysis confirmed imidazole sequestration within the BCI foam for both the acrylate and maleimide system. Further comparison between control BCI foams showcased an increase in thermal stability after the incorporation of the reactive filler, demonstrating the synergistic properties Michael acceptor additives have on BCI foams and further validating their use as a replacement for isocyanate-based polyurethane foam pathways.

### INTRODUCTION

Polyurethane (PU) foams stand out as a high-volume product accounting for approximately 67% of global PU consumption.¹ They provide a premier solution for cushioning, construction, light weighting and transportation applications due to their tunable porous structure and modular thermomechanical properties.¹⁻⁸ The facile, high-yielding reaction between an isocyanate and alcohol enables reliable PU foam synthesis at industrial scales, while efficient water-mediated decarboxylation chemistry results in a porous structure of controlled size and shape.^{9, 10} PU foams derive their tunability from not only the diverse isocyanate and polyol chemistry available, but also from pore size and shape.^{11, 12} Thus, extensive research has been conducted to understand and control these structure-property-processing relationships.¹³⁻¹⁶ While isocyanate and polyol chemistry control phase separation and the resulting thermomechanical properties, pore geometry serves as a mechanism to instill physical damping or insulative properties. Thus, a variety of PU foams exist ranging from flexible, open-cell structures for cushioning to high T_{g}, closed-cell structures for light-weight structural or insulative applications.¹⁷ Likewise, the ratio of isocyanate to alcohol groups, as well as the chemical structure (aliphatic vs. aromatic) greatly contribute to foam hardness and density. Namely, 4,4′-diphenylmethane diisocyanate (MDI) and toluene diisocyanate (TDI) comprise the majority of isocyanate selection for foams where MDI produces foams with increased hardness and density compared to TDI-derived foams.¹⁸

In addition to PU chemistry considerations, additives, or fillers, offer an additional route towards achieving outstanding, tailored properties. Modern PU foams are heavily formulated to meet safety standards or property requirements for a given application. Specifically, foams often contain added surfactants, amine and tin catalysts, flame retardants, colorants, plasticizers, and inorganic fillers among other specialized additives.^{17, 19-21} Further formulation requirements for certain applications require the additional insertion of bacteriostats for antibacterial properties, antistatic agents, UV stabilizers, compatibilizers, or auxiliary blowing agents.²²⁻²⁴ Thus, the wide-spread use of fillers for PU foams highlights the importance of additives for achieving optimal properties.

While conventional isocyanate and polyol chemistry proves an effective pathway for PU foam production, the inherent toxicity of isocyanate precursors prompted the search for safer, more sustainable synthetic pathways that achieve similar thermomechanical performance.²⁵ Therefore, a wide library of research pertaining to isocyanate-free pathways for PU synthesis exists. Namely, the development of non-isocyanate polyurethanes (NIPUs) resulted in several innovative synthetic pathways for the production of PU materials, while circumventing toxic isocyanates. ²⁶⁻²⁹ One such method is the ring opening of cyclic carbonates with amines producing poly(hydroxyurethane) s without the use of isocyanates.³⁰⁻³² This system proves effective at producing NIPU foam architectures, however suffers from pendant hydroxyl groups that result from the ring opening which cause increased water uptake and impedes phase separation. ³³⁻³⁵ A new synthetic approach leveraging bis-carbonylimidazolide (BCI) monomers demonstrates a more promising route towards the production of NIPU foams that omits pendant hydroxyl groups.^{36, 37} FIG. 6.1 describes the synthesis of BCI monomers and subsequent polymerization to provide a NIPU structure. Previous investigations revealed that BCI monomers produced foams with diverse thermomechanical properties when utilizing a basic catalyst and amine monomers with functionality >3. Likewise, careful surfactant loading successfully controlled pore architecture.

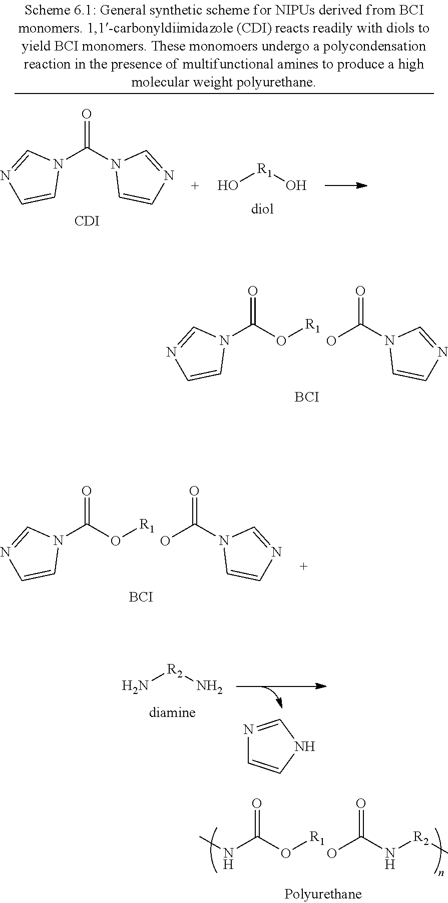

While previous literature displayed the successful formation of NIPU foams from a BCI approach, considerations regarding the imidazole byproduct were limited to solvent extractions.³⁸ The desire to reduce the number of post-processing steps prompted the exploration of a reactive filler capable of not only sequestration of the imidazole byproduct, but also the retention or enhancement of thermomechanical properties. Additionally, the successful capture of imidazole is necessary for facile adaptation of BCI chemistry to legacy foam processing techniques, i.e., molded PU foams. The nucleophilic reactivity of imidazole allowed the exploration of several Michael acceptor systems comprised of acrylate and maleimide functionalities. A Michael reaction system was chosen due to a wide temperature window for reactivity and facile incorporation into the existing BCI ecosystem.³⁹ In-situ FTIR and thermogravimetric analysis confirmed the reactivity of both chemistries for imidazole sequestration, which proved fortuitous as this allowed for implementation into rigid and flexible NIPU foams. Previously published BCI foam formulations served as a control to evaluate the sequestration of imidazole byproduct through mass-loss measurements. This manuscript outlines the direct incorporation of reactive Michael acceptors to existing BCI foam formulations and the subsequent capture of the produced imidazole in the absence of a post-processing step.

### Experimental and Methods

### Instruments

¹H and ¹³C nuclear magnetic resonance (NMR) spectroscopy utilized a Bruker Avance NEO 500 MHz spectrometer functioning at 500.15 MHz and 23° C. (solution concentration of 10 mg mL⁻¹). A ThermoFisher Scientific Nicolet iS5 FTIR spectrometer iD7 ATR, with a diamond cell, confirmed PU foam structure after 32 scans. A ReactIR in-situ FTIR spectrometer enabled real-time probing of Michael addition kinetics with a 2 min resolution at 64 scans per data spectrum. A TA Instruments Discovery Series TGA 5500 facilitated thermogravimetric analysis (TGA) by utilizing a heating rate of 10° C. min⁻¹ from 25-800° C. with a steady nitrogen purge. The T_{d,5%}, or temperature where 5% of the original sample mass is lost, stands as an indicator for sample thermal stability or imidazole volatilization. Stepwise isothermal TGA followed by ramping from 25-800° C. at 10° C. min⁻¹ until the weight change was >0.1% min⁻¹, and the TGA would isotherm until the weight change was <0.05% min⁻¹ allowing for accurate weight loss measurements due to imidazole. A TA Instruments Discovery Series DSC 2500 with heat/cool/heat cycles of 10° C. min^{-1, 10}° C. min⁻¹, and 10° C. min⁻¹, respectively, provided differential scanning calorimetry (DSC) data where the sample was under a nitrogen environment throughout the experiment. DSC provided the glass transition temperatures and monomer melting points from the midpoint of the endothermic transition in the 2nd heat. A TA Instruments Discovery SA (sorption analyzer) enabled water uptake measurements of foams throughout a wide range of humidity. A JEOL JSM IT500HR or JEOL 6300 scanning electron microscope coupled with a Cressington sputter coater 208 HR using an Au/Pd conductive layer provided micrographs of PU foams. The 30 nm Au/Pd layer allowed for high-resolution images at 10×, 25×, 100×, and 500× magnification, and the secondary electron detector maintained 15.0 kV for all images. A Gas Lab CM-0177, S8 CO₂ sensor kit enabled the detection of CO₂ released from the foaming reaction.

### Materials

1,4-butanediol (>99.0%), 1,1′-carbonyldiimidazole (CDI) (>97.0%), 4,8-bis(hydroxymethyl)tricyclo[5.2.1.0^{2,6}]decane (TCD) (96%), 1,4-butanediol diacrylate (BDDA) (technical grade), Dabco® 33LV, and dibutyltin dilaurate (95%) were purchased from Sigma Aldrich. 4,4′-dihidroxydiphenylmethane (BPF) (>99.0%), was purchased from TCI and used as received. 4-(4-aminophenoxy)benzene-1,3-diamine, or triaminodiphenylether, (TADE) (97%) was provided by SABIC and stored in a desiccator under reduced pressure. Jeffamine® T-403 polyetheramine was provided by Huntsman and had a number-average molecular weight of 440 g mol⁻¹. The Jeffamine® was dried at 60° C. under reduced pressure prior to use. Dabco® DC193 and 1,2-bis(2-aminophenylthio) ethane bismaleimide (APO-BMI) were provided by Honeywell NSC and used as received. Ethyl acetate (>99.5%, ACS grade), acetone (99.6% ACS reagent), and methanol (>99.8%, ACS grade) were purchased from Fisher Scientific and used as received. Nitrogen gas (99.999% UHP-T) was purchased from Praxair Distribution. Deuterated chloroform (CDCl₃) was purchased from Cambridge Isotope Laboratories, Inc.

### Synthesis of 1,4-butyl(bis-carbonylimidazolide) (BBCI) and 4,8-Bis(hydroxymethyl)tricyclo[5.2.1.0^{2,6}]decane (biscarbonylimidazolide) (TCDBCI)

The synthetic procedure for these monomers followed from our previous literature, with only slight modifications for TCDBCI.³⁶ 1,4-butanediol (27.04 g, 0.3 mol) was added to a three-necked, 1 L round-bottomed flask outfitted with a magnetic stir bar, nitrogen inlet, nitrogen outlet, and rubber septa. The butanediol was dissolved in ethyl acetate (600 mL) at 25° C. for 10 min under a nitrogen purge. 1,1′-Carbonyldiimidazole (CDI) (121.61 g, 0.7 mol) was added to the flask in partitions to allow for even mixing and to reduce the propensity for cyclization. The reaction was allowed to proceed for ˜2 h prior to filtration using a fritted funnel. The white powder was washed twice with ethyl acetate to remove byproducts (500 mL total) and dried at 60° C. and ˜1 in-Hg for 18 h. The final isolated yield was >90% with a melting point range of 138-140° C. ¹H NMR (CDCl₃, δ, Figure S1) 8.13-8.14 (t, 2H, 3), 7.41-7.42 (t, 2H, 2), 7.07-7.08 (m, 2H, 1), 4.47-4.51 (t, 4H, 5) 1.95-2.00 (m, 4H, 6). The synthesis for TCDBCI followed the same procedure as above, however the product was precipitated in water then centrifuged. The collected product was dried at 80° C. overnight under reduced pressure. A mixture of cis and trans isomers presents multiple peaks in NMR that split over a wide range in the aliphatic proton region. However, clear splitting of imidazole-bound protons that integrate favorably with aliphatic protons suggests complete conversion and sufficient purity.

### Synthesis of Non-Isocyanate Polyurethane Foams

BBCI and TCDBCI were used to synthesize PU foams with varied T_{g}s by incorporating either aromatic or flexible aliphatic amine monomers. BBCI (5.00 g, 18.0 mmol) was added to a 50 mL single-neck round bottomed flask with a stir bar and a twin connecting hose joint to allow for nitrogen flow over the flask. The flask was purged with nitrogen for 5-10 min before lowering the flask into an oil bath at 160° C. to melt the monomer. Once the BBCI was in the melt (<5 min), the T-403 (5.17 g, 11.7 mmol) was quickly added to the reaction with a syringe. The reaction proceeded for 1-2 min before curing. The foam was extracted with 250 mL of methanol for 18 h to extract the imidazole byproduct. The foams were then placed in an oven at 80° C. for 16 h before applying reduced pressure for an additional 18 h.

An aromatic triamine was utilized to further increase the T_{g} of the PU foams. Following the same procedure, BBCI (1.88 g, 6.7 mmol) and TADE (0.95 g, 4.4 mmol) were added to a 50 mL single-neck round bottomed flask with a stir bar and a twin connecting hose joint to allow for nitrogen flow over the flask. The flask was purged with nitrogen for 5-10 min before lowering the flask into an oil bath at 160° C. to melt the monomers. Once the reagents were in the melt, the reaction cured in <3 min. This process was repeated for the T-403-containing foams where T-403 was added in molar ratios of 100:0, 90:10, 80:20, 70:30, and 60:40 mol:mol, TADE:T-403. A low concentration, 0.8 wt. %, of Dabco® DC193 was added to select PU foams to elucidate the effect on cell structure and overall homogeneity. The surfactant was added with the BCI monomer prior to the addition of the amines and surfactant-containing foams were not used for thermal characterization. Foams synthesized with TCDBCI were conducted in a similar manner, although reaction temperatures were lowered to 120° C. to account for the lower melting point of the monomer.

### Synthesis of Foams Containing Michael Acceptor Additives

Formulations of NIPU foams that implement imidazole capture chemistries followed similar procedures as previously stated. The addition of acrylate or maleimide chemical groups enabled the rapid and efficient capture of the imidazole byproduct, while reaching sufficient urethane conversion to form a thermoset network. The Michael acceptor compound, either BDDA or APO-BMI) was added to the BCI component of the foam mixture at a 1:1 molar ratio of functional groups, as premature introduction to the amine component results unwanted azo-Michael additions that reduce amine functionality.

### Results and Discussion

Previous research efforts detailed the synthesis of non-isocyanate polyurethanes from biscarbonyl imidazolide (BCI) monomers. These efforts demonstrated the efficacy of thermomechanical property control over synthesized NIPUs through the modulation of rigid and flexible BCI monomer selection. Rigid BCI and amine monomers produced high T_{g} foams imparted with high compressive moduli. These monomers included TADE, an aromatic triamine, and a BCI monomer derived from butanediol, butane bis-carbonylimidazolide (BBCI). While the resulting foams demonstrated favorable thermomechanical properties,

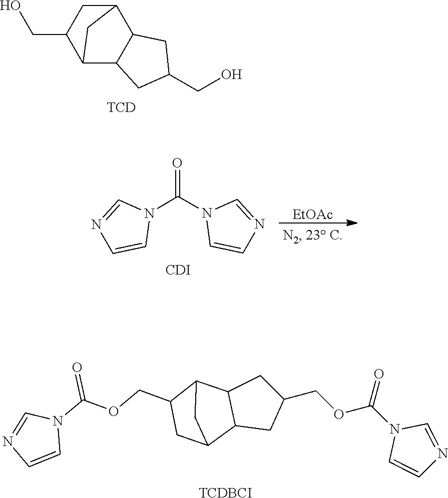

elevated processing temperatures of 180-230° C. prevented a practical implementation of these monomers in common foam molding applications. Due to these issues, low melting monomers capable of high-performance foams was still of interest. A commercial diol, bis(hydroxymethyl)tricyclo[5.2.1.0^{2,6}]decane (TCD), was chosen for investigation. TCD contains bulky substituents, which commonly result in decreased backbone mobility when incorporated into a polymer; this in turn raises T_{g} and provided an avenue to increased compressive modulus. Likewise, the mixture of isomers present in TCD results in a depression of melting point when not polymerized. Thus, the bulkiness of the BCI monomer decreased packing efficiency in the small molecule state, lowering the melting point of the monomer. To that end, a new BCI monomer was synthesized and evaluated for use in the BCI NIPU foam procedure, displayed in Scheme 6.2.

Scheme 6.2. Synthesis of a new BCI monomer for rigid foam applications. Bulky substituents enable T_{g} elevation of the final foam and melting point depression of the starting monomers.

Melting point evaluations for TCDBCI resulted in the selection of TCDBCI as a successful candidate for low temperature rigid foam synthesis. The low melting temperature of TCDBCI (−17° C.) enabled processing windows below 100° C. for rigid foam production while BBCI displayed melting temperatures of 140° C. Scheme 6.3 summarizes DSC thermal performance data after reaction with either a flexible, etheric triamine (T-403), a rigid, aromatic triamine (TADE), or a mixture thereof. As predicted, an increase in the concentration of the rigid aromatic triamine resulted in an increase in T_{g}. Likewise, imidazole condensate and any unreacted species that remained incorporated into the foam matrix led to a severe depression of T_{g}, noted by the increase in T_{g} the extraction process provides. The extraction process provided additional benefit to removal of the foam from the mold. Poor structural integrity or strong adhesion to the foam mold of some unextracted samples prohibited T_{g} measurements, denoted NA in Scheme 6.3. An additional effect resulting from the incorporation of a rigid aromatic triamine is increased reaction times. The decreased reactivity aromatic amines possess compared to aliphatic ones (aliphatic amines possess approximately 1000× more reactivity than their aromatic counterparts) explains this phenomenon. This proved beneficial for injection molding applications where working times dictate effective mold filling.

| Incorporation | | | |
|---|---|---|---|
| T-403:TADE | Pre-extraction | Post-extraction | Reaction time |
| (mol) | Tg (° C.) | Tg (° C.) | (min) |
| 100:0 | NA | 21 | 13 |
| 75:25 | 2 | 13 | 18 |
| 50:50 | −7 | 43 | 22 |
| 25:75 | 16 | NA | 24 |
| 0:100 | NA | 94 | 40 |

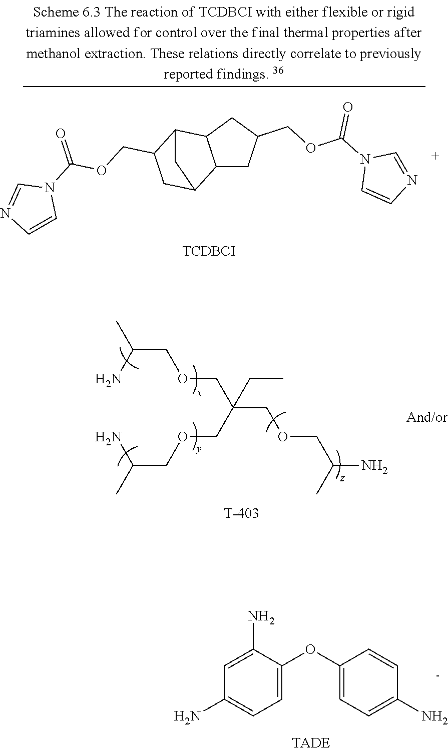

While solvent extraction of high performance NIPU foams resulted removal of the imidazole condensate and adequate thermomechanical properties, a facile processing procedure that circumvented this additional step remained desired. Likewise, additional fine tuning of thermomechanical properties with additives was unexplored, thus prompting investigations of a reactive filler capable of sequestering imidazole. The imidazole nitrogen provided a reactive handle for subsequent addition to an electrophile. While there exists a wide library of electrophilic moieties capable of reaction with a nucleophile, considerations regarding foam production temperatures, miscibility, and reactivity limited selection to a Michael reaction system. Compounds containing this reactivity are diverse and can be tuned for different chemistries including acrylate, maleimide, and vinyl sulfones. Likewise, the reaction is efficient, which provides high conversions. Scheme 6.4 displays a generalized reaction scheme between a nucleophile and a Michael acceptor, which reacts to high conversions to sequester the nucleophile. Tuning the chemistry of the acceptor allowed for incorporation of this filler into flexible and rigid foam systems after reacting with imidazole.

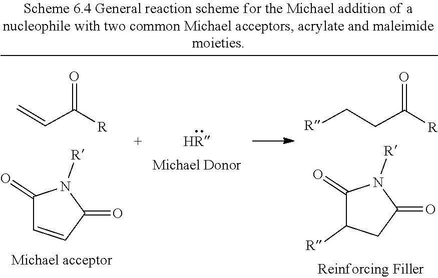

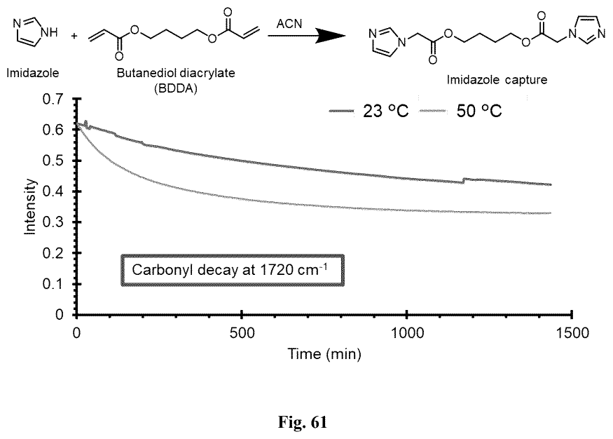

In-situ FTIR spectroscopy allowed probing of reaction kinetics at various temperatures for a model reaction between imidazole and a difunctional Michael acceptor, BDDA, displayed in FIG. 61. Although Michael addition products undergo a reverse reaction under sufficient temperatures, elevated temperatures resulted in an increase in reaction kinetics for product formation. This proved fortuitous, since the elevated temperatures for NIPU foam synthesis served to ensure fast sequestration of imidazole. The reaction kinetics derived form in-situ experiments required solvation of both reagents, which produces a decreased concentration of reactive groups. It is expected that melt-phase reactions involving imidazole and acrylates result in faster reaction rates on the order of foam curing rates.

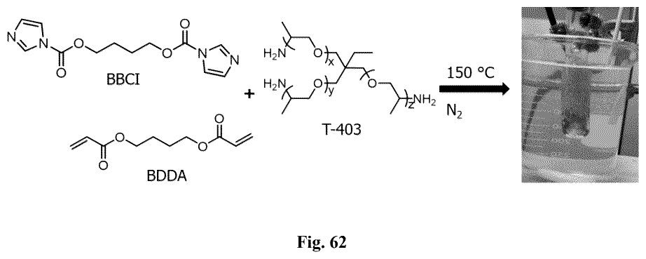

After In-situ FTIR spectroscopy confirmed the reactivity between imidazole and a Michael acceptor, BDDA was implemented into a conventional NIPU synthetic pathway involving BBCI and T-403. A 1:1 molar ratio of all reactive groups ensured sufficient reactivity to achieve a crosslinked foam and sequestration of any imidazole byproduct produced, shown in FIG. 62. Unlike previous BBCI-T-403 NIPU foams, this product displayed increased coloration, presumably due to the acrylate additive. However, the NIPU foam containing the additive maintained flexibility expected from an open-cell architecture. This maintained flexibility was attributed to the flexible nature of BDDA, a linear aliphatic additive. It is important to highlight, however that a large mass loading of BDDA was needed to ensure full sequestration of all produced imidazole. This can be offset by incorporating a Michael acceptor with increased functionality, such as a tri- or tetra-functional acrylate system that maintains a molar equivalent of reactive groups to the BCI monomer.

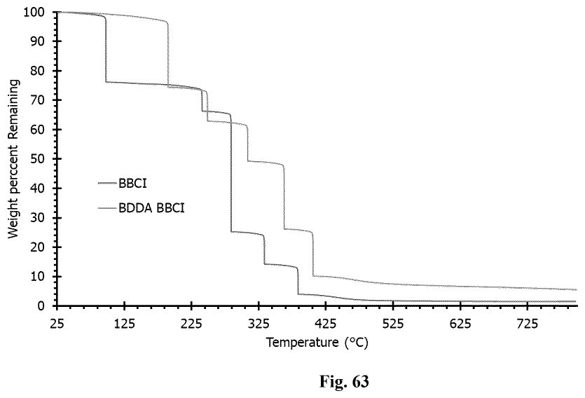

Thermogravimetric analysis provided an efficient method for monitoring residual imidazole content in a crosslinked BCI foam. A step-wise isothermal experiment, where the sample remained at a constant temperature until weight loss ceased, revealed residual imidazole content in control BBCI-T-403 and BBCI-T-403-BDDA NIPU foams. Imidazole contains a melting point of approximately 90° C. and displays and elevated vapor pressure resulting in measurable sample mass loss at this temperature. The step-wise isotherm experiment subsequently halted temperature ramping until all free imidazole in the foam sample evaporated. FIG. 63 highlights this phenomenon, as the control foam displays clear mass loss at 90° C. due to the thermal removal of imidazole trapped in the NIPU foam matrix. Conversely, the NIPU foam containing the BDDA additive displayed an absence of mass loss at those temperatures, instead displaying mass loss at 205° C. This was presumably due to a retro-Michael addition resulting in the release of imidazole and subsequent removal through evaporation.

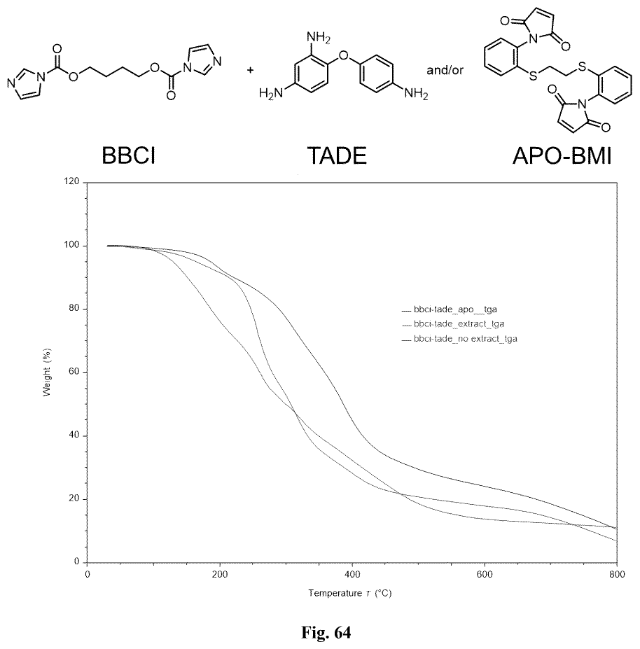

Additional Michael acceptor chemistries and foam compositions allowed the investigation of this reactive additive system as a holistic solution for rigid and flexible BCI foam production. The maleimide functional group boasts impressive thermal stability while maintaining similar electrophilic reactivity as acrylates.^{40, 41} A NIPU foam formulation that leveraged monomers with restricted mobility consisting of TADE and BBCI resulted in the synthesis of a rigid BCI foam for evaluation. Subsequent incorporation of a disulfide-derived bismaleimide (APO-BMI) allowed for the retention of a high T_{g} while probing imidazole sequestration. TGA enabled a comparison between a control BBCI-TADE and BBCI-TADE-APO-BMI foam to evaluate imidazole content as a function of chemical formulation and processing, shown in FIG. 64. Specifically, both the neat and extracted foams were compared to rigid foam composition that contained the APO-BMI additive. As expected, the unextracted control foam displayed an earlier onset mass loss due to the evaporation of imidazole. Conversely, the NIPU foam formulation containing the APO-BMI additive displayed an increased resistance to weight loss due to the sequestration of imidazole by the reactive additive. It is interesting to note, however, that the extracted control foam displayed mass loss at lower temperatures compared the APO-BMI infused foam, presumably due to the increased thermal stability of the maleimide-imidazole sequestration product. This proved fortuitous, as not only did APO-BMI effectively trap the imidazole condensate, but it boosted thermal performance as well, providing an improvement for this rigid NIPU foam system.

### Conclusions

The facile synthesis of a series of new BCI monomers derived from cyclic diols produced a series of NIPU foams with T_{g}s approaching 100° C. The bulky nature of TCDBCI resulted in a low melting point monomer that enabled foam reaction temperatures of 120° C., which is approximately 40° C. lower than previously reported. This innovation allowed successful foam production at moderate temperatures, however required additional post-processing to remove the imidazole condensate that resulted from the amine addition to BCI monomers. Thus, several Michael acceptor compounds were evaluated for their ability to capture the imidazole condensate that results from the formation of NIPU foams when utilizing BCI monomers. In-situ FTIR spectroscopy validated the aza-Michael addition of imidazole to an acrylate Michael acceptor and displayed increased reaction kinetics as a function of temperature. Incorporation of this reactive additive into flexible BCI foam formulations achieved imidazole sequestration, validated by step-wise TGA experiments, while maintaining expected T_{g} values. Furthermore, APO-BMI, a rigid reactive filler, enabled complete imidazole sequestration in a rigid foam system that displayed additional resistance to mass loss at elevated temperatures. The efficient imidazole sequestration shown in this work further validates the feasibility of BCI chemistry to replace isocyanates for PU foam production while providing an additional handle to tune the thermomechanical properties of the resulting foam.

### References Cited in this Example

1. Gama, N. V.; Ferreira, A.; Barros-Timmons, A., Polyurethane Foams: Past, Present, and Future. Materials 2018, 11 (10), 1841.
2. Somarathna, H. M. C. C.; Raman, S. N.; Mohotti, D.; Mutalib, A. A.; Badri, K. H., The use of polyurethane for structural and infrastructural engineering applications: A state-of-the-art review. Construction and Building Materials 2018, 190, 995-1014
3. Singhal, P.; Small, W.; Cosgriff-Hernandez, E.; Maitland, D. J.; Wilson, T. S., Low density biodegradable shape memory polyurethane foams for embolic biomedical applications. Acta Biomaterialia 2014, 10 (1), 67-76.
4. Jin, F.-L.; Zhao, M.; Park, M.; Park, S.-J., Recent Trends of Foaming in Polymer Processing: A Review. Polymers 2019, 11 (6), 953.
5. Wu, J.-W.; Sung, W.-F.; Chu, H.-S., Thermal conductivity of polyurethane foams. International Journal of Heat and Mass Transfer 1999, 42 (12), 2211-2217.
6. Zhang, H.; Fang, W.-Z.; Li, Y.-M.; Tao, W.-Q., Experimental study of the thermal conductivity of polyurethane foams. Applied Thermal Engineering 2017, 115, 528-538.
7. Casati, F. M.; Herrington, R. M.; Broos, R.; Miyazaki, Y., Tailoring the Performance of Molded Flexible Polyurethane Foams for Car Seats. Journal of Cellular Plastics 1998, 34 (5), 430-466.
8. Khan, T.; Acar, V.; Aydin, M. R.; Hülagü, B.; Akbulut, H.; Seydibeyoğlu, M. Ö., A review on recent advances in sandwich structures based on polyurethane foam cores. Polymer Composites 2020, 41 (6), 2355-2400.
9. Delebecq, E.; Pascault, J.-P.; Boutevin, B.; Ganachaud, F., On the Versatility of Urethane/Urea Bonds: Reversibility, Blocked Isocyanate, and Non-isocyanate Polyurethane. Chemical Reviews 2013, 113 (1), 80-118.
10. Yilgör, I.; Yilgör, E.; Wilkes, G. L., Critical parameters in designing segmented polyurethanes and their effect on morphology and properties: A comprehensive review. Polymer 2015, 58, A1-A36.
11. Smits, G. F., Effect of Cellsize Reduction on Polyurethane Foam Physical Properties. Journal of Thermal Insulation and Building Envelopes 1994, 17 (4), 309-329.
12. Janik, H.; Marzec, M., A review: Fabrication of porous polyurethane scaffolds. Materials Science and Engineering: C 2015, 48, 586-591.
13. Blackwell, J.; Nagarajan, M. R.; Hoitink, T. B., Structure of polyurethane elastomers: effect of chain extender length on the structure of MDI/diol hard segments. Polymer 1982, 23 (7), 950-956.
14. Kwei, T. K., Phase separation in segmented polyurethanes. Journal of Applied Polymer Science 1982, 27 (8), 2891-2899.
15. Chu, B.; Gao, T.; Li, Y.; Wang, J.; Desper, C. R.; Byrne, C. A., Microphase separation kinetics in segmented polyurethanes: effects of soft segment length and structure. Macromolecules 1992, 25 (21), 5724-5729.
16. Marciano, J. H.; Rojas, A. J.; Williams, R. J. J., Curing kinetics of a rigid polyurethane foam formulation. Polymer 1982, 23 (10), 1489-1492.
17. Hansen, R., Handbook of polymeric foams and foam technology, Daniel Klempner and Kurt C. Frisch, eds., Hanser Publishers, Munich, Germany, 1992, 442 pp. price: $148.00. (Distributed in the U.S. and Canada by Oxford University Press, New York.). Journal of Polymer Science Part A: Polymer Chemistry 1993, 31 (5), 1344-1344.
18. Javni, I.; Zhang, W.; Petrović, Z. S., Effect of different isocyanates on the properties of soy-based polyurethanes. Journal of Applied Polymer Science 2003, 88 (13), 2912-2916.
19. Lefebvre, J.; Bastin, B.; Le Bras, M.; Duquesne, S.; Paleja, R.; Delobel, R., Thermal stability and fire properties of conventional flexible polyurethane foam formulations. Polymer Degradation and Stability 2005, 88 (1), 28-34.
20. Thirumal, M.; Singha, N. K.; Khastgir, D.; Manjunath, B. S.; Naik, Y. P., Halogen-free flame-retardant rigid polyurethane foams: Effect of alumina trihydrate and triphenylphosphate on the properties of polyurethane foams. Journal of Applied Polymer Science 2010, 116 (4), 2260-2268.
21. Coste, G.; Negrell, C.; Caillol, S., From gas release to foam synthesis, the second breath of blowing agents. European Polymer Journal 2020, 140, 110029.
22. Sienkiewicz, N., Improvements of Polyurethane (PU) Foam's Antibacterial Properties and Bio-resistance. In Thermal Insulation and Radiation Control Technologies for Buildings, Kośny, J.; Yarbrough, D. W., Eds. Springer International Publishing: Cham, 2022; pp 217-240.
23. Oliviero, M.; Stanzione, M.; D′Auria, M.; Sorrentino, L.; Iannace, S.; Verdolotti, L., Vegetable Tannin as a Sustainable UV Stabilizer for Polyurethane Foams. Polymers 2019, 11 (3), 480.
24. Choe, K. H.; Lee, D. S.; Seo, W. J.; Kim, W. N., Properties of Rigid Polyurethane Foams with Blowing Agents and Catalysts. Polymer Journal 2004, 36 (5), 368-373.
25. Zapp, J. A., Jr., Hazards of Isocyanates in Polyurethane Foam Plastic Production. Arch. Indust. Health 1957, 15 (4), 324-30.
26. Cornille, A.; Dworakowska, S.; Bogdal, D.; Boutevin, B.; Caillol, S., A new way of creating cellular polyurethane materials: NIPU foams. European Polymer Journal 2015, 66, 129-138.
27. Zhang, K.; Nelson, A. M.; Talley, S. J.; Chen, M.; Margaretta, E.; Hudson, A. G.; Moore, R. B.; Long, T. E., Non-isocyanate poly(amide-hydroxyurethane) s from sustainable resources. Green Chemistry 2016, 18 (17), 4667-4681.
28. Gomez-Lopez, A.; Elizalde, F.; Calvo, I.; Sardon, H., Trends in non-isocyanate polyurethane (NIPU) development. Chemical Communications 2021, 57 (92), 12254-12265
29. Khatoon, H.; Iqbal, S.; Irfan, M.; Darda, A.; Rawat, N. K., A review on the production, properties and applications of non-isocyanate polyurethane: A greener perspective. Progress in Organic Coatings 2021, 154, 106124.
30. Besse, V.; Camara, F.; Mechin, F.; Fleury, E.; Caillol, S.; Pascault, J.-P.; Boutevin, B., How to explain low molar masses in PolyHydroxyUrethanes (PHUs). European Polymer Journal 2015, 71, 1-11.
31. Tomita, H.; Sanda, F.; Endo, T., Model reaction for the synthesis of polyhydroxyurethanes from cyclic carbonates with amines: Substituent effect on the reactivity and selectivity of ring-opening direction in the reaction of five-membered cyclic carbonates with amine. Journal of Polymer Science Part A: Polymer Chemistry 2001, 39 (21), 3678-3685.
32. Bossion, A.; Aguirresarobe, R. H.; Irusta, L.; Taton, D.; Cramail, H.; Grau, E.; Mecerreyes, D.; Su, C.; Liu, G.; Müller, A. J.; Sardon, H., Unexpected Synthesis of Segmented Poly(hydroxyurea-urethane) s from Dicyclic Carbonates and Diamines by Organocatalysis. Macromolecules 2018, 51 (15), 5556-5566.
33. Leitsch, E. K.; Beniah, G.; Liu, K.; Lan, T.; Heath, W. H.; Scheidt, K. A.; Torkelson, J. M., Nonisocyanate Thermoplastic Polyhydroxyurethane Elastomers via Cyclic Carbonate Aminolysis: Critical Role of Hydroxyl Groups in Controlling Nanophase Separation. ACS Macro Letters 2016, 5 (4), 424-429.
34. Kotanen, S.; Poikelispää, M.; Efimov, A.; Harjunalanen, T.; Mills, C.; Laaksonen, T.; Sarlin, E., Hydrolytic stability of polyurethane/polyhydroxyurethane hybrid adhesives. International Journal of Adhesion and Adhesives 2021, 110, 102950.
35. Yu, Y.-J.; Hearon, K.; Wilson, T. S.; Maitland, D. J., The effect of moisture absorption on the physical properties of polyurethane shape memory polymer foams. Smart Materials and Structures 2011, 20 (8), 085010.
36. Sintas, J. I.; Wolfgang, J. D.; Long, T. E., Carbamate thermal decarboxylation for the design of non-isocyanate polyurethane foams. Polymer Chemistry 2023, 14 (13), 1497-1506.
37. Wolfgang, J. D.; White, B. T.; Long, T. E., Non-isocyanate Polyurethanes from 1,1′-Carbonyldiimidazole: A Polycondensation Approach. Macromolecular Rapid Communications 2021, 42 (13), 2100163.
38. Sintas, J. I.; Wolfgang, J. D.; Long, T. E., Carbamate thermal decarboxylation for the design of non-isocyanate polyurethane foams. Polymer Chemistry 2023.
39. Mather, B. D.; Viswanathan, K.; Miller, K. M.; Long, T. E., Michael addition reactions in macromolecular design for emerging technologies. Progress in Polymer Science 2006, 31 (5), 487-531.
40. Brown, I. M.; Sandreczki, T. C., Cross-linking reactions in maleimide and bis(maleimide) polymers. An ESR study. Macromolecules 1990, 23 (1), 94-100.
41. Daily, C.; Torres, S. M.; Robison, T. W.; Bowler, N., Dielectric and kinetic comparison of APO-BMI grades. High Performance Polymers 2018, 30 (9), 1101-1113.

### Example 9

### Additional Non-Limiting Examples

### 9.1 Injection Molding of Non-Isocyanate Polyurethane Structural Foam Composites

A library of BCI monomers enabled the synthesis of rigid and flexible NIPU foams.^{1,2} Subsequent catalyst and surfactant optimization provided control over pore geometry and Michael acceptor reactive fillers resolved the issue of residual imidazole in the foam matrix. These results marked a substantial advancement in the field of NIPU foam chemistry, however applying this technology to commercially relevant processing modalities remains undiscussed. PU foam processing is largely divided into slabstock and molded modalities. Slabstock foams are produced by a continuous production pathway where isocyanates and polyols are mixed continuously to produce slabs of PU foams.³ Conversely, direct injection molding of isocyanate and polyol into a specially designed mold comprises molded PU foams.^{3, 4} Each processing modality contains specific benefits and drawbacks, i.e., the facile production, but post-processing required for slabstock foams compared to the cost-intensive, however specialized molded foam process. The tunablity of BCI monomers for rigid, structural foam applications renders this chemistry compatible with molded foam applications. Thus, the adaptation of this chemistry to a molded foam processing modality remains feasible and desired. Advancements described herein remediated the issue of residual imidazole, which represented the final hurdle in achieving facile processing of BCI NIPU foams for structural applications and enables the next step for the BCI platform.

Several BCI monomers that impart restricted rotation along the NIPU backbone serve as ideal candidates for foam molding applications, as sufficient modulus values are required for mold release. TCD, outlined herein allowed for the synthesis of such monomers, allowing for subsequent processing, shown in Scheme 9.1. As discussed herein, TCDBCI produces high T_{g} NIPU foams when reacted with the triaryl amine monomer, TADE. However, this rigid monomer selection resulted in the embrittlement of the final foam part, necessitating a flexible chain spacer to maintain part toughness.

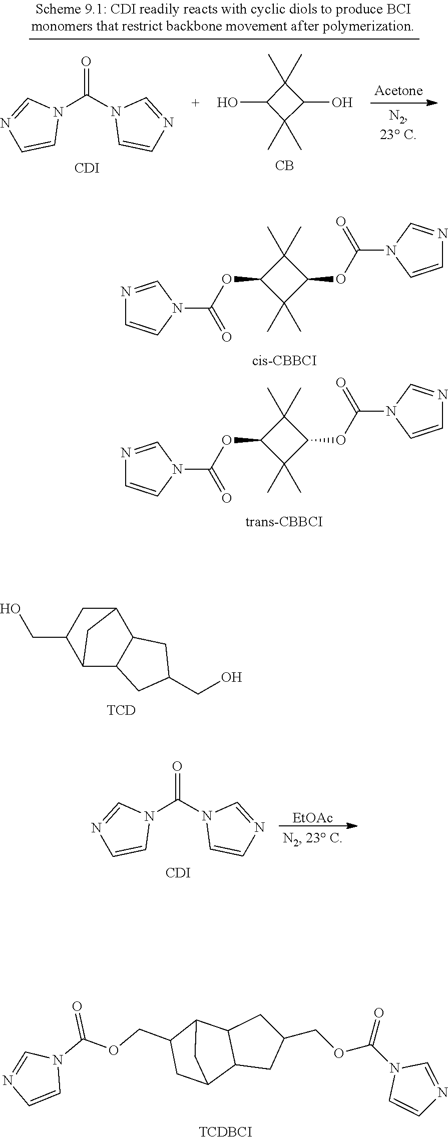

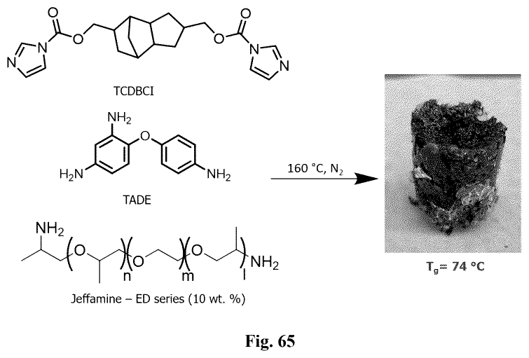

As previously mentioned, the addition of a Jeffamine® to the TCDBCI-TADE foam formulation resulted in a NIPU foam with decreased brittleness that maintained a relatively high T_{g} value of 74° C., FIG. 65. Synthetic procedures followed that as described herein with all reagents mixed in the melt to produce a cylindrical foam after extraction from a test tube.

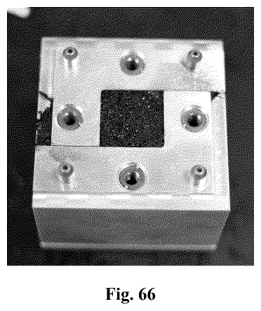

The design of a specialized foam mold allowed for initial explorations into foam molding processing routes with BCI monomers, displayed in FIG. 66. The foam mold utilized for these experiments underwent several iterations to account for pressure increases caused by CO₂ and imidazole production, as well as sufficient monomer loading to target foam density. Foam density was targeted by utilizing the known volume of the foam mold, as well as the monomer mass loading deducting the mass of the imidazole condensate. For systems incorporating a bis-maleimide Michael acceptor, APO-BMI, the mass of imidazole was retained, as TGA demonstrated efficient capture and no weight loss after curing. The mold was constructed out of aluminum to ensure efficient heat transfer throughout the rising foam, and a 0.01 mm vent hole allowed for depressurization during foam blowing. Initial BCI foam molding experiments consisted of the Jeffamine®-doped TCDBCI-TADE structural foam and yielded a square specimen that displayed adequate shape retention after removal from the foam mold.

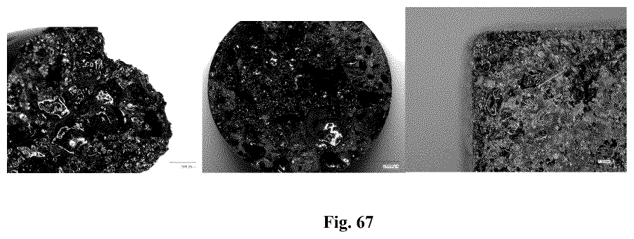

Incorporation of the reactive filler (APO-BMI) described herein resulted in a visual change of the molded foam. Microscopy images of initial molded parts display smooth edges, however cross-sectional analysis revealed uneven pore structure, shown in FIG. 67. This result highlights the importance of surfactants during the foaming process, and represents a vital area for innovation. While bismaleimides successfully capture the imidazole condensate and boast mechanical properties, surfactant effects on cell geometry remains unexplored. Investigations into surfactant chemistries and concentration serve to further improve BCI foam molding processes.

The process outlined above produces molded foam parts without the need for post-processing considerations, however improvements relating to monomer loading still serve to streamline this process. Future work in this area pertains to the reactive twin-screw extrusion of BCI monomers in the presence of multifunctional amines, chain spacers, reactive fillers, surfactants, and catalysts. Careful tuning of recycle times, influenced by catalyst loading, and monomer selection, will enable the realization of a continuous injection molded foam process. In this process, all reagents are mixed for homogeneously, then injected into a predetermined mold shape to yield a final NIPU foam part. Catalyst loading and amine reactivity tune working times, which allow for successful mold filling, while surfactant loading will control pore geometry. Lastly, the incorporation of reactive maleimide additives, outlined herein, will eliminate any post-processing needs by incorporating the imidazole condensate as functional filler in the final foam part. Careful control over mold temperatures and foam modulus will serve to optimize delamination of the final foam from the mold surface, allowing for smooth finishes shown in FIG. 67. The effects of carefully curated BCI foam formulations on thermomechanical properties is of great interest, as achieving optimal properties serves to further validate BCI chemistry as a viable alternative to isocyanate-derived PUs.

9.2 Enhanced Phase Separation of Non-Isocyanate Polyurethane Thermoplastic Elastomers

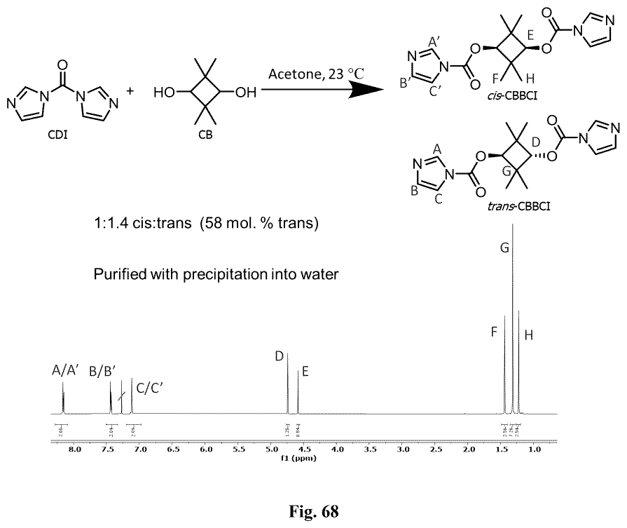

The synthesis of NIPUs derived from a polycondensation approach as described herein that utilized BCI monomers. This synthetic method utilized Le Chatelier's principle to actively drive molecular weight increase, which contrasts to the polyaddition mechanism leveraged by traditional isocyanate derived PUs. While a primary benefit of BCI chemistry is the green aspect of safer monomers, fully utilizing the imidazole condensate to achieve unique PU structures of high molecular weight provides an additional outstanding benefit. Additionally, a decarboxylation mechanism for BCI monomers was described herein, which increases in reaction rate at elevated temperatures.⁵ This was useful for NIPU foam synthesis, however required careful considerations during thermoplastic NIPU synthesis, where careful control over monomer stoichiometry is essential for achieving high molecular weight. The synthesis of high T_{g} NIPUs, however, requires elevated reaction temperatures to prevent the vitrification of the growing polymer chain, thus a method to inhibit this decarboxylation pathway was developed. As demonstrated throughout this work, informed monomer design allows for such control. 2,2′-4,4′-tetramethyl-1,3-cyclobutanediol (CB) is a commercial diol used for the synthesis of Tritan® polycarbonates (PCs), and imparts impact resistance and high T_{g} into the final PC. Interestingly, CB displays an absence of β-hydrogens, which eliminates the decarboxylation pathway for BCI monomers. Thus, CB was reacted with CDI to produce a new BCI monomer, CBBCI, described in FIG. 68.

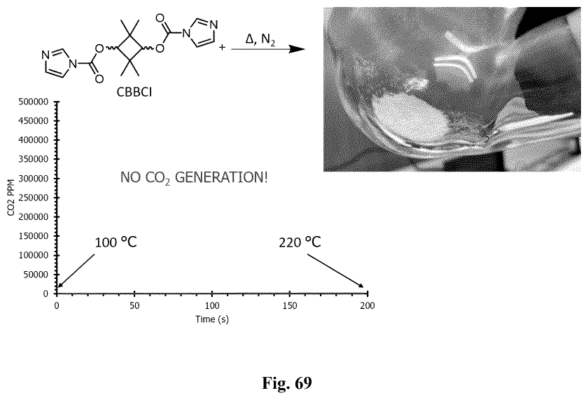

As predicted, this monomer displays no CO₂ generation at elevated temperature, which contrasts other BCI monomers outlined herein. This was confirmed with a CO₂ detector and multiple heating cycles, shown in FIG. 69. The unique thermal stability that CBBCI possesses allows for future work in the synthesis of high T_{g} or high Tₘ NIPUs, without the need for decarboxylation considerations. Thus, focus can be shifted towards the synthesis of high-performance, thermally robust NIPUs of various chemical compositions.

One such composition is the incorporation of poly(dimethyl siloxane) (PDMS) into the backbone of high-performance BCI NIPUs. As discussed herein, PDMS urethanes readily adapt to specialty applications including the biomedical device and coatings space.^{6, 7} This is due to the unique properties PDMS instills, namely low surface energy, the introduction of large temperature windows for operation, and high oxidation resistance.⁸ The low T_{g} of PDMS, −125° C. (reported as low as −150° C.), enables this large performance window.^{9, 10} Logically, pairing this low temperature performance with a high ultimate thermal transitions serves to lengthen the thermal performance window of PDMS-based PUs. Thus, combining amine-functionalized PDMS with CBBCI and an amine chain extender will enable the synthesis of a new, high-performance NIPU, displayed in Scheme 9.7.

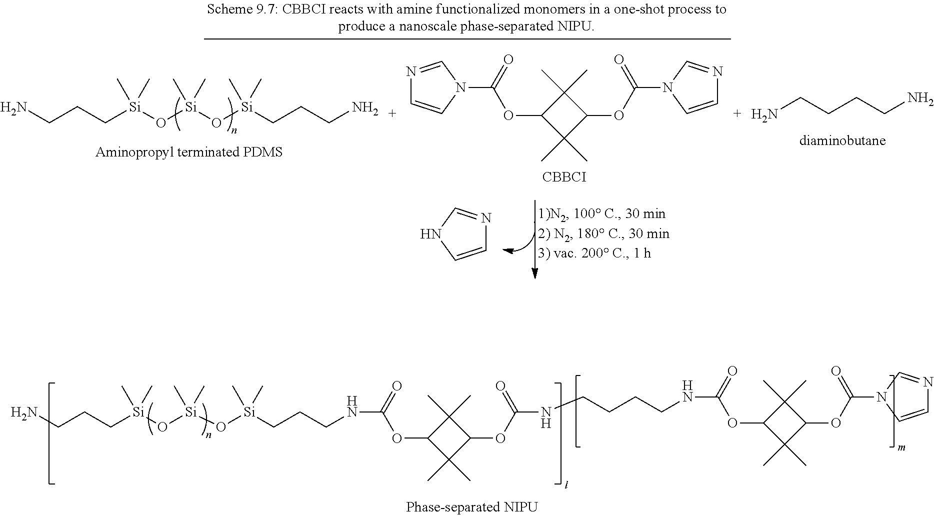

The preparation of a PDMS-containing NIPU that possesses impact-resistance CB linkages has potential use for coating applications, where thermal and damping properties are critical.^{11, 12} However, CBBCI is not limited to reactivity with PDMS soft segments. Conversely, it serves as a thermally stable, difunctional monomer capable of coupling with any amine-functionalized reactant. Likewise, the selection of chain extender can be tuned for increased T_{g} through selection of a rigid, cycloaliphatic amine. Additionally, evaluation of the phase separation behaviour with differing selections of chain extenders and soft segments enables further analysis of structure-property relationships of polyurethanes with new structures. Furthermore, the lack of CO₂ generation present in CBBCI enables the production of BCI NIPU foams that possess tunable pore structures. This can be done through utilizing CBBCI in conjunction with a CO₂-producing BCI monomer, such as BBCI, to control the extent of decarboxylation, providing an additional handle for tuning foam density.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed:

1. A polymer resin comprising:
a bis-carbonylimidazolide (BCI) monomer or derivative thereof;
a multifunctional nucleophile, wherein the multifunctional nucleophile is selected from the group consisting of a multifunctional primary amine, a multifunctional secondary amine, a multifunctional thiol, or a multifunctional alcohol, or a combination thereof; and
a Michael acceptor additive.

2. The resin of claim 1, wherein the BCI monomer or derivative thereof is present in about 1 weight % to about 90 weight % of the resin;
the amine is present in about 10 weight % to about 90 weight % of the resin; and
the Michael acceptor additive is present in about 1 weight % to about 90 weight % of the resin.

3. The resin of claim 1, wherein the bis-carbonylimidazolide (BCI) monomer or derivative thereof is 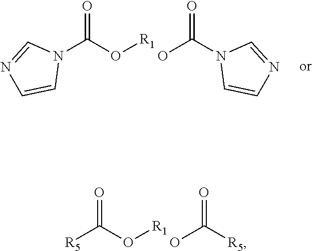
wherein —O—R₁—O— is taken together and selected from the group consisting of:
a polyol, a diol, an aliphatic alcohol, a cyclic alcohol, and an aromatic alcohol;
or R₁ is selected from the group consisting of: 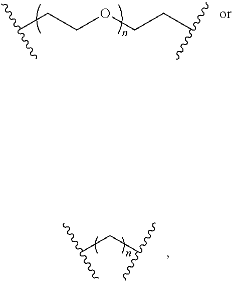
wherein n=1-10; alkyl-, -aryl-, -cycloalkyl-, -heterocyclyl-, -heteroaryl-, 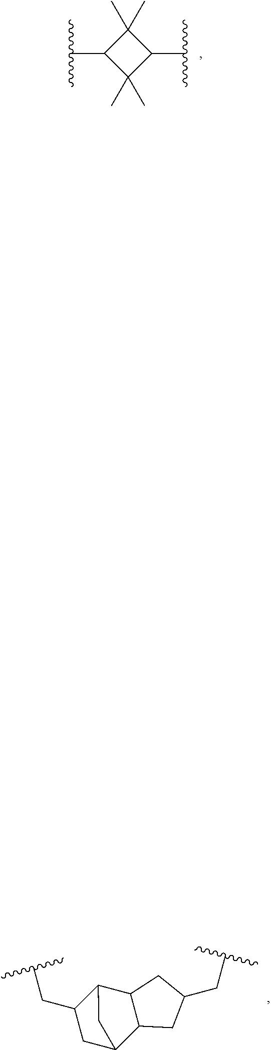
or a substituted derivative thereof; and
wherein, R₅ is selected from the group consisting of: 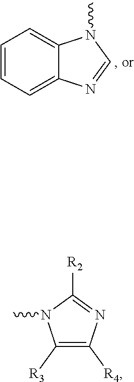
wherein R₂ is selected from the group consisting of an alkyl group, an aryl group, a vinyl group, or an inorganic substituent;
wherein R₃ is selected from the group consisting of an alkyl group, an aryl group, a vinyl group, or an inorganic substituent; and
wherein R₄ is selected from the group consisting of an alkyl group, an aryl group, a vinyl group, or an inorganic substituent.

4. The resin of claim 1, wherein the multifunctional nucleophile comprises: 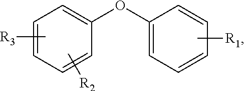
wherein R₁, R₂, and R₃ are independently selected from the group consisting of —H, —NH₂, —NR₄, —OH, or —SH, wherein R₄ is an alkyl group; 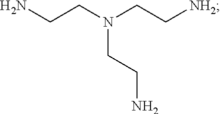
a polyetherimide; 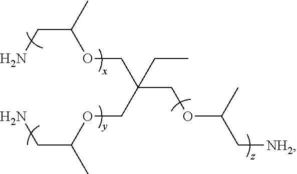
wherein x, y, and z are independently about 1 to about 10; 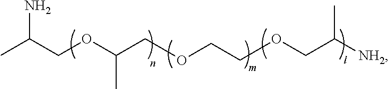
wherein n, m, and I are independently about 1 to about 25;
a dendritic nucleophile; or 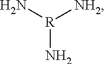
wherein R is a trialkylamine.

5. The resin of claim 1, wherein the Michael acceptor additive comprises a Michael acceptor.

6. The resin of claim 5, wherein the Michael acceptor comprises 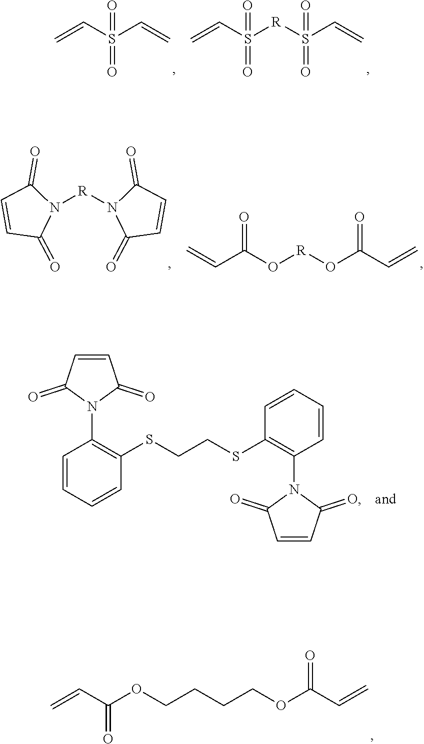
wherein R is: 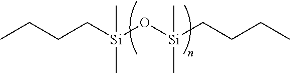
and n=1-10, 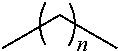
and n=1-10, 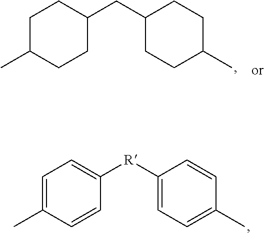
wherein R′ is an electron withdrawing group, an electron donating group, or a neutral group.

7. A method of producing a polymer or polymer material while capturing a byproduct to form a tunable filler, the method comprising:
combining a bis-carbonylimidazolide (BCI) monomer, or derivative thereof, and a Michael acceptor additive to produce a pre-reaction mixture;
reacting the pre-reaction mixture with at least one multifunctional nucleophile, thereby producing a polymer or polymer foam, wherein the polymer or polymer foam releases a Michael donor byproduct; and
reacting the Michael donor byproduct with the Michael acceptor additive, thereby capturing the Michael donor byproduct by forming a Michael addition filler.

8. The method of claim 7, wherein the Michael donor byproduct comprises a Michael donor.

9. The method of claim 8, wherein the Michael donor comprises: 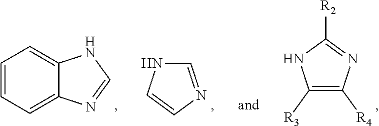
wherein, wherein R₂ is selected from the group consisting of an alkyl group, an aryl group, a vinyl group, or an inorganic substituent;
wherein R₃ is selected from the group consisting of an alkyl group, an aryl group, a vinyl group, or an inorganic substituent; and
wherein R₄ is selected from the group consisting of an alkyl group, an aryl group, a vinyl group, or an inorganic substituent.

10. The method of claim 7, wherein the bis-carbonylimidazolide (BCI) monomer or derivative thereof is 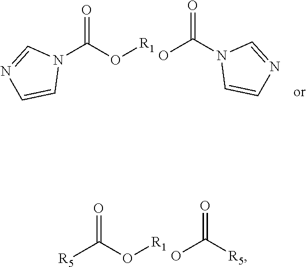
wherein —O—R₁—O— is taken together and selected from the group consisting of:
a polyol, a diol, an aliphatic alcohol, a cyclic alcohol, and an aromatic alcohol;
or R₁ is selected from the group consisting of: 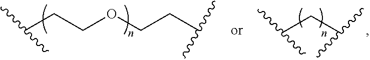
wherein n=1-10; alkyl-; -aryl-; -cycloalkyl-; -heterocyclyl-; -heteroaryl-; 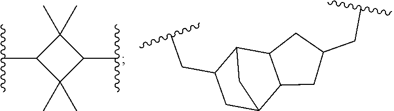
or a substituted derivative thereof; and
wherein, R₅ is selected from the group consisting of: 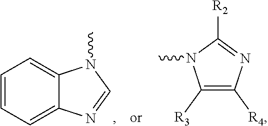
and
wherein R₂ is selected from the group consisting of an alkyl group, an aryl group, a vinyl group, or an inorganic substituent;
wherein R₃ is selected from the group consisting of an alkyl group, an aryl group, a vinyl group, or an inorganic substituent; and
wherein R₄ is selected from the group consisting of an alkyl group, an aryl group, a vinyl group, or an inorganic substituent.

11. The method of claim 10, wherein the polyol is a polyethylene glycol (PEG), a polypropylene glycol (PPG), a polyester diol, or a polydimethylsiloxane (PDMS) diol, and/or wherein the cyclic alcohol is isosorbide.

12. The method of claim 7, wherein the multifunctional nucleophile comprises a multifunctional aromatic amine or a multifunctional aliphatic amine.

13. The method of claim 7, wherein the multifunctional nucleophile comprises: 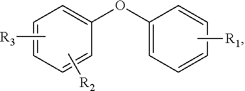
wherein R₁, R₂, and R₃ are independently selected from the group consisting of —H, —NH₂, —NR₄, —OH, or —SH, wherein R₄ is an alkyl group; 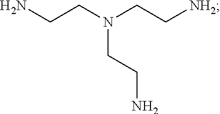
a polyetherimide; 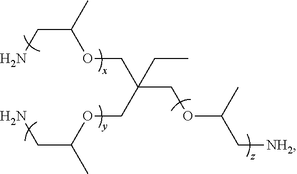
wherein x, y, and z are independently about 0 to about 10; 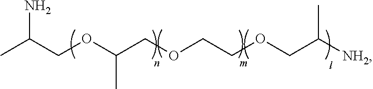
wherein n, m, and I are independently about 0 to about 25;
a dendritic nucleophile; or 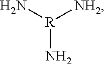
wherein R is a trialkylamine.

14. The method of claim 7, wherein the Michael acceptor additive comprises a Michael acceptor.

15. The method of claim 14, wherein the Michael acceptor comprises: 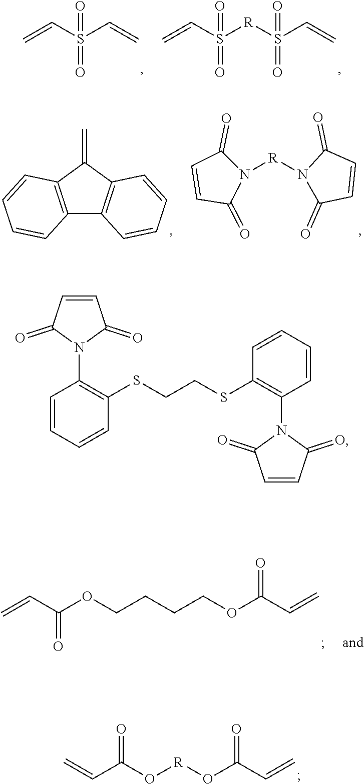
wherein R is selected from the group consisting of: 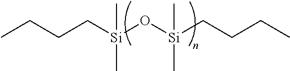
and n=1-10, 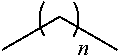
and n=1-10, 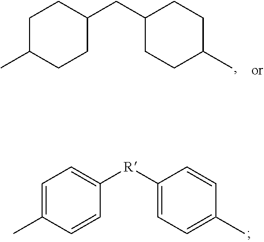
wherein R′ is an electron withdrawing group, an electron donating group, or a neutral group.

16. The method of claim 7, further comprising adjusting the reaction rate by tuning the Michael acceptor additive, the method comprising:
determining if the reaction rate should be increased or decreased; and
selecting a more electron withdrawing Michael acceptor to increase the reaction rate, or selecting a less electron withdrawing Michael acceptor to decrease the reaction rate.

17. The method of claim 7, further comprising targeting mechanical properties by tuning the Michael acceptor additive, the method comprising:
targeting an increased T_{g} and modulus or targeting a decreased T_{g} and modulus; and
selecting a rigid Michael acceptor additive to increase T_{g} and modulus, or selecting a flexible Michael acceptor additive to decrease T_{g} and modulus.

18. A polymer or polymer material produced by the method of claim 7.

19. The method of claim 7, further comprising heating the polymer or polymer material to a temperature sufficient to induce decarboxylation, thereby producing a foam.

20. The polymer, polymer material, or polymer foam of claim 19, wherein the polymer, polymer material, or polymer foam is a polycarbonate, a polycarbonate foam, a polycarbonate material, a polyurethane, a polyurethane foam, a polyurethane material, a thiourethane, a thiourethane foam, a thiourethane material, or a co-polymer, copolymer material, or co-polymer foam thereof.
